(19) United States
(12) Patent Application Publication
(10) Pub. No.: US 2009/0111711 A1
(43) Pub. Date: Apr. 30, 2009

(54) DEVICE AND METHOD FOR HIGH THROUGHPUT SCREENING OF CRYSTALLIZATION CONDITIONS IN A VAPOR DIFFUSION ENVIRONMENT

(76) Inventors: Francis A. Lewandowski, Washington Crossing, PA (US); Joseph Daniel Kwasnoski, Newtown, PA (US); John C. Spurlino, Downingtown, PA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/109,723

(22) Filed: Apr. 25, 2008

Related U.S. Application Data
(60) Provisional application No. 60/983,960, filed on Oct. 31, 2007.

(51) Int. Cl. C40B 30/10; C40B 60/12

(52) U.S. Cl. 506/12; 506/39

(57) ABSTRACT

A high-density high-throughput microplate and methods for simultaneously screening a plurality of protein crystallization solutions and for producing diffraction quality protein crystals in a vapor-diffusion environment are disclosed. The microplate has defined side-by-side paired chambers of equal size, wherein the side-by-side paired chambers have a maximum volume of about 8 μl, and wherein the paired chambers have a vapor channel, therein providing vapor exchange between the side-by-side paired chambers. The microplate further includes a membrane to seal the surface of the microplate. The microplate is adapted to receive a crystallization solution in one of the side-by-side paired chambers and a protein solution in the other of the side-by-side paired chambers, wherein the protein solution and the crystallization solution interact via a vapor diffusion process, which enables the formation of protein crystals within the chamber that contains the protein solution.

### CROSS-REFERENCE TO RELATED APPLICATIONS

This application claims priority to Application No. 60/983,960 filed on Oct. 31, 2007, the entire contents of which are incorporated by reference herein.

### TECHNICAL FIELD

The present invention relates in general to the field of biotechnology and, in particular, to a microplate and methods for simultaneously screening a plurality of protein crystallization solutions and producing diffraction quality protein crystals in a vapor-diffusion environment in a high-density high-throughput format.

### BACKGROUND OF THE INVENTION

Various publications, which may include patents, published applications, technical articles and scholarly articles, are cited throughout the specification in parentheses, and full citations of each may be found at the end of the specification. Each of these cited publications is incorporated by reference herein, in its entirety.

Innovative technologies and advancements in experimental techniques have enabled researchers to rapidly increase both the number of newly identified genes and the number of three-dimensional structures of biological macromolecules. There have been significant improvements in the sequential process of gene expression, protein purification, crystallization, and structure determination, but crystallization remains as one of the major bottlenecks in crystal structure determination. To address that issue, a number of different high-throughput protein-crystallization methods have been proposed and a number of automated crystallization systems have been developed (Stevens 2000; Sugahara and Miyano 2002; Sulzenbacher et al. 2002; Watanabe et al. 2002; Hosfield et al. 2003; Hui and Edwards 2003; Stojanoff 2004; Hiraki et al. 2006). For example, the Oryx 6 (Douglas Instruments, Ltd., Berkshire, UK) can set up 96-wells in 12 minutes for sitting-drop vapour diffusion and the Syrrx system can set up 2880 drops for vapour diffusion per hour (Hosfield et al. 2003; Hiraki et al. 2006).

When compared to microbatch and hanging drop methods, sitting-drop vapour-diffusion methods and microplates have advantages for high-throughput crystallization applications. Advantages include easy observation of crystallization drops, easy harvesting of crystals from the drops, and easy handling of the microplates with standard robotics and liquid handling devices (Hiraki et al. 2006). Numerous sitting drop microplates are commercially available at low cost from a number of different vendors, including Hampton Research, Greiner, and Corning. Others, such as Emerald Biostructures Inc., Structural Genomics Inc., and UAB Research Foundation have designed their own microplates or microarrays for custom applications (U.S. Pat. Nos. 6,039,804; 6,656,267; and 7,214,540). Some examples of sitting drop protein crystallography microplates or microarrays are briefly discussed below.

FIG. 1 shows a perspective view (1A) and a cross-sectional side view (1B) of a Cryschem™ Plate from Hampton Research (Hampton Research, Aliso Viejo, Calif.). The Cryschem™ Plate is a 24-well sitting drop microplate that includes an array of twenty-four wells (102), each of which may receive a sample of a protein solution to be assayed. The Hampton Research microplate includes a frame (104) that supports the wells. The frame is rectangular in shape and includes an outer wall (106) and a top planar surface (108) extending between the outer wall and the wells. The wells have circular cross-sections in a plane parallel to the top planar surface. The outer wall that defines the outer periphery of the frame has a bottom edge that extends below the wells. Thus, when the Hampton Research microplate is placed on a support surface, it is supported by the bottom edge (110) with the wells being raised above the support surface to protect them from damage. As illustrated, the outer wall also has a rim (112) to accommodate the skirt of a microplate cover (not shown).

FIG. 1B shows that each well (102) includes outer sidewalls (114), a bottom (116) and a post (118). The post located in the center of the well includes a concaved reservoir (120) in which a protein solution and a reagent solution are placed. A portion of the area in the well around the post receives a reagent solution that has a higher concentration than the protein and reagent solution mixture within the concaved reservoir. The configuration of the well then enables the protein solution and the reagent solution within the concaved reservoir to interact with the reagent solution around the post via a vapor diffusion process, which enables the formation of protein crystals within the concaved reservoir. The typical fill volume for the reagent solution is 500 μl to 1,000 μl, with a total well capacity of 1.5 ml. The maximum drop volume on the post is 40 μl. It should be noted that Hampton Research also has 96-well CrystalClear Strips™ microplates (not shown), in which 50 nanoliters to 4 microliters of protein solution can be dispensed on a shelf on one side of each well and 50 to 100 microliters of crystallization reagent can be placed in the well.

FIG. 2 shows a perspective view (2A), a partial top view (2B) and a cross-sectional side view (2C) of a CrystalQuick™ microplate from Greiner (Greiner Bio-One North America Inc., North Carolina, USA) The Greiner microplate is a 96-well sitting drop microplate where each well (202) may receive up to three samples of protein solutions to be studied. As seen from the perspective view, the Greiner microplate includes a frame (204) that supports the wells. The frame, which is rectangular in shape, includes an outer wall (206) that defines the periphery of the frame and a top planar surface (208) extending between the outer wall and the wells. The wells as shown have rectangular cross-sections in a plane parallel to the top planar surface.

FIG. 2B and FIG. 2C show that each well (202) includes a relatively large reservoir (214) and three relatively small reservoirs (216). Each small reservoir includes a flat bottom (218) on which there can be deposited a protein solution and a reagent solution. The large reservoir located next to the small reservoirs typically receives a reagent solution that has a higher concentration than the reagent solutions within the small reservoirs. The configuration of the well then enables the protein solution and the reagent solution within each of the small reservoirs to interact with the reagent solution within the large reservoir via a vapor diffusion process. This enables the formation of protein crystals within each of the small reservoirs.

FIG. 3 shows a perspective view (3A), a cut-away partial perspective view (3B), and a cross-sectional side view (3C) of a Corning microplate described in U.S. Pat. No. 6,913,732. As illustrated, the microplate is a 96-well high-throughput crystallography microplate that includes an array of ninety-six functional wells (302), each of which are able to receive a sample of a protein solution. The microplate includes a frame (304) that supports the wells. The frame, which is rectangular in shape, includes an outer wall (306) and a top planar surface (308) extending between the outer wall and the wells. As illustrated, the outer wall defines the outer periphery of the frame, which has a bottom edge (310) that extends below the wells. When the microplate is placed on a support surface, it is supported by the bottom edge with the wells raised above the support surface. The outer wall also has a rim to accommodate the skirt of a microplate cover (not shown).

FIG. 3B and FIG. 3C show that each functional well (302) is composed of two overlapping circular wells (302a and 302b), both of which are located in a plane parallel to the top planar surface (308). In particular, the first overlapping well has a relatively small concaved reservoir (314) capable of receiving a protein solution and a reagent solution and the second overlapping well has a relatively large reservoir (316) capable of receiving a reagent solution that has a higher concentration than the reagent solution deposited in the first well. After depositing protein solutions and reagent solutions in the wells, the openings of the wells can be covered by a seal such as an adhesive seal or a heat seal to prevent excessive evaporation of the solutions. As a result of the configuration and placement of the first and second overlapping wells, the protein solution and the reagent solution can interact via a vapor diffusion process, which enables the formation of protein crystals within the first well containing the protein solution.

FIG. 4 shows a perspective view (4A), a partial top view (4B), and a cross-sectional side view (4C) of a second microplate design described in U.S. Pat. No. 6,913,732. The microplate shown in FIG. 4 has 96 functional wells in which the first part of the well (402a) and the second part of the well (402b) are adjacent to one another and not overlapping as in the wells of the microplate shown in FIG. 3.

FIG. 5 shows a perspective view (5A), a partial top view (5B), and a cross-sectional side view (5C) of a third microplate design described in U.S. Pat. No. 6,913,732. The microplate shown in FIG. 5 has 48 functional wells composed of a first well (502a) and the second well (502b) connected to one another by a channel (504). The first well (502a) includes a relatively small reservoir and the second well (502b) includes a relatively large reservoir.

In U.S. Pat. No. 7,214,540, there is disclosed a method of screening protein crystal growth conditions with microchambers having a volume from about 0.001 nl to about 250 nl. Also disclosed is a method that employs a microarray with a plurality of wells or reservoirs as shown in FIG. 6. The microarray (10) includes two wells (12, 14) connected by a microchannel (16) that connects the protein solution well (12) and the precipitate solution well (14). It is further disclosed that the wells are sufficient for holding or retaining a desired volume of from about 0.001 nl to about 500 nl, preferably from about 0.01 nl to about 20 nl. Protein crystal growth in the different chambers is monitored by high resolution or other optical means, which automatically detects crystal growth or by manual inspection using high-resolution microscopy or electron microscopy. It is disclosed that if desirable crystal growth is observed in a sample, the protein crystal growth conditions of the sample can be reproduced on a macro scale to produce a protein crystal for further analysis. The very small volumes of the screening methods disclosed do not support growth of large diffraction quality crystals during the screen.

The microplate of the present invention has advantages over other available crystallography microplates. The microplate of the present invention is in a high-density 1536-well format with 768 functional wells, thus allowing for a truly high-density high-throughput screen using a sitting-drop vapor-diffusion method. The standard 1536-well format allows for facile robotic handling of the microplate and compatibility with a wide range of liquid handling systems. Furthermore, using wells of equal size with bottoms aligned in the same plane at the bottom of the wells allows for facile imaging with an inverted light microscope while at the same time allowing manipulation and harvesting of crystals from above. In a preferred embodiment, in which the bottoms of the wells are flat, microscopic images of the wells can be very rapidly screened because the bottoms of the wells are in a single focal plane. It should also be noted that the decreased reservoir to droplet ratio volumes of the high-density high-throughput format should lead to faster equilibration rates and more rapid protein nucleation and crystal growth compared to using other available crystallography microplates (Santarsiero et al. 2002).

The microplate and methods of the present invention also have an advantage over the microarray and methods described in U.S. Pat. No. 7,214,540. By using the microplate of the present invention with 8 μl maximum volumes it is possible to use protein solution volumes of about 1 μl or volumes as much as 2 μl, thus the method of the present invention allows for growth of diffraction quality crystals during a high-density high-throughput screen. The crystals obtained directly from the screen are suitable for analysis by x-ray, thus eliminating the need to reproduce the crystals on a macro scale to produce a protein crystal suitable to be analyzed.

### SUMMARY OF THE INVENTION

The present invention includes a microplate and methods for simultaneously screening a plurality of protein crystallization solutions and producing diffraction quality protein crystals in a vapor-diffusion environment in a high-density high-throughput format.

According to a first aspect of the present invention, there is provided a microplate, comprising a frame including a plurality of wells with defined side-by-side paired chambers of equal size, wherein the side-by-side paired chambers have a maximum volume of about 8 μl, wherein the paired side-by-side chambers have a vapor channel providing vapor exchange between the side-by-side paired chambers.

According to a second aspect of the present invention, there is provided a microplate comprising a frame having a footprint that can be easily handled by a robotic handling system.

According to a third aspect of the present invention, there is provided a microplate, wherein the bottoms of the side-by-side paired chambers are aligned in the same plane.

According to a fourth aspect of the present invention, there is provided a microplate, wherein the bottoms of the side-by-side paired chambers are flat, conical, or concave.

According to a fifth aspect of the present invention, there is provided a microplate, wherein the vapor channel has a predetermined depth and width to allow for a predetermined quantity of a first and second crystallization solution to optimally equilibrate.

According to a sixth aspect of the present invention, there is provided a microplate, wherein the vapor channel is formed by a predetermined opening in a portion of a wall between the side-by-side paired chambers and a transparent adhesive membrane that is positioned over the side-by-side paired chambers.

According to a seventh aspect of the present invention, there is provided a microplate, wherein each well is positioned on said frame such that a liquid handling system can automatically deposit a formulated crystallization solution into one of the side-by-side paired chambers and can automatically deposit a protein solution into the other side-by-side paired chamber.

According to an eighth aspect of the present invention, there is provided a microplate, wherein the high-density high-throughput sitting-drop vapor diffusion protein crystallography microplate has 768 functional wells.

According to a ninth aspect of the present invention, there is provided a microplate, wherein each well is positioned on said frame such that a liquid handling system can automatically deposit the formulated crystallization solution into one of the side-by-side paired chambers and can automatically deposit a protein solution into the other side-by-side paired chamber.

According to a tenth aspect of the present invention, there is provided a method wherein a liquid handling system can automatically deposit a formulated crystallization solution into one of the side-by-side paired chambers of a microplate of the present invention and can automatically deposit a protein solution into the other side-by-side paired chamber of a microplate of the present invention, and wherein the protein solution in one side-by-side paired chamber and the crystallization solution within the second side-by-side paired chamber interact via a vapor diffusion process which enables the formation of protein crystals within the chamber containing the protein solution.

According to an eleventh aspect of the present invention, there is provided a method, wherein the formulated crystallization solutions are selected from the solutions shown in Table 2.

According to a twelfth aspect of the present invention, there is provided a method, wherein the amount of formulated crystallization solution deposited is about 6 μl and the amount of protein solution deposited is about 1 μl.

According to a thirteenth aspect of the present invention, there is provided a method, wherein the amount of formulated crystallization solution deposited is in the range of about 4 μl to about 8 μl and the amount of protein solution deposited is in the range of greater than 0.5 μl to about 2 μl.

### BRIEF DESCRIPTION OF THE FIGURES

A preferred embodiment of the present invention will now be described, by way of an example only, with reference to the accompanying drawings wherein:

FIG. 1 shows a perspective view (1A) and a cross-sectional side view (1B) of a Cryschem™ Plate from Hampton Research Inc.

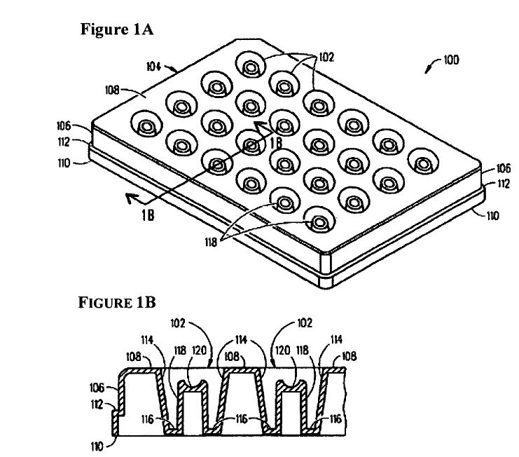

FIG. 2 shows a perspective view (2A), a partial top view (2B) and a cross-sectional side view (2C) of a CrystalQuick™ microplate by Greiner Bio-One North America Inc.

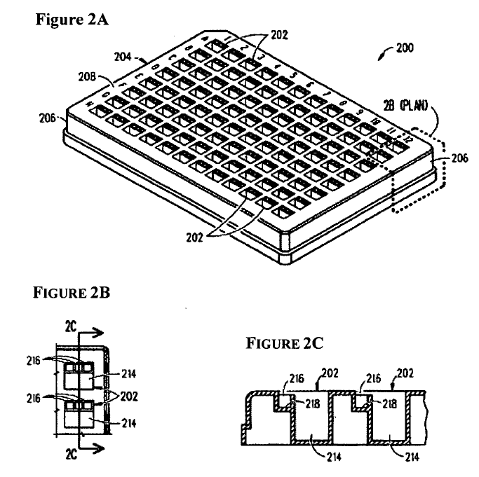

FIG. 3 shows a perspective view (3A), a cut-away partial perspective view (3B), and a cross-sectional side view (3C) of a first microplate disclosed in U.S. Pat. No. 6,913,732.

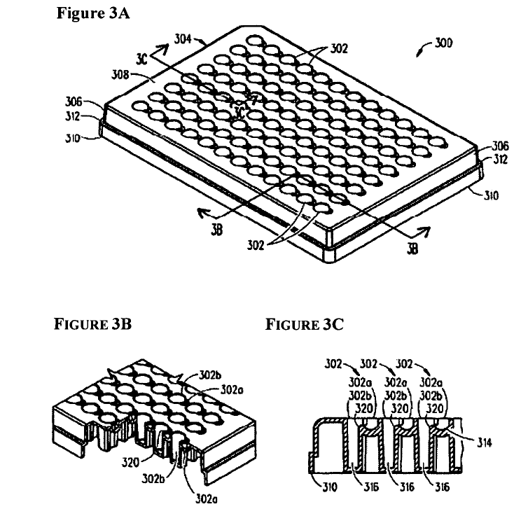

FIG. 4 shows a perspective view (4A), a partial top view (4B), and a cross-sectional side view (4C) of a second microplate disclosed in U.S. Pat. No. 6,913,732.

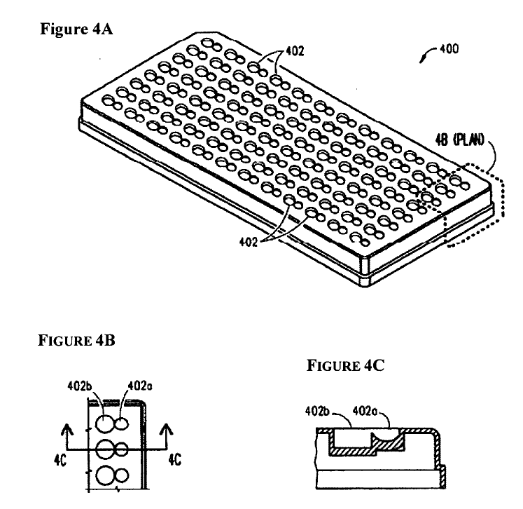

FIG. 5 shows a perspective view (5A), a partial top view (5B), and a cross-sectional side view (5C) of a third microplate disclosed in U.S. Pat. No. 6,913,732.

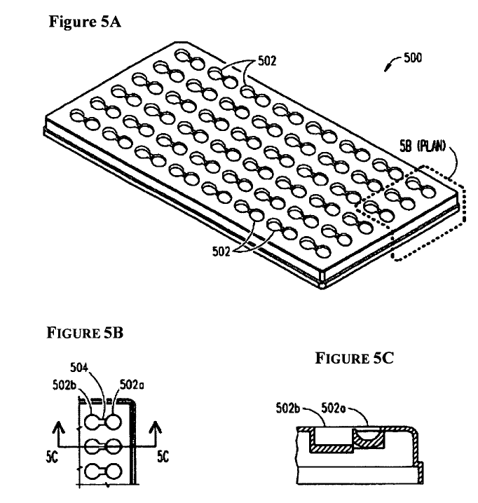

FIG. 6 shows a microarray disclosed in U.S. Pat. No. 7,214,540.

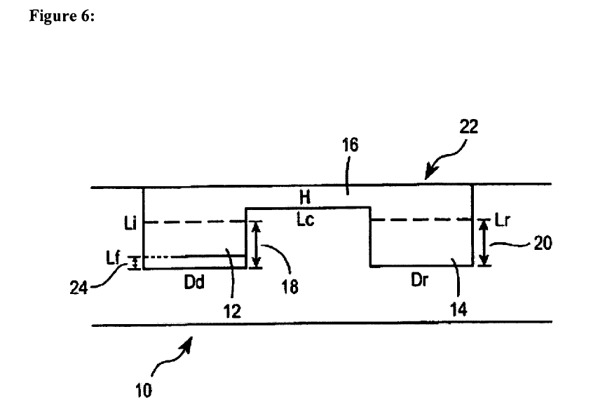

FIG. 7 shows a top view (7A) of a modified 1536-well transparent polystyrene assay plate having 768 functional wells, with column 1 and every odd column following designated for crystallization solutions (W) and column 2 and every even column following designated for protein droplets (P). When sealed with a transparent adhesive membrane, the shorter milled wall creates a vapor channel connecting the two side-by-side paired chambers, W and P, thus forming a single environment for crystallization (7B).

FIG. 8 shows 4 functional wells of the crystallography microplate of the present invention. 8A is a side view through the center of four functional wells with column 1 and every odd column following designated for crystallization solutions (W) and with column 2 and every even column following designated for protein droplets (P). 8B shows the side view of 8A with a 90 degree rotation. 8C shows a top view of 4 functional wells of the high-density high-throughput 768 functional well microplate of the present invention with 6 μl of crystallization solution in W and 1 μl of protein solution in P.

FIG. 9 shows images and the associated narrow scoring guidelines used to score each crystallization experiment. Scores from 1 through 10 are critical markers identifying a protein's threshold compared with each solution component. A rating of 10 initially gets grouped with protein leads until it is determined to be salt. Scores from 11 through 20 are flagged for optimization experiments to reproduce crystals for further characterization and diffraction analysis.

Table 1: Stock Components for the 1000 Solution Crystallization Screen: Shown is a table of the stock solution reagent set used to generate the 1000 solution crystallization screen. Stock solutions were either prepared at concentrations based on the solubility information provided in the CRC Handbook of Chemistry or purchased from Hampton Research, Inc.

Table 2: Complete List of 1000 Solutions: Shown is a table listing the composition of all of the 1000 solutions used in the high-density high-throughput screen.

### DEFINITIONS

Certain terms are used herein which shall have the meanings set forth as follows.

The term “comprising” means “including principally, but not necessarily solely”. Furthermore, variations of the word “comprising”, such as “comprise” and “comprises”, have correspondingly varied meanings.

The following abbreviations are used herein and throughout the specification:

nl: nanoliter;

μl: microliter;

ml: milliliter;

mm: millimeter;

mg/ml: milligram per millimeter;

° C.: degrees Celsius;

### DETAILED DESCRIPTION OF THE INVENTION

The present invention will now be further described in greater detail. It is to be understood at the outset, that the figures and examples provided herein are to exemplify and not to limit the invention and its various embodiments.

### Reagent Development for High-Throughput Crystallization

Due to the limited amount of crystallization screens commercially available during the development of the high-throughput crystallization method, a diverse sparse-matrix screen of solutions was designed. Based on the generalization that the crystallization success rate for most proteins is equivalent or greater than 2%, Segelke has suggested that a thorough screen for one protein should consist of approximately 288 crystallization solutions (Segelke 2001). Given the low protein and reservoir requirements of the high-density high-throughput method and microplate of the present invention, it was decided to expand the solution screen to decrease the amount of absent parameter space and improve the chances of producing crystals in a single screen. A 1000 solution screen was developed to cover a crystallization parameter space of approximately 4 times the recommended size discussed by Segelke. In a preferred embodiment, diffraction quality crystals are produced directly from a single 1000 solution screen, but the 1000 solution screen was also designed to provide data on the protein's solubility and information for further optimization of conditions if diffraction quality crystals were not produced during the initial screen.

Ideal components were selected to design a unique 1000 solution screen with a maximum likelihood of generating crystals. Information was gathered from optimum solubility screening articles, the NIST/CARB Biological Macromolecule Crystallization Database, PDB (Brookhaven Protein Data Bank) crystallization parameters, the Hofmeister series, and existing crystallization screens from Hampton Research and Emerald Biosystems (Jancarik and Kim 1991; Saridakis and Chayen 2000). The selected chemicals consisted of 50 precipitants, 12 buffers with alternating pH values, 51 additives, and 8 detergents (Table 1). These chemicals were correlated and entered into the CRYStool™ program (Jena Bioscience GmbH, Germany) to randomly generate 1000 unique solutions. The CRYStool™ program was chosen since it had the capability of producing a screen based on random sampling (Segelke 2001). This reagent set was transferred to a spreadsheet and used to calculate stock reagent concentrations. Selected components were manually combined to create each unique crystallization solution comprising the 1000 solution screen listed in Table 2. The complete set of 1000 solutions is a truly diverse set of solutions with a range of pH, buffers, salts, polymers, alcohols, detergents, and other additives. All of the solutions were prepared in 50 ml conical tubes and transferred into Matrix 96-well deep-well storage blocks (Catalogue #4211, Thermo Fisher Scientific, New Hampshire, USA) for storage at 4° C. Solutions in the deep-well blocks have a shelf life of approximately 1 year.

### Modified Microplate Design

A microplate and method were needed to quickly set up and use the 1000 solution screen. Although there are alternative methods available, as many as 95% of all crystallization experiments are set up under a vapor diffusion environment. The traditional vapor diffusion method routinely used for more than 20 years utilizes a 24-well deep-well Linbro plate and a suspended 2 μl protein droplet on a glass coverslip. The protein droplet is typically comprised of a 1:1 ratio of protein to crystallization solution and the drop is suspended over 1 ml of crystallization solution. The vapor diffusion method allows the protein droplet to equilibrate with the crystallization solution with water being extracted from the droplet. As the water is extracted during equilibration, the protein and precipitant concentrations slowly increase in the droplet and thus conditions vary over a broad range to promote nucleation and/or crystal growth. Unfortunately the traditional hanging-drop method using 24-well deep-well Linbro plates and a suspended 2 μl protein droplet on a glass coverslip is an extremely laborious and tedious process. In addition, if conventional 24-well Linbro plates were used to conduct the 1000 solution screen, it would have required 42 plates that would have occupied approximately two cubic feet of incubator space, consumed 1 liter of crystallization solutions by using 1 ml of each crystallization solution per well, and taken approximately 16 hours for experimental set up. A 96-well crystallization plate approach would have reduced the number of plates to 11, decreased the total crystallization solution volume to 80 ml by using 80 μl of each crystallization solution per well, and reduced the time to set up the 1000 solution screen to approximately 3 hours.

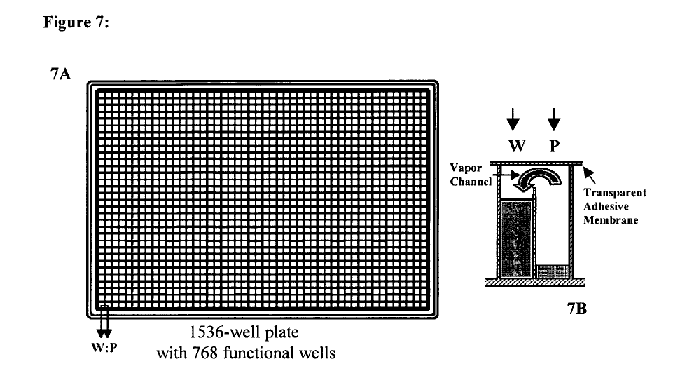

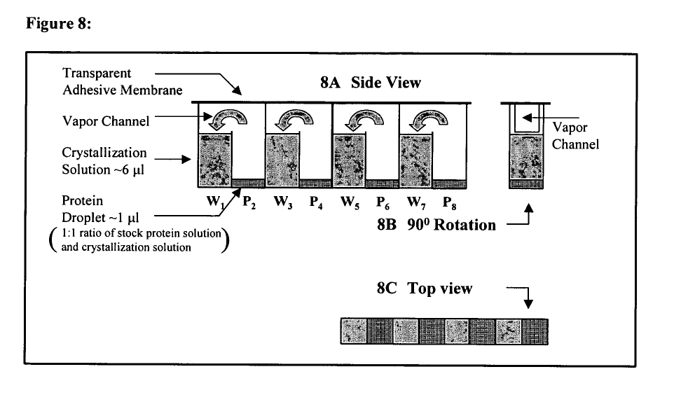

The present invention provides a microplate and methods to perform sitting-drop vapor diffusion experiments in modified 1536-well Hibase, clear, polystyrene, flat bottom microplates, with 768 functional wells (FIG. 7 and FIG. 8). The method and microplate increased plate storage capacity, reduced the total crystallization solution consumption to slightly less than 7 ml by using only 6 μl per well, and reduced the time to only about 20 minutes to completely set up a 1000 solution screen. In addition, decreased reservoir to droplet ratio volumes were expected to lead to faster equilibration rates and more rapid protein nucleation and crystal growth (Santarsiero et al. 2002). The unmodified 1536-well, Hibase, clear, polystyrene, flat bottom microplates were purchased from Greiner (Greiner America, Inc., Catalogue #782101). The modified microplates were created by milling about ¼ of the height from the top of the wall between two side-by-side wells, thus producing microplates with 768 functional wells consisting of 768 side-by-side paired chambers. After milling, each chamber has a maximum volume of about 8 μl. The shorter milled wall between side-by-side paired chambers becomes a vapor channel when the microplate is sealed with a transparent adhesive membrane. (FIG. 7 and FIG. 8).

Starting from the left side of the microplate, column 1 and every odd column following are designated for well solutions (W) (FIG. 7 and FIG. 8). Column 2 and every even column following are designated for protein droplets (P) (FIG. 7 and FIG. 8). When sealed with a transparent adhesive membrane, the shorter milled wall creates a vapor channel connecting the two side-by-side paired chambers, W and P, thus forming a single environment for crystallization. For example, one experiment would include a first selection from the 1000 solutions in W₁ and a protein droplet in P₂. A second experiment would include a second selection from the 1000 solutions in W₃ and a protein droplet in P₄. A third experiment would include a third selection from the 1000 solutions in W₅ and a protein droplet in P₆. Each protein droplet is a 1:1 ratio of a stock protein solution and one of the 1000 crystallization solutions that is made by pipetting about 0.5 μl of stock protein solution and 0.5 μl of one of the 1000 crystallization solutions into each protein well. The crystallization solution used in a 1:1 ratio in each protein droplet well (P) is the same as the corresponding crystallization solution used in each side-by-side paired crystallization solution well (W). This procedure continues over the entire modified microplate to set up a complete microplate of 768 crystallization experiments.

### Utilization of the Modified Microplate

The 1000 crystallization solutions are transferred from Matrix 96-well deep-well storage blocks (Catalogue #4211, Thermo Fisher Scientific, New Hampshire, USA) using a Gilson C250 robot (Gilson, Inc., Middleton, Wis., USA) into three 384-well daughter plates (Greiner America, Inc., Catalogue #781201). Each daughter plate is made to contain 80 μl per well of one of the 1000 crystallization solutions. Each daughter plate can accommodate a high-throughput screening cycle of 12 proteins before re-dispensation is necessary. The daughter plates are used to dispense the crystallization solutions into the screening microplates. Two modified 1536-well modified microplates with 768 functional wells are required to run a full screen of 1000 solutions. A first microplate is made to contain 768 experiments in 768 functional wells. A second microplate is made to contain the remaining 232 experiments in 232 functional wells with an additional 536 functional wells for expansion of the screen in the future if more solutions are desired.

To add crystallization solutions and protein solutions to the high-density high-throughput 768 functional well screening microplates, a highly reproducible crystallization routine was developed using the VPrep® automated liquid handling system with a fixed 384 syringe head (Velocity 11, Inc., California, USA). In a typical high-density high-throughput screen, the (W) well receives 6 μl of one of the 1000 crystallization solutions from a 384-well daughter plate and the (P) well receives 0.5 μl of stock protein solution and 0.5 μl of one of the 1000 crystallization solutions for a final volume 1 μl. The crystallization solution used in a 1:1 ratio in each protein droplet well (P) is the same as the corresponding crystallization solution used in each side-by-side paired crystallization solution well (W). After setting up the screening microplate, each well solution (W) has a protein droplet (P) adjacent to it at essentially half the concentration of the crystallization solution (FIG. 7 and FIG. 8). The microplate is then sealed with a transparent adhesive membrane and centrifuged at 2500 rpm for 5 minutes to ensure the protein droplet is at the bottom of the protein well. The plates are then stored at either 4° C. or 22° C. until queued for image analysis. Once sealed with the transparent adhesive membrane, which forms the vapor channel from the milled wall between the 768 paired chambers, each protein droplet equilibrates with each well solution until the protein solution reaches the same concentration as the well solution. The process of equilibration promotes nucleation by permitting the protein to be concentrated toward a supersaturated state.

### Visualization & Image Analysis

In order to increase both the throughput and precision necessary to evaluate experiments in the high-density high-throughput 768 functional well microplates, an automated Nikon M3 inverted microscope, Phase 3 Imaging XY stage, and an Evolution MP 5.1 Mega-pixel CCD color camera were assembled to capture and record images. The primary focus was to identify crystals for harvesting and analysis by x-ray diffraction or to identify crystallization leads for data analysis and further optimization to enhance crystal quality. Every captured image, 100 KB per frame, is time date stamped and binned in appropriate folders to create a unique figure array for visualization. It takes approximately 1½ hours to image a complete 1000-well experimental set.

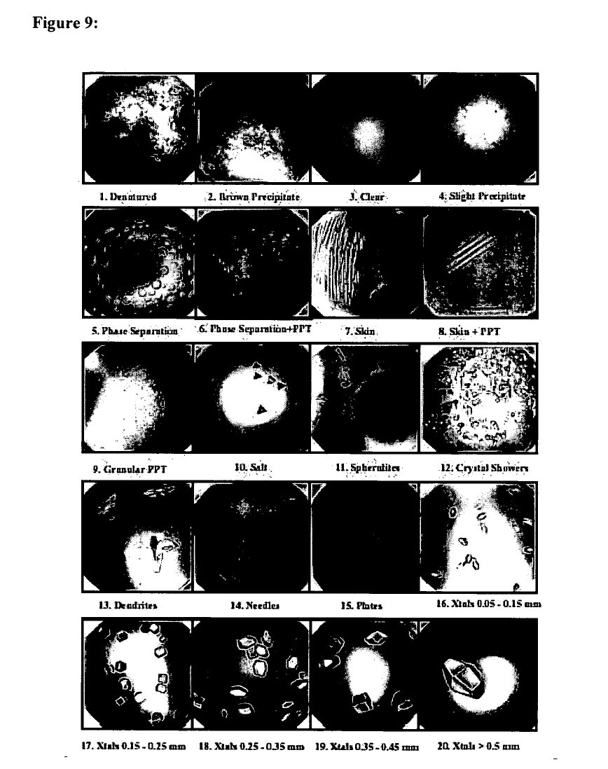

Each set of 1000 images uses approximately 100 MB of disk space and is stored in an internal database to be accessed for comparative examination. The Crystal Evaluator browser, designed in-house, is used to load a set of images and visualize each image. Internal control settings include zoom in/out and light intensity filters to assist with accurate scoring. The scoring process is currently done manually, but can be easily adapted into an automated process once image recognition software becomes further automated. Each image is manually scored against an ordinal 20 number ratings schema to define the visual characteristics of the protein crystallization droplet (FIG. 9). The narrow interpretation of each rating assists with the correlation of how each solution component affects protein behaviour. Any droplet having a rating ≧10 is flagged as an initial lead and subsequently is queued for reproducibility and protein validation studies. The ratings are also converted into a binary format of 0 and 1. Any result observed from 1 to 10 is recorded as 0 while results from 11 to 20 are recorded as 1. While results tend to be subjective from observer to observer, the ratings list was generated to specifically define the majority of observations typically observed in a crystallization experiment from the worst to the best. Ratings from 11 through 20 are most important since they identify solutions that produce protein crystals. All results, including negative ones, are recorded in a database to include both ordinal and binary tables and provide data to study trends in protein crystallization from solution to solution. The quality of the leads dictates the path taken for further characterization. Crystals large enough for x-ray studies are harvested directly from the high-density high-throughput 768 functional well microplates, placed into a preformulated cryo-protectant, frozen at −173° C., and screened for protein diffraction. If crystals are too small to x-ray, they are either stained with a Coomassie solution to observe absorption, crushed to determine if protein, or used as a seed stock in crystal regeneration. Optimization experiments are conducted on leads identified with diffraction ≧8 Å. Historical methods to generate improved crystals suitable for structural studies include experiments with variable pH and precipitant concentrations, additive screening, buffer/precipitant substitutions, and seeding.

### Results

The 1000 solution set and the high-density high-throughput 768 functional well microplate format and method were initially tested using a 15 mg/ml lysozyme stock solution. The test produced a 17.5% hit rate by identifying 175 unique solutions as leads for crystallizing lysozyme. The hits ranged from crystal showers to crystals larger than 0.5 mm. Crystals, ranging from 0.05 mm to greater than 0.5 mm, comprised 14% of the 1000 solutions, with 2% larger than 0.25 mm. The results confirmed that the 1000 solution set and the high-density high-throughput 768 functional well microplate format and method were suitable for generating protein crystals in a screen and for identifying leads for further optimization and crystal generation.

The 1000 solution set and the high-density high-throughput 768 functional well microplate format and method have become invaluable for the process of rapidly screening proteins to identify leads and produce crystals suitable for structure based drug design. Over the past three years, the process has identified 684 leads resulting in the structure determination of 33 proteins or inhibitor complexes from 13 of the 46 therapeutic targets investigated. Surface response data on proteins from all therapeutic areas against each of the 1000 solutions is currently being collected to build a repository for the calculation and prediction of optimal crystallization conditions for unknown proteins.

TABLE 1

| PRECIPITANTS | BUFFERS | pH | ADDITIVES | DETERGENTS |
|---|---|---|---|---|
| 2 Ethoxyethanol | Bis-Tris Propane | 4.5 | 1,4-Dithio-DL-Threitol | C12E9 |
| Ammonium Acetate | Bis-Tris Propane | 5.5 | 1,4 Butanediol | Cymal-3 |
| Ammonium Bromide | Bis-Tris Propane | 6.5 | 1,4 Dioxane | Glucopyranoside |
| Ammonium Citrate | Bis-Tris Propane | 7.5 | 1,6 Hexanediol | Glycerol |
| Ammonium Nitrate | Bis-Tris Propane | 8.5 | 2,2,2-Trifluoroethanol | LDAO |
| Ammonium Phosphate | CAPSO | 8.5 | Acetonitrile | Maltoside |
| Ammonium Sulfate | CAPSO | 9.5 | Ammonium Sulfate | Triton X-100 |
| Cadmium Sulfate Monohydrate | Gomori's succinate | 4.5 | ATP disodium salt | Zwittergent |
| Calcium Acetate Dihydrate | Gomori's succinate | 5.5 | Barium Chloride | |
| Calcium Chloride | Gomori's succinate | 6.5 | Benzamidine HCl | |
| Dioxane | Hepes | 6.5 | Betaine Monohydrate | |
| Ethanol | Hepes | 7.5 | Cadmium Chloride | |
| Ethylene Glycol | Hepes | 8.5 | Calcium Chloride | |
| Ferric Chloride Hexahydrate | Mopso | 6.5 | Cesium Chloride | |
| Glycerol | Mopso | 7.5 | Cobaltus Chloride | |
| Isobutanol | Na-Acetate | 4.5 | Cupric Chloride | |
| Isopropanol | Na-Acetate | 5.5 | D (+) Glucose | |
| Jeffamine M-600 | Na-Cacodylate | 4.5 | Dextran Sulfate | |
| Lithium Chloride | Na-Cacodylate | 5.5 | DMSO | |
| Lithium Sulfate Monohydrate | Na-Cacodylate | 6.5 | EDTA | |
| Magnesium Chloride | Na-Cacodylate | 7.5 | Ethanol | |
| Magnesium Sulfate | Na-Citrate | 4.5 | Ethyl Acetate | |
| Methanol | Na-Citrate | 5.5 | Ethylene Glycol | |
| MPD | Na-Citrate | 6.5 | Glycerol Anhydrous | |
| Nickel Chloride Hexahydrate | Na—K-Phosphate | 5.5 | Glycine | |
| PEG 10K | Na—K-Phosphate | 6.5 | Glycyl-Glycyl-Glycine | |
| PEG 1500 | Na—K-Phosphate | 7.5 | Guanidine HCl | |
| PEG 200 | Na—K-Phosphate | 8.5 | Isopropanol | |
| PEG 300 | Na-Succinate | 4.5 | Jeffamine M-600 | |
| PEG 400 | Na-Succinate | 5.5 | Lithium Chloride | |
| PEG 4K | Na-Succinate | 6.5 | Magnesium Chloride | |
| PEG 600 | Na-Succinate | 7.5 | Manganese Chloride | |
| PEG 6K | TRIS-HCl | 6.5 | MPD | |
| PEG 8K | TRIS-HCl | 7.5 | NAD | |
| PEG DME 250 | TRIS-HCl | 8.5 | PEG 200 | |
| PEG DME 2K | TRIS-Maleate | 4.5 | PEG 400 | |
| PEG MME 550 | TRIS-Maleate | 5.5 | Phenol | |
| PEG MME 5K | TRIS-Maleate | 6.5 | Potassium Chloride | |
| Polyethyleneimine | | | sec-butanol | |
| Potassium Chloride | | | Sodium Chloride | |
| Potassium Phosphate | | | Sodium Fluoride | |
| Potassium Sodium Tartrate | | | Sodium Iodide | |
| Sec-Butanol | | | Sodium Thiocyanate | |
| Sodium Acetate | | | Spermidine | |
| Sodium Chloride | | | Strontium Chloride | |
| Sodium Formate | | | Taurine | |
| Sodium Phosphate | | | Trimethylamine HCl | |
| Sodium Sulfate | | | Urea | |
| Tri-Sodium Citrate Dihydrate | | | Xylitol | |
| Zinc Sulfate Hexahydrate | | | Yttrium Chloride | |
| | | | Zinc Acetate | |

TABLE 2

| | | | Precip. Final | | | | | | | | | Additive Final | | | Detergent final |
|---|---|---|---|---|---|---|---|---|---|---|---|---|---|---|---|
| # | Final pH | Precipitant | Conc. | | | vol #1 50 | Buffer | Buffer Final Conc. | | | Additive | Conc. | | Detergent | Conc. |
| 1 | 4.57 | PEG 6K | 23 | 23.0% | | 23 | Na-Acetate pH 4.5 | 50 | mM | | Acetonitrile | 2.32% | | | |
| 2 | 7.36 | PEG 600 | 43.2 | 18.0% | | 18 | Hepes pH 8.5 | 100 | mM | | Magnesium Chloride | 0.204 | M | | |
| 3 | 5.3 | Sec-Butanol | 4 | 4.0% | | 2 | Bis-Tris Propane pH 9.5 | 100 | mM | | Sodium Fluoride | 0.3184 | M | | |
| 4 | 5.46 | Isopropanol | 20 | 20.0% | | 10 | Na-Acetate pH 5.5 | 50 | mM | | NAD | 0.01 | M | Cymal-3 | 0.44% |
| 5 | 6.78 | PEG 600 | 24 | 24.0% | | 24 | Na-Succinate pH 6.5 | 100 | mM | | | | | | |
| 6 | 6.98 | 2 Ethoxyethanol | 9.4 | 9.4% | | 4.7 | TRIS-Maleate pH 6.5 | 50 | mM | | 1,6 Hexanediol | 0.92 | M | | |
| 7 | 6.16 | PEG 600 | 28.1 | 28.1% | | 28.1 | Hepes pH 6.5 | 100 | mM | | Ammonium Sulfate | 0.154 | M | | |
| 8 | 5.91 | PEG DME 250 | 9.2 | 9.2% | | 4.6 | Hepes pH 6.5 | 100 | mM | | Cesium Chloride | 0.028 | M | | |
| 9 | 8.75 | Jeffamine M-600 | 9.8 | 9.8% | | 4.9 | Hepes pH 6.5 | 100 | mM | | | | | | |
| 10 | 7.94 | Glycerol | 8.6 | 8.6% | | 4.3 | TRIS-HCl pH 8.5 | 100 | mM | | | | | | |
| 11 | 5.93 | PEG 1500 | 26.2 | 26.2% | | 26.2 | Na-Malonate pH 4.0 | 100 | mM | | Jeffamine M-600 | 4.9% | | | |
| 12 | 7.89 | PEG 600 | 22.1 | 22.1% | | 22.1 | Hepes pH 8.5 | 100 | mM | | Sodium Chloride | 0.32 | M | | |
| 13 | 5.84 | PEG DME 250 | 5.8 | 5.8% | | 2.9 | Mopso pH 6.5 | 100 | mM | | Lithium Chloride | 0.418 | M | | |
| 14 | 7.88 | Isobutanol | 5.9 | 5.9% | | 2.95 | Bis-Tris Propane pH 6.5 | 100 | mM | | Spermidine | 0.02 | M | | |
| 15 | 6.19 | PEG 4K | 24.1 | 24.1% | | 24.1 | Na—K-Phosphate pH 5.5 | 100 | mM | | Sodium Iodide | 0.082 | M | | |
| 16 | 8.63 | Isobutanol | 10 | 10.0% | | 5 | Bis-Tris Propane pH 8.5 | 100 | mM | | | | | | |
| 17 | 6.04 | PEG 200 | 53.5 | 53.5% | | 26.75 | Na-Citrate pH 5.5 | 50 | mM | | Cesium Chloride | 0.146 | M | | |
| 18 | 7.02 | PEG MME 550 | 33.5 | 33.5% | | 16.75 | Hepes pH 7.5 | 100 | mM | | Sodium Fluoride | 0.156 | M | | |
| 19 | 5.38 | Ethanol | 33 | 33.0% | | 16.5 | TRIS-Maleate pH 4.5 | 50 | mM | | | | | Glucopyranoside | 0.82% |
| 20 | 5.82 | PEG 300 | 27 | 27.0% | | 13.5 | Bis-Tris Propane pH 8.5 | 100 | mM | | Acetonitrile | 0.8% | | | |
| 21 | 4.23 | PEG MME 2K | 26.4 | 26.4% | | 26.4 | Na-Cacodylate pH 4.5 | 100 | mM | | Sodium Chloride | 0.29 | M | | |
| 22 | 4.19 | Isobutanol | 4.2 | 4.2% | | 2.1 | Na-Cacodylate pH 4.5 | 100 | mM | | Cesium Chloride | 0.084 | M | | |
| 23 | 5.67 | PEG 10K | 14 | 14.0% | | 14 | Na—K-Phosphate pH 5.5 | 100 | mM | | Sodium Chloride | 0.1 | M | | |
| 24 | 6.96 | PEG 6K | 5.2 | 5.2% | | 5.2 | TRIS-HCl pH 7.5 | 100 | mM | | Acetonitrile | 2.96% | | | |
| 25 | 7.52 | PEG DME 2K | 13.2 | 13.2% | | 13.2 | TRIS-HCl pH 8.5 | 100 | mM | | Cobaltus Chloride | 0.0061 | M | | |
| 26 | 5.22 | Glycerol | 54.8 | 54.8% | | 27.4 | Na-Acetate pH 5.5 | 50 | mM | | NAD | 0.014 | M | | |
| 27 | 7.76 | PEG MME 5K | 23.8 | 23.8% | | 23.8 | Na-Malonate pH 4.0 | 100 | mM | | Acetonitrile | 1.92% | | | |
| 28 | 6.86 | PEG 10K | 24.5 | 24.5% | | 24.5 | TRIS-Maleate pH 6.5 | 50 | mM | | Ammonium Sulfate | 0.189 | M | | |
| 29 | 8 | PEG 6K | 25.1 | 25.1% | | 25.1 | Na—K-Phosphate pH 8.5 | 100 | mM | | Sodium Thiocyanate | 0.192 | M | | |
| 30 | 5.89 | PEG 300 | 50.1 | 50.1% | | 25.05 | Hepes pH 6.5 | 100 | mM | | Sodium Chloride | 0.295 | M | | |
| 31 | 8.25 | PEG DME 2K | 7 | 7.0% | | 7 | Bis-Tris Propane pH 7.5 | 100 | mM | | Spermidine | 0.012 | M | Triton X-100 | 0.44% |
| 32 | 6.1 | Ethylene Glycol | 58.1 | 58.1% | | 29.05 | Na-Citrate pH 5.5 | 50 | mM | | Jeffamine M-600 | 1.15% | | | |
| 33 | 4.76 | PEG DME 2K | 26.6 | 26.6% | | 26.6 | Na-Cacodylate pH 5.5 | 100 | mM | | Barium Chloride | 0.058 | M | | |
| 34 | 5.08 | PEG MME 2K | 21 | 21.0% | | 21 | Na-Citrate pH 4.5 | 50 | mM | | Lithium Chloride | 0.278 | M | | |
| 35 | 6.12 | PEG 4K | 22.8 | 22.8% | | 22.8 | Na-Cacodylate pH 4.5 | 100 | mM | | Spermidine | 0.014 | M | Glucopyranoside | 0.96% |
| 36 | 5.62 | PEG 4K | 22.8 | 22.8% | | 22.8 | Hepes pH 6.5 | 100 | mM | | | | | | |
| 37 | 8.95 | PEG 600 | 9.4 | 9.4% | | 9.4 | CAPSO pH 8.5 | 50 | mM | | | | | | |
| 38 | 7.2 | Ethanol | 39.6 | 39.6% | | 19.8 | TRIS-HCl pH 7.5 | 100 | mM | | Sodium Iodide | 0.372 | M | Cymal-3 | 0.84% |
| 39 | 10.57 | PEG MME 5K | 23.7 | 23.7% | | 23.7 | Na-Citrate pH 4.5 | 50 | mM | | Jeffamine M-600 | 2.2% | | | |
| 40 | 6.89 | Ethylene Glycol | 15 | 15.0% | | 7.5 | Na-Citrate pH 6.5 | 50 | mM | | Sodium Fluoride | 0.2064 | M | Glycerol | 2% |
| 41 | 4.63 | PEG 300 | 41.8 | 41.8% | | 20.9 | Na-Citrate pH 4.5 | 50 | mM | | Lithium Chloride | 0.216 | M | Cymal-3 | 1% |
| 42 | 8.12 | Ethylene Glycol | 5.8 | 5.8% | | 2.9 | Na—K-Phosphate pH 7.5 | 100 | mM | | | | | | |
| 43 | 10.65 | PEG 400 | 13.9 | 13.9% | | 6.95 | Na-Citrate pH 6.5 | 50 | mM | | Spermidine | 0.012 | M | | |
| 44 | 4.08 | PEG DME 250 | 5.4 | 5.4% | | 2.7 | Bis-Tris Propane pH 9.5 | 100 | mM | | | | | Cymal-3 | 0.24% |
| 45 | 7 | Glycerol | 8.4 | 8.4% | | 4.2 | Na—K-Phosphate pH 6.5 | 100 | mM | | Cesium Chloride | 0.086 | M | | |
| 46 | 6.2 | PEG 400 | 20 | 20.0% | | 10 | Na-Succinate pH 6.5 | 100 | mM | | Cesium Chloride | 0.196 | M | | |
| 47 | 8.49 | Ethylene Glycol | 31.4 | 31.4% | | 15.7 | Na—K-Phosphate pH 8.5 | 100 | mM | | Acetonitrile | 1.68% | | | |
| 48 | 4.47 | Sec-Butanol | 10 | 10.0% | | 5 | Na-Succinate pH 4.5 | 100 | mM | | Acetonitrile | 0.8% | | Triton X-100 | 0.2% |
| 49 | 10.31 | Jeffamine M-600 | 40 | 40.0% | | 20 | CAPSO pH 8.5 | 50 | mM | | | | | | |
| 50 | 4.35 | PEG MME 550 | 19.8 | 19.8% | | 9.9 | Na-Malonate pH 4.0 | 100 | mM | | | | | Glycerol | 2.4% |
| 51 | 5.82 | | | | | | Mopso pH 6.5 | 100 | mM | | Zinc Acetate | 0.012 | M | | |
| 52 | 5.73 | PEG 8K | 12.2 | 12.2% | | 12.2 | Mopso pH 7.5 | 100 | mM | | Cobaltus Chloride | 0.064 | M | | |
| 53 | 10 | Jeffamine M-600 | 18 | 18.0% | | 9 | Na-Citrate pH 5.5 | 25 | mM | | NAD | 0.006 | M | LDAO | 0.21% |
| 54 | 5.36 | PEG 10K | 12.1 | 12.1% | | 12.1 | Na-Citrate pH 5.5 | 50 | mM | | Cesium Chloride | 0.216 | M | | |
| 55 | 4.11 | PEG MME 5K | 38.3 | 38.3% | | 38.3 | Na-Malonate pH 4.0 | 100 | mM | | | | | | |
| 56 | 5.98 | Methanol | 41.6 | 41.6% | | 20.8 | Na-Citrate pH 5.5 | 50 | mM | | | | | C12E9 | 0.2% |
| 57 | 6.85 | Methanol | 30.2 | 30.2% | | 15.1 | TRIS-Maleate pH 5.5 | 50 | mM | | | | | | |
| 58 | 6.25 | Isopropanol | 43.6 | 43.6% | | 21.8 | Na-Citrate pH 5.5 | 50 | mM | | | | | | |
| 59 | 6.82 | PEG 600 | 37.2 | 37.2% | | 37.2 | Mopso pH 6.5 | 100 | mM | | | | | | |
| 60 | 4.63 | Isopropanol | 32 | 32.0% | | 15.8 | Bis-Tris Propane pH 9.5 | 100 | mM | | Ethanol | 2.8% | | | |
| 61 | 3.06 | 2 Ethoxyethanol | 31.4 | 31.4% | | 15.7 | TRIS-HCl pH 6.5 | 100 | mM | | ATP disodium salt | 0.018 | M | C12E9 | 0.2% |
| 62 | 10.72 | PEG 10K | 6.45 | 6.5% | | 6.45 | | 0 | mM | | Jeffamine M-600 | 3.25% | | | |
| 63 | 7.78 | MPD | 50 | 50.0% | | 25 | TRIS-Maleate pH 6.5 | 50 | mM | | | | | | |
| 64 | 6.13 | PEG MME 2K | 32.1 | 32.1% | | 32.1 | Hepes pH 6.5 | 100 | mM | | | | | | |
| 65 | 6.79 | PEG 600 | 44 | 44.0% | | 44 | Na-Succinate pH 7.5 | 100 | mM | | | | | | |
| 66 | 6.49 | Isobutanol | 3.8 | 3.8% | | 1.9 | Mopso pH 6.5 | 100 | mM | | 1,6 Hexanediol | 1.04 | M | | |
| 67 | 3.89 | 2 Ethoxyethanol | 27.5 | 27.5% | | 13.75 | Hepes pH 6.5 | 100 | mM | | NAD | 0.011 | M | | |
| 68 | 8.66 | PEG 10K | 21.7 | 21.7% | | 21.7 | CAPSO pH 8.5 | 50 | mM | | Sodium Iodide | 0.242 | M | Glycerol | 3.4% |
| 69 | 10.54 | Polyethyleneimine | 3 | 3.0% | | 3 | Na—K-Phosphate pH 8.5 | 100 | mM | | Sodium Thiocyanate | 0.076 | M | | |
| 70 | 3.33 | PEG MME 5K | 17.1 | 17.1% | | 17.1 | | 0 | mM | | Zinc Acetate | 0.134 | M | | |
| 71 | 6.16 | PEG 300 | 37.4 | 37.4% | | 18.7 | Na-Cacodylate pH 6.5 | 100 | mM | | Barium Chloride | 0.057 | M | C12E9 | 0.2% |
| 72 | 5.52 | PEG 400 | 31.5 | 31.5% | | 15.75 | Na-Succinate pH 6.5 | 100 | mM | | Magnesium Chloride | 0.15 | M | | |
| 73 | 3.71 | PEG 4K | 19.4 | 19.4% | | 19.4 | Na-Acetate pH 4.5 | 50 | mM | | Cupric Chloride | 0.051 | M | | |
| 74 | 9.53 | Polyethyleneimine | 3.5 | 3.5% | | 3.5 | Na-Citrate pH 5.5 | 50 | mM | | Cesium Chloride | 0.18 | M | LDAO | 0.11% |
| 75 | 5.26 | Isobutanol | 4.4 | 4.4% | | 2.2 | Na-Cacodylate pH 5.5 | 100 | mM | | 1,6 Hexanediol | 1.88 | M | | |
| 76 | 4.67 | Methanol | 45.6 | 45.6% | | 22.8 | Na-Malonate pH 4.0 | 100 | mM | | | | | | |
| 77 | 4.28 | PEG 300 | 56.6 | 56.6% | | 28.3 | TRIS-Maleate pH 4.5 | 50 | mM | | Zinc Acetate | 0.05 | M | | |
| 78 | 7.75 | PEG DME 250 | 20 | 20.0% | | 10 | CAPSO pH 8.5 | 50 | mM | | Lithium Chloride | 0.2 | M | C12E9 | 0.2% |
| 79 | 5.95 | PEG 6K | 5.3 | 5.3% | | 5.3 | Na-Cacodylate pH 7.5 | 100 | mM | | Zinc Acetate | 0.05 | M | | |
| 80 | 4 | PEG MME 5K | 10.1 | 10.1% | | 10.1 | Na-Cacodylate pH 4.5 | 100 | mM | | Calcium Chloride | 0.03 | M | | |
| 81 | 5.41 | 2 Ethoxyethanol | 49.4 | 49.4% | | 24.7 | TRIS-HCl pH 7.5 | 100 | mM | | Cobaltus Chloride | 0.057 | M | C12E9 | 0.2% |
| 82 | 9.03 | Jeffamine M-600 | 58.8 | 58.8% | | 29.4 | Bis-Tris Propane pH 9.5 | 100 | mM | | Ammonium Sulfate | 0.2 | M | | |
| 83 | 5.27 | Isopropanol | 38.2 | 38.2% | | 19.1 | Na-Citrate pH 4.5 | 50 | mM | | Cobaltus Chloride | 0.001 | M | | |
| 84 | 3.54 | PEG 8K | 26.6 | 26.6% | | 26.6 | TRIS-HCl pH 6.5 | 100 | mM | | Cesium Chloride | 0.09 | M | | |
| 85 | 5.77 | Methanol | 59.6 | 59.6% | | 29.8 | Na-Cacodylate pH 5.5 | 100 | mM | | | | | | |
| 86 | 8.54 | Isopropanol | 7.2 | 7.2% | | 3.6 | Na—K-Phosphate pH 8.5 | 100 | mM | | Acetonitrile | 2.4% | | Glycerol | 8.4% |
| 87 | 4.43 | PEG 4K | 30.8 | 30.8% | | 30.8 | Na-Acetate pH 4.5 | 50 | mM | | Sodium Chloride | 0.17 | M | | |
| 88 | 8.85 | Methanol | 28.6 | 28.6% | | 14.3 | CAPSO pH 8.5 | 50 | mM | | | | | | |
| 89 | 4.21 | Isobutanol | 3.8 | 3.8% | | 1.9 | | 0 | mM | | Cupric Chloride | 0.038 | M | | |
| 90 | 7.45 | PEG 6K | 16.3 | 16.3% | | 16.3 | Na—K-Phosphate pH 8.5 | 100 | mM | | | | | | |
| 91 | 5.96 | Isopropanol | 12 | 12.0% | | 6 | TRIS-Maleate pH 5.5 | 50 | mM | | Acetonitrile | 0.8% | | | |
| 92 | 3.37 | PEG 10K | 13 | 13.0% | | 13 | | 0 | mM | | | | | | |
| 93 | 6.63 | Dioxane | 46.4 | 46.4% | | 23.2 | Hepes pH 7.5 | 100 | mM | | ATP disodium salt | 0.01 | M | | |
| 94 | 6.86 | PEG 6K | 26.9 | 26.9% | | 26.9 | Na-Cacodylate pH 7.5 | 100 | mM | | | | | | |
| 95 | 7.42 | 2 Ethoxyethanol | 6.8 | 6.8% | | 3.4 | Na-Succinate pH 7.5 | 100 | mM | | DMSO | 0.9% | | | |
| 96 | 7.13 | Ammonium | 2.29 | 2.3 | M | 32.71428571 | TRIS-HCl pH 6.5 | 100 | mM | | | | | | |
| | | Sulfate | | | | | | | | | | | | | |
| 97 | 9.11 | PEG DME 250 | 10 | 10.0% | | 5 | Na-Cacodylate pH 7.5 | 100 | mM | | Jeffamine M-600 | 1% | | C12E9 | 0.2% |
| 98 | 5.53 | Ethylene Glycol | 4.2 | 4.2% | | 2.1 | Na-Cacodylate pH 6.5 | 100 | mM | | Magnesium Chloride | 0.162 | M | | |
| 99 | 6.49 | Sec-Butanol | 10 | 10.0% | | 5 | Na-Succinate pH 6.5 | 100 | mM | | | | | Glucopyranoside | 0.98% |
| 100 | 2.18 | PEG DME 2K | 11.15 | 11.2% | | 11.15 | | 0 | mM | | Zinc Acetate | 0.19 | M | | |
| 101 | 4.38 | PEG 1500 | 19.9 | 19.9% | | 19.9 | Na-Succinate pH 4.5 | 100 | mM | | Barium Chloride | 0.01 | M | | |
| 102 | 7.96 | Sec-Butanol | 10 | 10.0% | | 5 | CAPSO pH 8.5 | 100 | mM | | Ammonium Sulfate | 0.18 | M | Glucopyranoside | 0.64% |
| 103 | 4.21 | PEG 200 | 39 | 39.0% | | 19.5 | Na-Cacodylate pH 4.5 | 100 | mM | | Lithium Chloride | 0.43 | M | LDAO | 0.28% |
| 104 | 6.63 | PEG 200 | 30 | 30.0% | | 15 | Na-Succinate pH 7.5 | 100 | mM | | | | | | |
| 105 | 5.8 | PEG 600 | 8.6 | 8.6% | | 8.6 | Mopso pH 6.5 | 100 | mM | | Magnesium Chloride | 0.206 | M | | |
| 106 | 7.21 | Ethylene Glycol | 21.2 | 21.2% | | 10.6 | Hepes pH 7.5 | 100 | mM | | Acetonitrile | 3.2% | | Glycerol | 5.2% |
| 107 | 6.81 | PEG 400 | 48.2 | 48.2% | | 24.1 | Hepes pH 7.5 | 100 | mM | | Sodium Thiocyanate | 0.172 | M | | |
| 108 | 7.94 | PEG MME 550 | 19.1 | 19.1% | | 9.55 | TRIS-HCl pH 8.5 | 100 | mM | | 1,6 Hexanediol | 1.36 | M | | |
| 109 | 6.96 | PEG 6K | 11.3 | 11.3% | | 11.3 | Mopso pH 7.5 | 100 | mM | | Sodium Iodide | 0.204 | M | | |
| 110 | 8.1 | PEG 8K | 9.2 | 9.2% | | 9.2 | TRIS-HCl pH 8.5 | 100 | mM | | Cesium Chloride | 0.1 | M | | |
| 111 | 7.38 | PEG MME 5K | 11.9 | 11.9% | | 11.9 | Bis-Tris Propane pH 7.5 | 100 | mM | | | | | | |
| 112 | 8.16 | PEG 4K | 30.6 | 30.6% | | 30.6 | Bis-Tris Propane pH 8.5 | 100 | mM | | Calcium Chloride | 0.045 | M | | |
| 113 | 4.19 | PEG 600 | 42.8 | 41.0% | | 41 | Na-Acetate pH 4.5 | 50 | mM | | Magnesium Chloride | 0.134 | M | | |
| 114 | 5.52 | PEG 8K | 7.4 | 7.4% | | 7.4 | Na-Citrate pH 5.5 | 50 | mM | | Ethanol | 2.4% | | C12E9 | 0.2% |
| 115 | 9.53 | PEG MME 2K | 22.55 | 22.6% | | 22.55 | CAPSO pH 8.5 | 50 | mM | | Jeffamine M-600 | 4.45% | | | |
| 116 | 6 | PEG MME 550 | 31.1 | 31.1% | | 15.55 | Mopso pH 6.5 | 100 | mM | | Potassium Chloride | 0.136 | M | | |
| 117 | 11.08 | Dioxane | 2.5 | 2.5% | | 1.25 | | 0 | mM | | Spermidine | 0.02 | M | Glucopyranoside | 0.46% |
| 118 | 4.65 | | | | | | Na-Citrate pH 5.5 | 50 | mM | | Cupric Chloride | 0.005 | M | | |
| 119 | 4.4 | PEG 200 | 25.2 | 25.2% | | 12.6 | Na-Acetate pH 4.5 | 50 | mM | | ATP disodium salt | 0.019 | M | | |
| 120 | 6.66 | PEG 600 | 41.4 | 38.5% | | 38.5 | Mopso pH 6.5 | 100 | mM | | Sodium Iodide | 0.116 | M | | |
| 121 | 5.39 | PEG 10K | 26 | 26.0% | | 26 | Na-Cacodylate pH 6.5 | 100 | mM | | Magnesium Chloride | 0.124 | M | | |
| 122 | 6.15 | PEG MME 2K | 11.1 | 11.1% | | 11.1 | TRIS-Maleate pH 5.5 | 50 | mM | | Jeffamine M-600 | 0.9% | | | |
| 123 | 6 | 2 Ethoxyethanol | 39.6 | 39.6% | | 19.8 | Na-Citrate pH 5.5 | 50 | mM | | | | | | |
| 124 | 9.66 | Ethanol | 11.4 | 11.4% | | 5.7 | CAPSO pH 9.5 | 50 | mM | | DMSO | 1.5% | | LDAO | 0.1% |
| 125 | 7.07 | Dioxane | 2.5 | 2.5% | | 1.25 | Na-Cacodylate pH 7.5 | 100 | mM | | DMSO | 1.5% | | | |
| 126 | 5.56 | PEG 200 | 54.2 | 54.2% | | 27.1 | TRIS-Maleate pH 4.5 | 50 | mM | | Isopropanol | 1.4% | | | |
| 127 | 6.89 | MPD | 5.2 | 5.2% | | 2.6 | Na-Citrate pH 6.5 | 50 | mM | | Sodium Fluoride | 0.1104 | M | | |
| 128 | 7.18 | PEG DME 250 | 10.4 | 10.4% | | 5.2 | Na-Citrate pH 5.5 | 50 | mM | | | | | Maltoside | 0.42% |
| 129 | 6.52 | Isopropanol | 38.6 | 38.6% | | 19.3 | Na-Cacodylate pH 6.5 | 100 | mM | | Sodium Iodide | 0.188 | M | | |
| 130 | 4.31 | PEG MME 5K | 29.4 | 29.4% | | 29.4 | Na-Acetate pH 4.5 | 50 | mM | | Calcium Chloride | 0.063 | M | | |
| 131 | 8.53 | PEG MME 2K | 39.8 | 39.8% | | 39.8 | Bis-Tris Propane pH 7.5 | 100 | mM | | Jeffamine M-600 | 4.8% | | | |
| 132 | 4.17 | PEG 4K | 19.7 | 19.7% | | 19.7 | | 0 | mM | | Lithium Chloride | 0.122 | M | | |
| 133 | 7.98 | PEG 1500 | 15.7 | 15.7% | | 15.7 | Hepes pH 8.5 | 100 | mM | | | | | | |
| 134 | 8.37 | PEG 200 | 38.8 | 38.8% | | 19.4 | TRIS-HCl pH 8.5 | 100 | mM | | Spermidine | 0.019 | M | | |
| 135 | 4.66 | Isopropanol | 18.8 | 18.8% | | 9.4 | Na-Succinate pH 4.5 | 100 | mM | | Jeffamine M-600 | 0.5% | | | |
| 136 | 4.47 | PEG DME 250 | 7.4 | 7.4% | | 3.7 | Na-Succinate pH 4.5 | 100 | mM | | Ammonium Sulfate | 0.112 | M | | |
| 137 | 6.95 | Methanol | 19.4 | 19.4% | | 9.7 | TRIS-HCl pH 6.5 | 100 | mM | | | | | | |
| 138 | 5.11 | Ethylene Glycol | 3.6 | 3.6% | | 1.8 | Na-Cacodylate pH 5.5 | 100 | mM | | 1,6 Hexanediol | 0.08 | M | | |
| 139 | 7.57 | MPD | 26.4 | 26.4% | | 13.2 | Na-Citrate pH 6.5 | 25 | mM | | Lithium Chloride | 0.07 | M | Glycerol | 2.4% |
| 140 | 6.02 | Sec-Butanol | 4 | 4.0% | | 2 | | 0 | mM | | Ethanol | 2.6% | | | |
| 141 | 4.86 | PEG DME 250 | 28 | 28.0% | | 14 | TRIS-Maleate pH 4.5 | 50 | mM | | Cesium Chloride | 0.024 | M | | |
| 142 | 7.52 | PEG 8K | 35.1 | 35.1% | | 35.1 | TRIS-Maleate pH 6.5 | 50 | mM | | Jeffamine M-600 | 1.2% | | | |
| 143 | 6.23 | PEG 200 | 42 | 42.0% | | 21 | Mopso pH 7.5 | 100 | mM | | Cobaltus Chloride | 0.01 | M | | |
| 144 | 5.76 | PEG 4K | 39.2 | 39.2% | | 39.2 | Na-Acetate pH 5.5 | 50 | mM | | Sodium Thiocyanate | 0.136 | M | | |
| 145 | 8.03 | PEG 4K | 15.7 | 15.7% | | 15.7 | Hepes pH 8.5 | 100 | mM | | | | | | |
| 146 | 4.94 | PEG 10K | 27 | 27.0% | | 27 | Na-Acetate pH 5.5 | 50 | mM | | Magnesium Chloride | 0.104 | M | Triton X-100 | 0.05% |
| 147 | 10.45 | Jeffamine M-600 | 15 | 15.0% | | 7.5 | Na—K-Phosphate pH 6.5 | 100 | mM | | | | | | |
| 148 | 6.15 | PEG MME 5K | 36.9 | 36.9% | | 36.9 | Hepes pH 6.5 | 100 | mM | | 1,6 Hexanediol | 0.6 | M | | |
| 149 | 7.57 | PEG MME 550 | 23.5 | 23.5% | | 11.75 | TRIS-HCl pH 8.5 | 100 | mM | | | | | | |
| 150 | 3.08 | PEG 6K | 9 | 9.0% | | 9 | | 0 | mM | | Cupric Chloride | 0.01 | M | | |
| 151 | 6.86 | 2 Ethoxyethanol | 6.4 | 6.4% | | 3.2 | TRIS-Maleate pH 6.5 | 50 | mM | | Ethanol | 0.2% | | | |
| 152 | 5.6 | PEG 6K | 13.4 | 13.4% | | 13.4 | Na-Citrate pH 5.5 | 50 | mM | | 1,6 Hexanediol | 0.99 | M | | |
| 153 | 10.23 | Polyethyleneimine | 2.5 | 2.5% | | 2.5 | Na—K-Phosphate pH 7.5 | 100 | mM | | Sodium Chloride | 0.28 | M | | |
| 154 | 10.44 | Methanol | 54 | 54.0% | | 27 | Na-Succinate pH 6.5 | 100 | mM | | Spermidine | 0.015 | M | | |
| 155 | 7.02 | Polyethyleneimine | 1.5 | 1.5% | | 1.5 | Na-Acetate pH 4.5 | 50 | mM | | Cesium Chloride | 0.17 | M | | |
| 156 | 3.93 | Sec-Butanol | 10 | 10.0% | | 5 | Na-Malonate pH 4.0 | 100 | mM | | Calcium Chloride | 0.086 | M | Maltoside | 0.4% |
| 157 | 7.18 | Dioxane | 2.5 | 2.5% | | 1.25 | Mopso pH 6.5 | 100 | mM | | Sodium Chloride | 0.35 | M | | |
| 158 | 9.74 | Jeffamine M-600 | 20 | 20.0% | | 10 | Na-Cacodylate pH 4.5 | 100 | mM | | | | | Maltoside | 0.2% |
| 159 | 6.88 | PEG DME 250 | 25.6 | 25.6% | | 12.8 | Hepes pH 7.5 | 100 | mM | | Potassium Chloride | 0.122 | M | | |
| 160 | 4.78 | Glycerol | 37.8 | 37.8% | | 18.9 | | 0 | mM | | Ethanol | 2.3% | | | |
| 161 | 7.84 | PEG 4K | 23.2 | 23.2% | | 23.2 | Na-Malonate pH 6.0 | 100 | mM | | Sodium Thiocyanate | 0.144 | M | Cymal-3 | 0.7% |
| 162 | 6.05 | PEG 8K | 6 | 6.0% | | 6 | Mopso pH 6.5 | 100 | mM | | EDTA | 0.014 | M | | |
| 163 | 5.97 | PEG 4K | 8.5 | 8.5% | | 8.5 | Mopso pH 6.5 | 100 | mM | | Sodium Chloride | 0.16 | M | C12E9 | 0.2% |
| 164 | 8.98 | PEG 200 | 45.8 | 45.8% | | 22.9 | CAPSO pH 9.5 | 50 | mM | | | | | | |
| 165 | 7.43 | Jeffamine M-600 | 0.5 | 0.5% | | 2.1 | Hepes pH 7.5 | 100 | mM | | | | | | |
| 166 | 3.45 | PEG DME 250 | 18.5 | 18.5% | | 9.25 | | 0 | mM | | 1,6 Hexanediol | 1.86 | M | | |
| 167 | 6.86 | PEG DME 250 | 10 | 10.0% | | 5 | Hepes pH 7.5 | 100 | mM | | ATP disodium salt | 0.011 | M | LDAO | 0.46% |
| 168 | 7.22 | PEG 10K | 6.6 | 6.6% | | 6.6 | Na—K-Phosphate pH 6.5 | 100 | mM | | Ethanol | 3.8% | | | |
| 169 | 4.81 | Methanol | 29.2 | 29.2% | | 14.6 | Na-Cacodylate pH 4.5 | 100 | mM | | Cobaltus Chloride | 0.053 | M | LDAO | 0.41% |
| 170 | 9.75 | 2 Ethoxyethanol | 21 | 21.0% | | 10.5 | CAPSO pH 9.5 | 50 | mM | | EDTA | 0.014 | M | | |
| 171 | 5.05 | 2 Ethoxyethanol | 43.2 | 43.2% | | 21.6 | Na-Citrate pH 4.5 | 50 | mM | | Ammonium Sulfate | 0.182 | M | | |
| 172 | 10.56 | Polyethyleneimine | 2.3 | 2.3% | | 2.3 | Na-Succinate pH 6.5 | 100 | mM | | Sodium Iodide | 0.184 | M | | |
| 173 | 5.22 | PEG MME 2K | 28.6 | 28.6% | | 28.6 | Na-Citrate pH 5.5 | 50 | mM | | Sodium Chloride | 0.45 | M | | |
| 174 | 7.21 | Ethanol | 40.4 | 40.4% | | 20.2 | Hepes pH 7.5 | 100 | mM | | | | | | |
| 175 | 3.28 | PEG MME 550 | 23.7 | 23.7% | | 11.85 | | 0 | mM | | Cadmium Chloride | 0.008 | M | | |
| 176 | 6.41 | Sec-Butanol | 4 | 4.0% | | 2 | Mopso pH 6.5 | 100 | mM | | Cesium Chloride | 0.158 | M | | |
| 177 | 9.39 | Ethylene Glycol | 4.4 | 4.4% | | 2.2 | CAPSO pH 9.5 | 50 | mM | | Barium Chloride | 0.01 | M | | |
| 178 | 8.62 | PEG 600 | 27.2 | 27.2% | | 27.2 | CAPSO pH 9.5 | 50 | mM | | NAD | 0.012 | M | | |
| 179 | 7.37 | PEG 10K | 20 | 20.0% | | 20 | Mopso pH 6.5 | 100 | mM | | Potassium Chloride | 0.05 | M | LDAO | 0.12% |
| 180 | 6.75 | PEG 600 | 53.6 | 14.0% | | 14 | Bis-Tris Propane pH 7.5 | 100 | mM | | Ethanol | 4.2% | | | |
| 181 | 4.93 | Isopropanol | 40.6 | 40.6% | | 20.3 | Bis-Tris Propane pH 9.5 | 100 | mM | | Lithium Chloride | 0.26 | M | | |
| 182 | 4.2 | PEG 4K | 34.7 | 34.7% | | 34.7 | Na-Cacodylate pH 4.5 | 100 | mM | | Acetonitrile | 2.16% | | | |
| 183 | 8.45 | Ethylene Glycol | 3.8 | 3.8% | | 1.9 | Bis-Tris Propane pH 8.5 | 100 | mM | | Acetonitrile | 2.72% | | | |
| 184 | 6.88 | Sec-Butanol | 20 | 20.0% | | 10 | | 0 | mM | | Ethanol | 10% | | | |
| 185 | 8.93 | Jeffamine M-600 | 8 | 8.0% | | 4 | Na-Acetate pH 4.5 | 50 | mM | | Ethanol | 2% | | | |
| 186 | 9.74 | PEG 300 | 17.8 | 17.8% | | 8.9 | CAPSO pH 9.5 | 50 | mM | | | | | | |
| 187 | 8.4 | Sec-Butanol | 10 | 10.0% | | 5 | Bis-Tris Propane pH 8.5 | 100 | mM | | Sodium Thiocyanate | 0.08 | M | | |
| 188 | 4.64 | Ammonium | 2 | 2.0 | M | 28.57142857 | Na-Citrate pH 4.5 | 50 | mM | | | | | | |
| | | Sulfate | | | | | | | | | | | | | |
| 189 | 7.37 | Isopropanol | 39 | 39.0% | | 19.5 | Na-Cacodylate pH 4.5 | 100 | mM | | Jeffamine M-600 | 4.7% | | | |
| 190 | 7.89 | PEG 1500 | 9.8 | 9.8% | | 9.8 | Mopso pH 7.5 | 100 | mM | | Potassium Chloride | 0.128 | M | | |
| 191 | 4.36 | MPD | 37.8 | 37.8% | | 18.9 | Bis-Tris Propane pH 6.5 | 100 | mM | | Cobaltus Chloride | 0.08 | M | LDAO | 0.11% |
| 192 | 7.2 | PEG MME 2K | 30.4 | 30.4% | | 30.4 | Na-Succinate pH 7.5 | 100 | mM | | Ammonium Sulfate | 0.224 | M | | |
| 193 | 4.13 | Isobutanol | 2.8 | 2.8% | | 1.4 | Na-Cacodylate pH 4.5 | 100 | mM | | Lithium Chloride | 0.174 | M | | |
| 194 | 7.8 | PEG 300 | 26.4 | 26.4% | | 13.2 | Na-Malonate pH 4.0 | 100 | mM | | Cesium Chloride | 0.224 | M | | |
| 195 | 8.32 | Methanol | 46.4 | 46.4% | | 23.2 | Bis-Tris Propane pH 8.5 | 100 | mM | | Magnesium Chloride | 0.23 | M | Cymal-3 | 0.2% |
| 196 | 7.95 | Ethylene Glycol | 5.8 | 5.8% | | 2.9 | Bis-Tris Propane pH 7.5 | 100 | mM | | Ammonium Sulfate | 0.11 | M | | |
| 197 | 7.03 | Isopropanol | 40 | 40.0% | | 20 | Na-Succinate pH 6.5 | 100 | mM | | | | | | |
| 198 | 10.16 | Jeffamine M-600 | 26.6 | 26.6% | | 13.3 | Mopso pH 7.5 | 100 | mM | | Acetonitrile | 3.76% | | | |
| 199 | 6.43 | Isopropanol | 44.4 | 44.4% | | 22.2 | Na-Citrate pH 5.5 | 50 | mM | | NAD | 0.018 | M | | |
| 200 | 7.84 | MPD | 42.8 | 42.8% | | 21.4 | TRIS-HCl pH 8.5 | 100 | mM | | Calcium Chloride | 0.029 | M | | |
| 201 | 6.68 | PEG 400 | 19.8 | 19.8% | | 9.9 | Na-Succinate pH 7.5 | 100 | mM | | Acetonitrile | 1.04% | | | |
| 202 | 4.63 | MPD | 8.6 | 8.6% | | 4.3 | TRIS-Maleate pH 4.5 | 50 | mM | | EDTA | 0.011 | M | | |
| 203 | 7.26 | PEG 300 | 31.8 | 31.8% | | 15.9 | Na-Citrate pH 5.5 | 50 | mM | | Sodium Chloride | 0.2 | M | | |
| 204 | 5.59 | Ethylene Glycol | 23 | 23.0% | | 11.5 | | 0 | mM | | Cadmium Chloride | 0.03 | M | | |
| 205 | 5.43 | PEG 4K | 8.4 | 8.4% | | 8.4 | Na-Succinate pH 5.5 | 100 | mM | | | | | | |
| 206 | 10.63 | Jeffamine M-600 | 8.4 | 8.4% | | 4.2 | Na—K-Phosphate pH 7.5 | 100 | mM | | Ethanol | 3.6% | | | |
| 207 | 5.86 | 2 Ethoxyethanol | 29.4 | 29.4% | | 14.7 | Bis-Tris Propane pH 8.5 | 100 | mM | | DMSO | 1.32% | | Maltoside | 0.24% |
| 208 | 9.66 | Methanol | 23.4 | 23.4% | | 11.7 | CAPSO pH 9.5 | 50 | mM | | DMSO | 0.72% | | LDAO | 0.5% |
| 209 | 9.58 | Jeffamine M-600 | 10 | 10.0% | | 5 | Na—K-Phosphate pH 6.5 | 100 | mM | | | | | | |
| 210 | 6.41 | PEG 300 | 27 | 27.0% | | 13.5 | Na—K-Phosphate pH 5.5 | 100 | mM | | Ethanol | 2% | | Glycerol | 8.2% |
| 211 | 6.1 | PEG DME 250 | 10.2 | 10.2% | | 5.1 | Bis-Tris Propane pH 8.5 | 100 | mM | | Lithium Chloride | 0.17 | M | | |
| 212 | 10.12 | PEG 400 | 10.4 | 10.4% | | 5.2 | Na—K-Phosphate pH 7.5 | 100 | mM | | Jeffamine M-600 | 2.5% | | | |
| 213 | 7.83 | Ammonium | 3 | 3.0 | M | 42.85714286 | TRIS-HCl pH 7.5 | 100 | mM | | | | | | |
| | | Sulfate | | | | | | | | | | | | | |
| 214 | 7.08 | Isopropanol | 9.4 | 9.4% | | 4.7 | TRIS-Maleate pH 6.5 | 50 | mM | | 1,6 Hexanediol | 1.2 | M | | |
| 215 | 6.17 | | | | | | Na-Cacodylate pH 6.5 | 100 | mM | | 1,6 Hexanediol | 1.68 | M | Glycerol | 8% |
| 216 | 11.03 | Isobutanol | 3 | 3.0% | | 1.5 | | 0 | mM | | Spermidine | 0.017 | M | | |
| 217 | 5.35 | PEG 8K | 33.2 | 33.2% | | 33.2 | Na-Citrate pH 4.5 | 50 | mM | | | | | | |
| 218 | 7.59 | MPD | 13.2 | 13.2% | | 6.6 | Na-Succinate pH 7.5 | 100 | mM | | Ethanol | 2.4% | | Cymal-3 | 0.2% |
| 219 | 3.2 | PEG DME 250 | 10 | 10.0% | | 5 | | 0 | mM | | ATP disodium salt | 0.006 | M | | |
| 220 | 5.2 | PEG MME 5K | 13.3 | 13.3% | | 13.3 | | 0 | mM | | Ethanol | 0.4% | | | |
| 221 | 6.17 | Isobutanol | 4 | 4.0% | | 2 | Hepes pH 6.5 | 100 | mM | | 1,6 Hexanediol | 1.64 | M | | |
| 222 | 4.79 | PEG MME 5K | 18.4 | 18.4% | | 18.4 | Na-Citrate pH 4.5 | 50 | mM | | | | | Glucopyranoside | 0.2% |
| 223 | 10.56 | MPD | 53.6 | 53.6% | | 26.8 | Na-Succinate pH 7.5 | 100 | mM | | Jeffamine M-600 | 4.2% | | Glycerol | 3.4% |
| 224 | 7.13 | Ethylene Glycol | 4.2 | 4.2% | | 2.1 | Hepes pH 6.5 | 100 | mM | | Spermidine | 0.012 | M | | |
| 225 | 9.2 | PEG 200 | 26.4 | 26.4% | | 13.2 | Na-Succinate pH 6.5 | 100 | mM | | Jeffamine M-600 | 1.2% | | | |
| 226 | 5.42 | PEG MME 550 | 32.8 | 32.8% | | 16.4 | Na-Malonate pH 6.0 | 100 | mM | | | | | | |
| 227 | 6.46 | PEG 200 | 16.8 | 16.8% | | 8.4 | Na-Cacodylate pH 7.5 | 100 | mM | | Cupric Chloride | 0.01 | M | | |
| 228 | 6.99 | | | | | | Na-Citrate pH 6.5 | 50 | mM | | EDTA | 0.018 | M | | |
| 229 | 4.47 | PEG 200 | 27.4 | 27.4% | | 13.7 | Na-Citrate pH 4.5 | 50 | mM | | Sodium Chloride | 0.26 | M | | |
| 230 | 6.07 | PEG 10K | 28.4 | 28.4% | | 28.4 | Hepes pH 6.5 | 100 | mM | | Sodium Chloride | 0.36 | M | | |
| 231 | 9.14 | 2 Ethoxyethanol | 17.2 | 17.2% | | 8.6 | CAPSO pH 9.5 | 50 | mM | | | | | | |
| 232 | 7.72 | Polyethyleneimine | 1.7 | 1.7% | | 1.7 | Na-Cacodylate pH 5.5 | 100 | mM | | DMSO | 1.38% | | | |
| 233 | 8.68 | PEG 4K | 26.4 | 26.4% | | 26.4 | Bis-Tris Propane pH 8.5 | 100 | mM | | Potassium Chloride | 0.19 | M | | |
| 234 | 9.59 | PEG MME 5K | 7.7 | 7.7% | | 7.7 | CAPSO pH 9.5 | 50 | mM | | Sodium Chloride | 0.2 | M | | |
| 235 | 8.62 | PEG 200 | 6.6 | 6.6% | | 3.3 | Bis-Tris Propane pH 8.5 | 100 | mM | | Potassium Chloride | 0.07 | M | | |
| 236 | 4.33 | PEG 4K | 14.4 | 14.4% | | 14.4 | CAPSO pH 9.5 | 50 | mM | | NAD | 0.024 | M | | |
| 237 | 4.45 | PEG 200 | 46.8 | 46.8% | | 23.4 | TRIS-Maleate pH 4.5 | 50 | mM | | Lithium Chloride | 0.408 | M | | |
| 238 | 6.67 | PEG 400 | 9.8 | 9.8% | | 4.9 | Na-Succinate pH 7.5 | 100 | mM | | Potassium Chloride | 0.06 | M | | |
| 239 | 7.98 | PEG 6K | 13 | 13.0% | | 13 | TRIS-HCl PH 8.5 | 100 | mM | | EDTA | 0.022 | M | C12E9 | 0.2% |
| 240 | 6.54 | PEG DME 250 | 10 | 10.0% | | 5 | TRIS-HCl pH 7.5 | 100 | mM | | Ammonium Sulfate | 0.112 | M | | |
| 241 | 10.99 | Polyethyleneimine | 2.8 | 2.8% | | 2.8 | Na-Citrate pH 4.5 | 50 | mM | | | | | | |
| 242 | 4.48 | Glycerol | 13.8 | 13.8% | | 6.9 | | 0 | mM | | Zinc Acetate | 0.148 | M | | |
| 243 | 7.43 | MPD | 54.4 | 54.4% | | 27.2 | Na-Succinate pH 6.5 | 100 | mM | | | | | | |
| 244 | 5.77 | Ethylene Glycol | 10.8 | 10.8% | | 5.4 | Na-Cacodylate pH 6.5 | 100 | mM | | ATP disodium salt | 0.019 | M | | |
| 245 | 4.5 | PEG 1500 | 11.6 | 11.6% | | 11.6 | TRIS-Maleate pH 4.5 | 50 | mM | | Potassium Chloride | 0.054 | M | | |
| 246 | 3.82 | PEG 4K | 25.4 | 25.4% | | 25.4 | Na-Citrate pH 4.5 | 50 | mM | | Zinc Acetate | 0.04 | M | | |
| 247 | 4.05 | PEG 8K | 25.4 | 25.4% | | 25.4 | TRIS-Maleate pH 4.5 | 50 | mM | | Magnesium Chloride | 0.106 | M | | |
| 248 | 8.29 | PEG MME 5K | 36.8 | 36.8% | | 36.8 | Bis-Tris Propane pH 8.5 | 100 | mM | | Acetonitrile | 1.6% | | | |
| 249 | 5.8 | MPD | 27 | 27.0% | | 13.5 | Bis-Tris Propane pH 9.5 | 100 | mM | | Ammonium Sulfate | 0.1 | M | | |
| 250 | 5.92 | PEG MME 550 | 35 | 35.0% | | 17.5 | Bis-Tris Propane pH 8.5 | 100 | mM | | Barium Chloride | 0.03 | M | | |
| 251 | 4.67 | PEG 8K | 14.2 | 14.2% | | 14.2 | Na-Citrate pH 4.5 | 50 | mM | | | | | | |
| 252 | 6 | Glycerol | 34.4 | 34.4% | | 17.2 | TRIS-Maleate pH 5.5 | 50 | mM | | 2,2,2-Trifluoroethanol | 4% | | | |
| 253 | 4.61 | Ethylene Glycol | 32.8 | 32.8% | | 16.4 | Na-Acetate pH 4.5 | 50 | mM | | | | | | |
| 254 | 7.89 | PEG MME 2K | 19.6 | 19.6% | | 19.6 | Na—K-Phosphate pH 8.5 | 100 | mM | | Taurine | 0.065 | M | | |
| 255 | 4.7 | PEG DME 250 | 10 | 10.0% | | 5 | Na-Citrate pH 4.5 | 50 | mM | | Dextran Sulfate | 1.56% | | | |
| 256 | 3.89 | PEG MME 2K | 15 | 15.0% | | 15 | | 0 | mM | | PEG 400 | 2.9% | | Cymal-3 | 0.84% |
| 257 | 5.63 | 2 Ethoxyethanol | 24.8 | 24.8% | | 12.4 | Na-Succinate pH 5.5 | 100 | mM | | Trimethylamine HCl | 0.082 | M | | |
| 258 | 8.6 | Glycerol | 19.4 | 19.4% | | 9.7 | CAPSO pH 8.5 | 50 | mM | | Strontium Chloride | 0.09 | M | | |
| 259 | 6.45 | Glycerol | 29.6 | 29.6% | | 14.8 | Na-Citrate pH 6.5 | 50 | mM | | Ethyl Acetate | 1.81% | | | |
| 260 | 4.56 | PEG MME 550 | 12.9 | 12.9% | | 6.45 | Na-Succinate pH 4.5 | 100 | mM | | 2,2,2-Trifluoroethanol | 1.1% | | | |
| 261 | 6.63 | Sec-Butanol | 12 | 12.0% | | 6 | Na-Succinate pH 6.5 | 100 | mM | | Glycine | 0.108 | M | | |
| 262 | 3.8 | PEG 10K | 19.2 | 19.2% | | 19.2 | TRIS-HCl pH 6.5 | 100 | mM | | Glycerol Anhydrous | 1% | | | |
| 263 | 6.45 | MPD | 38.6 | 38.6% | | 19.3 | Na-Cacodylate pH 6.5 | 100 | mM | | Manganese Chloride | 0.007 | M | | |
| 264 | 8.35 | Methanol | 36.4 | 36.4% | | 18.2 | Bis-Tris Propane pH 8.5 | 100 | mM | | D (+) Glucose | 5% | | | |
| 265 | 5.75 | Isobutanol | 9 | 9.0% | | 4.5 | | 0 | mM | | sec-butanol | 9% | | Maltoside | 0.3% |
| 266 | 7.15 | Isobutanol | 5.4 | 5.4% | | 2.7 | TRIS-HCl pH 7.5 | 100 | mM | | 2,2,2-Trifluoroethanol | 1.1% | | | |
| 267 | 6.1 | PEG MME 550 | 19.1 | 19.1% | | 9.55 | Na-Cacodylate pH 6.5 | 100 | mM | | Xylitol | 1% | | | |
| 268 | 7.81 | PEG 400 | 37.6 | 37.6% | | 18.8 | Hepes pH 8.5 | 100 | mM | | Betaine Monohydrate | 0.01 | M | | |
| 269 | 8.75 | Polyethyleneimine | 3.9 | 3.9% | | 3.9 | Hepes pH 7.5 | 100 | mM | | Betaine Monohydrate | 0.036 | M | Triton X-100 | 0.24% |
| 270 | 7.03 | Dioxane | 2.5 | 2.5% | | 1.25 | TRIS-Maleate pH 6.5 | 50 | mM | | 1,4 Butanediol | 3.8% | | | |
| 271 | 4.55 | Dioxane | 2.5 | 2.5% | | 1.25 | Na-Citrate pH 4.5 | 50 | mM | | | | | | |
| 272 | 4.49 | PEG 4K | 12 | 12.0% | | 12 | TRIS-Maleate pH 5.5 | 50 | mM | | PEG 400 | 2% | | Triton X-100 | 0.92% |
| 273 | 5.6 | PEG MME 550 | 24 | 24.0% | | 12 | TRIS-Maleate pH 5.5 | 50 | mM | | Glycyl-Glycyl-Glycine | 0.015 | M | | |
| 274 | 10.49 | Polyethyleneimine | 2.7 | 2.7% | | 2.7 | | 0 | mM | | Urea | 0.092 | M | | |
| 275 | 7.72 | Glycerol | 43.6 | 43.6% | | 21.8 | Na—K-Phosphate pH 8.5 | 100 | mM | | Ethylene Glycol | 1.2% | | LDAO | 0.42% |
| 276 | 8.63 | PEG 6K | 22.6 | 22.6% | | 22.6 | Na—K-Phosphate pH 8.5 | 100 | mM | | 2,2,2-Trifluoroethanol | 1% | | | |
| 277 | 7.2 | Ethanol | 4.2 | 4.2% | | 2.1 | Na—K-Phosphate pH 6.5 | 100 | mM | | Sodium Chloride | 0.01 | M | | |
| 278 | 5.81 | PEG 200 | 19 | 19.0% | | 9.5 | Bis-Tris Propane pH 8.5 | 100 | mM | | Ethylene Glycol | 4% | | | |
| 279 | 6.32 | Sec-Butanol | 10 | 10.0% | | 5 | | 0 | mM | | Xylitol | 3% | | | |
| 280 | 6.24 | PEG 200 | 56.6 | 56.6% | | 28.3 | TRIS-HCl pH 7.5 | 100 | mM | | 1,4-Dithio-DL-Threitol | 0.079 | M | | |
| 281 | 8.3 | Isopropanol | 20 | 20.0% | | 10 | Hepes pH 8.5 | 100 | mM | | | | | | |
| 282 | 5.33 | PEG 8K | 6.8 | 6.8% | | 6.8 | Na-Succinate pH 5.5 | 100 | mM | | Dextran Sulfate | 2.58% | | | |
| 283 | 4.6 | PEG DME 250 | 16.6 | 16.6% | | 8.3 | Na-Acetate pH 4.5 | 50 | mM | | MPD | 1% | | Cymal-3 | 0.1% |
| 284 | 6.39 | PEG 200 | 22.6 | 22.6% | | 11.3 | Na-Succinate pH 6.5 | 100 | mM | | Glycine | 0.254 | M | | |
| 285 | 6.24 | PEG 1500 | 29 | 29.0% | | 29 | TRIS-Maleate pH 5.5 | 50 | mM | | sec-butanol | 1.3% | | | |
| 286 | 5.98 | PEG 6K | 29.7 | 29.7% | | 29.7 | Hepes pH 6.5 | 100 | mM | | Guanidine HCl | 0.042 | M | | |
| 287 | 5.63 | 2 Ethoxyethanol | 17.2 | 17.2% | | 8.6 | Na-Succinate pH 5.5 | 100 | mM | | | | | | |
| 288 | 3.65 | PEG 10K | 9.3 | 9.3% | | 9.3 | TRIS-HCl pH 6.5 | 100 | mM | | Strontium Chloride | 0.011 | M | C12E9 | 0.2% |
| 289 | 7.33 | | | | | | Mopso pH 6.5 | 100 | mM | | ATP disodium salt | 0.01 | M | | |
| 290 | 7.51 | MPD | 26.2 | 26.2% | | 13.1 | Na-Succinate pH 7.5 | 100 | mM | | Glycyl-Glycyl-Glycine | 0.005 | M | | |
| 291 | 6.92 | PEG 1500 | 33.8 | 33.8% | | 33.8 | Na-Cacodylate pH 7.5 | 100 | mM | | D (+) Glucose | 1.1% | | | |
| 292 | 6.41 | PEG DME 2K | 5.8 | 5.8% | | 5.8 | | 0 | mM | | 1,4-Dithio-DL-Threitol | 0.079 | M | | |
| 293 | 6.46 | Methanol | 18.8 | 18.8% | | 9.4 | Na-Succinate pH 6.5 | 100 | mM | | Ethyl Acetate | 1.68% | | | |
| 294 | 3.41 | PEG DME 250 | 26 | 26.0% | | 13 | | 0 | mM | | Betaine Monohydrate | 0.006 | M | | |
| 295 | 5.02 | Ethylene Glycol | 40.8 | 40.8% | | 20.4 | TRIS-Maleate pH 4.5 | 50 | mM | | sec-butanol | 4.6% | | | |
| 296 | 7.66 | PEG 4K | 29.1 | 29.1% | | 29.1 | Na-Citrate pH 5.5 | 50 | mM | | | | | | |
| 297 | 7.09 | PEG 400 | 38 | 38.0% | | 19 | Na-Cacodylate pH 6.5 | 100 | mM | | | | | | |
| 298 | 6.15 | Isopropanol | 42 | 42.0% | | 21 | Hepes pH 6.5 | 100 | mM | | sec-butanol | 1% | | | |
| 299 | 7.78 | PEG 300 | 49.4 | 49.4% | | 23.7 | Na-Citrate pH 4.5 | 50 | mM | | Guanidine HCl | 0.02 | M | Glucopyranoside | 0.4% |
| 300 | 7.76 | PEG DME 250 | 36.2 | 36.2% | | 18.1 | Hepes pH 8.5 | 100 | mM | | Guanidine HCl | 0.088 | M | | |
| 301 | 8.99 | Isobutanol | 5.6 | 5.6% | | 2.8 | CAPSO pH 8.5 | 50 | mM | | D (+) Glucose | 1.5% | | | |
| 302 | 6.1 | Glycerol | 32.6 | 32.6% | | 16.3 | Na-Cacodylate pH 6.5 | 100 | mM | | 1,4 Butanediol | 1.3% | | | |
| 303 | 4.63 | MPD | 21.6 | 21.6% | | 10.8 | Na-Succinate pH 4.5 | 100 | mM | | PEG 400 | 2% | | | |
| 304 | 7.96 | PEG 4K | 9 | 9.0% | | 9 | TRIS-HCl pH 8.5 | 100 | mM | | | | | Glycerol | 5.4% |
| 305 | 7.59 | PEG MME 550 | 33.9 | 33.9% | | 16.95 | Na-Malonate pH 6.0 | 100 | mM | | Glycine | 0.036 | M | | |
| 306 | 4.79 | PEG 8K | 34 | 34.0% | | 34 | Na-Cacodylate pH 5.5 | 100 | mM | | 1,4 Butanediol | 2.7% | | | |
| 307 | 5.01 | PEG DME 250 | 20 | 20.0% | | 10 | Na-Cacodylate pH 5.5 | 100 | mM | | Glycine | 0.286 | M | | |
| 308 | 6.23 | PEG 8K | 23.3 | 23.3% | | 23.3 | Na-Succinate pH 6.5 | 100 | mM | | 1,4 Butanediol | 0.5% | | | |
| 309 | 7.88 | MPD | 47.8 | 47.8% | | 23.9 | TRIS-HCl pH 7.5 | 100 | mM | | | | | | |
| 310 | 4.79 | Ethanol | 36.6 | 36.6% | | 18.3 | Na-Acetate pH 4.5 | 50 | mM | | Trimethylamine HCl | 0.092 | M | | |
| 311 | 8.08 | PEG 1500 | 19.5 | 19.5% | | 19.5 | Hepes pH 8.5 | 100 | mM | | 1,4-Dithio-DL-Threitol | 0.065 | M | Glucopyranoside | 0.36% |
| 312 | 5.2 | PEG 8K | 33.8 | 33.8% | | 33.8 | TRIS-Maleate pH 4.5 | 50 | mM | | Ethylene Glycol | 3.6% | | | |
| 313 | 7.46 | Sec-Butanol | 6.6 | 6.6% | | 3.3 | Bis-Tris Propane pH 7.5 | 100 | mM | — | Ethylene Glycol | 4.5% | | | |
| 314 | 7.97 | PEG DME 250 | 10 | 10.0% | | 5 | TRIS-HCl pH 8.5 | 100 | mM | | | | | | |
| 315 | 8.03 | Methanol | 19 | 19.0% | | 9.5 | Na-Citrate pH 4.5 | 50 | mM | | | | | Glycerol | 2% |
| 316 | 5.99 | Isobutanol | 4.4 | 4.4% | | 2.2 | Bis-Tris Propane pH 8.5 | 100 | mM | | PEG 400 | 2.6% | | | |
| 317 | 5.43 | PEG 1500 | 28.1 | 28.1% | | 28.1 | Na-Malonate pH 7.0 | 100 | mM | | 2,2,2-Trifluoroethanol | 4.3% | | Glucopyranoside | 0.4% |
| 318 | 3.34 | PEG 10K | 9.7 | 9.7% | | 9.7 | | 0 | mM | | Taurine | 0.1 | M | Triton X-100 | 0.28% |
| 319 | 6.96 | PEG DME 250 | 20 | 20.0% | | 10 | Na-Succinate pH 7.5 | 100 | mM | | Glycine | 0.146 | M | | |
| 320 | 9.69 | PEG 6K | 15.2 | 15.2% | | 15.2 | CAPSO pH 9.5 | 50 | mM | | PEG 400 | 2.5% | | | |
| 321 | 5.45 | PEG 300 | 14 | 14.0% | | 7 | Na-Succinate pH 5.5 | 100 | mM | | Guanidine HCl | 0.046 | M | Glucopyranoside | 0.4% |
| 322 | 8.56 | PEG 4K | 15.5 | 15.5% | | 15.5 | CAPSO pH 8.5 | 50 | mM | | | | | | |
| 323 | 7.46 | PEG DME 250 | 44 | 44.0% | | 22 | TRIS-HCl pH 8.5 | 100 | mM | | PEG 400 | 1% | | | |
| 324 | 7.22 | MPD | 20 | 20.0% | | 10 | Hepes pH 7.5 | 100 | mM | | | | | | |
| 325 | 7.29 | PEG 10K | 29.7 | 29.7% | | 29.7 | Na—K-Phosphate pH 8.5 | 100 | mM | | | | | | |
| 326 | 10.56 | Jeffamine M-600 | 46.8 | 46.8% | | 23.4 | CAPSO pH 9.5 | 50 | mM | | Phenol | 0.033 | M | | |
| 327 | 8.1 | Sec-Butanol | 10 | 10.0% | | 5 | TRIS-HCl pH 8.5 | 100 | mM | | Guanidine HCl | 0.02 | M | LDAO | 0.42% |
| 328 | 4.8 | PEG 10K | 18.7 | 18.7% | | 18.7 | Na-Cacodylate pH 5.5 | 100 | mM | | ATP disodium salt | 0.019 | M | | |
| 329 | 5.42 | PEG 600 | 57.4 | 39.0% | | 39 | Na-Acetate pH 4.5 | 50 | mM | | Glycyl-Glycyl-Glycine | 0.001 | M | | |
| 330 | 9.72 | Jeffamine M-600 | 6 | 6.0% | | 3 | Na—K-Phosphate pH 5.5 | 100 | mM | | Xylitol | 4% | | | |
| 331 | 7.66 | PEG 400 | 22.8 | 22.8% | | 11.4 | Na—K-Phosphate pH 7.5 | 100 | mM | | Ethylene Glycol | 1% | | | |
| 332 | 6.17 | PEG 8K | 10.5 | 10.5% | | 10.5 | Na-Succinate pH 6.5 | 100 | mM | | Dextran Sulfate | 2.4% | | | |
| 333 | 8.68 | 2 Ethoxyethanol | 56.4 | 56.4% | | 28.2 | CAPSO pH 8.5 | 50 | mM | | D (+) Glucose | 1% | | | |
| 334 | 6.08 | Ethylene Glycol | 57.8 | 57.8% | | 28.9 | Hepes pH 6.5 | 100 | mM | | 2,2,2-Trifluoroethanol | 1% | | | |
| 335 | 3.94 | Glycerol | 57.2 | 57.2% | | 28.6 | Na-Cacodylate pH 5.5 | 100 | mM | | Dextran Sulfate | 2.28% | | | |
| 336 | 5.94 | PEG MME 550 | 38.6 | 38.6% | | 38.6 | Na-Succinate pH 5.5 | 100 | mM | | 1,4 Butanediol | 3.4% | | | |
| 337 | 3.7 | PEG 4K | 31 | 31.0% | | 31 | Na-Cacodylate pH 4.5 | 100 | mM | | Strontium Chloride | 0.028 | M | | |
| 338 | 5.41 | PEG MME 5K | 12.4 | 12.4% | | 12.4 | Na-Acetate pH 5.5 | 50 | mM | | 1,4 Butanediol | 3.7% | | | |
| 339 | 4.69 | PEG 8K | 34.2 | 34.2% | | 34.2 | | 0 | mM | | 1,4-Dithio-DL-Threitol | 0.088 | M | | |
| 340 | 5.66 | MPD | 54.6 | 54.6% | | 27.3 | Hepes pH 6.5 | 100 | mM | | Strontium Chloride | 0.047 | M | | |
| 341 | 6.26 | Sec-Butanol | 10 | 10.0% | | 5 | Mopso pH 6.5 | 100 | mM | | Strontium Chloride | 0.096 | M | | |
| 342 | 5.62 | PEG MME 2K | 24 | 24.0% | | 24 | Na-Succinate pH 5.5 | 100 | mM | | | | | | |
| 343 | 4.64 | PEG MME 5K | 24.8 | 24.8% | | 24.8 | Na-Succinate pH 4.5 | 100 | mM | | Urea | 0.006 | M | | |
| 344 | 7.25 | | | | | | TRIS-HCl pH 7.5 | 100 | mM | | Phenol | 0.078 | M | | |
| 345 | 6.15 | PEG DME 250 | 26.2 | 26.2% | | 13.1 | TRIS-Maleate pH 5.5 | 50 | mM | | 1,4-Dithio-DL-Threitol | 0.006 | M | Triton X-100 | 0.62% |
| 346 | 7.7 | Ethanol | 53.8 | 53.8% | | 26.9 | CAPSO pH 9.5 | 50 | mM | | Ethyl Acetate | 1.38% | | | |
| 347 | 7.06 | Sec-Butanol | 10 | 10.0% | | 5 | TRIS-Maleate pH 6.5 | 50 | mM | | Ethylene Glycol | 1.2% | | | |
| 348 | 5.6 | PEG DME 2K | 5 | 5.0% | | 5 | Na-Citrate pH 5.5 | 50 | mM | | Taurine | 0.077 | M | | |
| 349 | 5.25 | Ethylene Glycol | 36 | 36.0% | | 17.9 | Na-Cacodylate pH 5.5 | 100 | mM | | Glycerol Anhydrous | 2.2% | | C12E9 | 0.2% |
| 350 | 4.75 | PEG 6K | 18.4 | 18.4% | | 18.4 | Na-Citrate pH 4.5 | 50 | mM | | 1,4-Dithio-DL-Threitol | 0.056 | M | | |
| 351 | 5.56 | Sec-Butanol | 10 | 10.0% | | 5 | Na-Citrate pH 5.5 | 50 | mM | | Guanidine HCl | 0.06 | M | | |
| 352 | 5.07 | 2 Ethoxyethanol | 40.2 | 40.2% | | 20.1 | Na-Succinate pH 4.5 | 100 | mM | | sec-butanol | 2.5% | | | |
| 353 | 5.68 | PEG DME 250 | 10.6 | 10.6% | | 5.3 | TRIS-Maleate pH 5.5 | 50 | mM | | Benzamidine HCl | 3.16% | | | |
| 354 | 5.38 | Sec-Butanol | 10 | 10.0% | | 5 | Na-Acetate pH 5.5 | 50 | mM | | Glycyl-Glycyl-Glycine | 0.028 | M | | |
| 355 | 9.48 | Polyethyleneimine | 1.4 | 1.4% | | 1.4 | Hepes pH 8.5 | 100 | mM | | Ethylene Glycol | 2.6% | | | |
| 356 | 7 | PEG 600 | 49 | 19.0% | | 19 | Mopso pH 6.5 | 100 | mM | | Xylitol | 4% | | LDAO | 0.17% |
| 357 | 6.71 | PEG 10K | 20 | 20.0% | | 20 | Mopso pH 7.5 | 100 | mM | | Yttrium Chloride | 0.031 | M | | |
| 358 | 8.83 | PEG MME 5K | 18.3 | 18.3% | | 18.3 | CAPSO pH 8.5 | 50 | mM | | Ethyl Acetate | 1% | | | |
| 359 | 6.58 | Isobutanol | 4 | 4.0% | | 2 | Bis-Tris Propane pH 8.5 | 100 | mM | | Ethyl Acetate | 1.53% | | | |
| 360 | 6.88 | PEG 10K | 32.7 | 32.7% | | 32.7 | Na-Citrate pH 6.5 | 50 | mM | | MPD | 1.5% | | | |
| 361 | 8.35 | MPD | 26.6 | 26.6% | | 13.3 | Bis-Tris Propane pH 8.5 | 100 | mM | | | | | | |
| 362 | 6.86 | PEG 1500 | 24.1 | 24.1% | | 24.1 | Na-Citrate pH 6.5 | 50 | mM | | Taurine | 0.006 | M | | |
| 363 | 4.4 | | | | | | Na-Succinate pH 4.5 | 100 | mM | | Dextran Sulfate | 2.52% | | | |
| 364 | 5.13 | PEG 4K | 38.7 | 38.7% | | 38.7 | Na-Cacodylate pH 5.5 | 100 | mM | | 2,2,2-Trifluoroethanol | 2.7% | | | |
| 365 | 4.89 | PEG 300 | 58.6 | 58.6% | | 29.3 | | 0 | mM | | | | | | |
| 366 | 2.95 | Glycerol | 45.2 | 45.2% | | 22.6 | | 0 | mM | | Ethyl Acetate | 2.15% | | | |
| 367 | 5.63 | | | | | | TRIS-Maleate pH 5.5 | 50 | mM | | Sodium Iodide | 0.024 | M | | |
| 368 | 7.13 | Ethanol | 10.6 | 10.6% | | 5.3 | TRIS-HCl pH 7.5 | 100 | mM | | 2,2,2-Trifluoroethanol | 1% | | C12E9 | 0.2% |
| 369 | 5.4 | Sec-Butanol | 11.2 | 11.2% | | 5.6 | Na-Acetate pH 5.5 | 50 | mM | | Phenol | 0.052 | M | | |
| 370 | 2.92 | PEG 400 | 21.8 | 21.8% | | 10.9 | | 0 | mM | | Ethyl Acetate | 2.86% | | | |
| 371 | 9.49 | Jeffamine M-600 | 20 | 20.0% | | 10 | Bis-Tris Propane pH 8.5 | 100 | mM | | Betaine Monohydrate | 0.02 | M | Triton X-100 | 0.4% |
| 372 | 7.7 | PEG 400 | 22 | 22.0% | | 11 | TRIS-HCl pH 8.5 | 100 | mM | | 1,4 Dioxane | 1.5% | | Glucopyranoside | 0.74% |
| 373 | 6.86 | Isobutanol | 2 | 2.0% | | 1 | Na-Citrate pH 6.5 | 50 | mM | | Trimethylamine HCl | 0.065 | M | | |
| 374 | 4.64 | PEG 300 | 9.4 | 9.4% | | 4.7 | Na-Citrate pH 4.5 | 50 | mM | | D (+) Glucose | 1.3% | | | |
| 375 | 4.6 | MPD | 26.4 | 26.4% | | 13.2 | Na-Malonate pH 4.0 | 100 | mM | | Taurine | 0.032 | M | | |
| 376 | 4.66 | PEG 4K | 16 | 16.0% | | 16 | TRIS-Maleate pH 4.5 | 50 | mM | | Phenol | 0.063 | M | | |
| 377 | 7.73 | Ethylene Glycol | 49.4 | 49.4% | | 24.7 | TRIS-HCl pH 8.5 | 100 | mM | | sec-butanol | 3% | | | |
| 378 | 7.19 | PEG DME 250 | 14.4 | 14.4% | | 7.2 | Bis-Tris Propane pH 7.5 | 100 | mM | | Glycine | 0.09 | M | | |
| 379 | 7.09 | Glycerol | 12.8 | 12.8% | | 6.4 | Na—K-Phosphate pH 6.5 | 100 | mM | | ATP disodium salt | 0.01 | M | | |
| 380 | 6.72 | 2 Ethoxyethanol | 19.4 | 19.4% | | 9.7 | Mopso pH 6.5 | 100 | mM | | Taurine | 0.007 | M | | |
| 381 | 9.26 | PEG DME 250 | 32.4 | 32.4% | | 16.2 | CAPSO pH 9.5 | 50 | mM | | Xylitol | 1% | | | |
| 382 | 6.98 | PEG MME 2K | 34.4 | 34.4% | | 34.4 | TRIS-HCl pH 7.5 | 100 | mM | | Urea | 0.037 | M | Triton X-100 | 0.7% |
| 383 | 6.72 | PEG 4K | 23.2 | 23.2% | | 23.2 | Mopso pH 7.5 | 100 | mM | | Guanidine HCl | 0.046 | M | | |
| 384 | 6.19 | PEG 200 | 46 | 46.0% | | 23 | Mopso pH 6.5 | 100 | mM | | Benzamidine HCl | 1.48% | | | |
| 385 | 6.33 | | | | | | TRIS-HCl pH 6.5 | 100 | mM | | ATP disodium salt | 0.019 | M | | |
| 386 | 8.2 | Sec-Butanol | 12 | 12.0% | | 6 | Hepes pH 8.5 | 100 | mM | | D (+) Glucose | 4.7% | | | |
| 387 | 8.7 | PEG MME 2K | 6.2 | 6.2% | | 6.2 | CAPSO pH 8.5 | 50 | mM | | Glycerol Anhydrous | 2.6% | | | |
| 388 | 4.72 | Methanol | 54.4 | 54.4% | | 27.2 | Na-Cacodylate pH 4.5 | 100 | mM | | D (+) Glucose | 2.9% | | | |
| 389 | 4.57 | PEG MME 2K | 16.4 | 16.4% | | 16.4 | Na-Acetate pH 4.5 | 50 | mM | | | | | | |
| 390 | 7.36 | PEG 600 | 12.4 | 12.4% | | 12.4 | Bis-Tris Propane pH 7.5 | 100 | mM | | Glycerol Anhydrous | 4.4% | | Cymal-3 | 0.52% |
| 391 | 6.98 | PEG 200 | 19 | 19.0% | | 9.5 | TRIS-HCl pH 7.5 | 100 | mM | | | | | Cymal-3 | 0.4% |
| 392 | 4.99 | Ethylene Glycol | 23 | 23.0% | | 11.5 | Na-Cacodylate pH 5.5 | 100 | mM | | Benzamidine HCl | 2.16% | | | |
| 393 | 9 | Jeffamine M-600 | 20 | 20.0% | | 10 | Bis-Tris Propane pH 9.5 | 100 | mM | | 1,4 Butanediol | 1% | | Glycerol | 4.8% |
| 394 | 6.12 | Isobutanol | 4 | 0.4% | | 2 | Hepes pH 6.5 | 100 | mM | | Ethyl Acetate | 1.12% | | | |
| 395 | 2.48 | PEG DME 2K | 5 | 5.0% | | 5 | Bis-Tris Propane pH 9.5 | 100 | mM | | Ethyl Acetate | 2.6% | | | |
| 396 | 5.1 | PEG MME 550 | 19.6 | 19.6% | | 9.8 | Na-Acetate pH 5.5 | 50 | mM | | ATP disodium salt | 0.006 | M | Glucopyranoside | 0.88% |
| 397 | 5.48 | PEG MME 2K | 25 | 25.0% | | 25 | Na-Acetate pH 5.5 | 50 | mM | | Glycine | 0.288 | M | | |
| 398 | 6.2 | | | | | | TRIS-HCl pH 6.5 | 100 | mM | | Yttrium Chloride | 0.005 | M | | |
| 399 | 7.23 | Isopropanol | 24 | 24.0% | | 12 | TRIS-Maleate pH 6.5 | 50 | mM | | Taurine | 0.006 | M | | |
| 400 | 4.4 | PEG 6K | 9.2 | 9.2% | | 9.2 | Na-Succinate pH 4.5 | 100 | mM | | PEG 400 | 1% | | | |
| 401 | 7.04 | MPD | 8.6 | 8.6% | | 4.3 | Na-Citrate pH 6.5 | 50 | mM | | | | | | |
| 402 | 9.02 | PEG DME 2K | 5 | 5.0% | | 5 | CAPSO pH 8.5 | 50 | mM | | Xylitol | 3% | | Cymal-3 | 0.92% |
| 403 | 5.96 | Ethanol | 6.6 | 6.6% | | 3.3 | | 0 | mM | | Manganese Chloride | 0.034 | M | | |
| 404 | 8.04 | Ethylene Glycol | 5.4 | 5.4% | | 2.7 | Na—K-Phosphate pH 7.5 | 100 | mM | | D (+) Glucose | 1% | | | |
| 405 | 3.9 | PEG DME 2K | 5 | 5.0% | | 5 | Na-Cacodylate pH 4.5 | 100 | mM | | D (+) Glucose | 9.5% | | | |
| 406 | 3.24 | PEG DME 2K | 7 | 7.0% | | 7 | | 0 | mM | | Strontium Chloride | 0.06 | M | | |
| 407 | 6.06 | PEG 4K | 28.4 | 28.4% | | 28.4 | Mopso pH 6.5 | 100 | mM | | 1,4 Butanediol | 3.3% | | | |
| 408 | 7.22 | PEG 8K | 20.3 | 20.3% | | 20.3 | Na—K-Phosphate pH 7.5 | 100 | mM | | | | | | |
| 409 | 4.73 | PEG 10K | 20 | 20.0% | | 20 | TRIS-Maleate pH 4.5 | 50 | mM | | MPD | 1% | | Glycerol | 9.2% |
| 410 | 5.79 | PEG 4K | 25.3 | 25.3% | | 25.3 | Bis-Tris Propane pH 7.5 | 100 | mM | | MPD | 3.3% | | | |
| 411 | 3.66 | PEG 300 | 17.8 | 17.8% | | 8.9 | TRIS-HCl pH 6.5 | 100 | mM | | 1,4 Dioxane | 1% | | | |
| 412 | 6.38 | Polyethyleneimine | 1.5 | 1.5% | | 1.5 | Na-Acetate pH 4.5 | 50 | mM | | 1,4 Dioxane | 3.4% | | | |
| 413 | 5.16 | MPD | 40 | 40.0% | | 40 | TRIS-Maleate pH 4.5 | 50 | mM | | 1,4-Dithio-DL-Threitol | 0.006 | M | | |
| 414 | 7.29 | PEG MME 5K | 12.9 | 12.9% | | 12.9 | Na-Succinate pH 7.5 | 100 | mM | | | | | | |
| 415 | 8.83 | 2 Ethoxyethanol | 14 | 14.0% | | 7 | CAPSO pH 8.5 | 50 | mM | | 2,2,2-Trifluoroethanol | 1.9% | | | |
| 416 | 7.66 | PEG 300 | 26.6 | 26.6% | | 13.3 | Na-Citrate pH 5.5 | 50 | mM | | 2,2,2-Trifluoroethanol | 4.5% | | Glucopyranoside | 0.82% |
| 417 | 5 | Methanol | 24.8 | 24.8% | | 12.4 | TRIS-Maleate pH 4.5 | 50 | mM | | Phenol | 0.086 | M | | |
| 418 | 2.87 | PEG 1500 | 10.6 | 10.6% | | 10.6 | Na-Cacodylate pH 4.5 | 100 | mM | | Yttrium Chloride | 0.076 | M | | |
| 419 | 4.58 | PEG 6K | 26.7 | 26.7% | | 26.7 | Na-Succinate pH 4.5 | 100 | mM | | Xylitol | 1% | | | |
| 420 | 11.02 | Jeffamine M-600 | 10 | 10.0% | | 5 | Na-Citrate pH 6.5 | 50 | mM | | 1,4-Dithio-DL-Threitol | 0.03 | M | | |
| 421 | 5.83 | PEG 300 | 42.6 | 42.6% | | 21.3 | Hepes pH 6.5 | 100 | mM | | ATP disodium salt | 0.019 | M | | |
| 422 | 6.92 | Glycerol | 31 | 31.0% | | 15.5 | TRIS-Maleate pH 6.5 | 50 | mM | | sec-butanol | 1.5% | | C12E9 | 0.2% |
| 423 | 9.75 | Jeffamine M-600 | 7 | 7.0% | | 3.5 | Na-Succinate pH 4.5 | 100 | mM | | 2,2,2-Trifluoroethanol | 1% | | Glucopyranoside | 0.2% |
| 424 | 7.78 | Polyethyleneimine | 2.1 | 2.1% | | 2.1 | Na-Succinate pH 4.5 | 100 | mM | | Strontium Chloride | 0.005 | M | | |
| 425 | 7.88 | PEG 6K | 13.7 | 13.7% | | 13.7 | Na-Malonate pH 4.0 | 100 | mM | | MPD | 1.3% | | | |
| 426 | 9.53 | Jeffamine M-600 | 6 | 6.0% | | 3 | Na-Succinate pH 4.5 | 100 | mM | | PEG 400 | 0.5% | | Glucopyranoside | 0.68% |
| 427 | 10.58 | Polyethyleneimine | 3.7 | 3.7% | | 3.7 | Na—K-Phosphate pH 7.5 | 100 | mM | | | | | | |
| 428 | 4.35 | Methanol | 12 | 12.0% | | 6 | Na-Malonate pH 4.0 | 100 | mM | | Trimethylamine HCl | 0.065 | M | | |
| 429 | 9.09 | Sec-Butanol | 8.8 | 8.8% | | 4.4 | CAPSO pH 8.5 | 50 | mM | | Xylitol | 3.1% | | Glucopyranoside | 0.38% |
| 430 | 6.89 | PEG 200 | 24.2 | 24.2% | | 12.1 | Na-Citrate pH 6.5 | 50 | mM | | Benzamidine HCl | 0.4% | | Maltoside | 0.32% |
| 431 | 6.1 | | | | | | Bis-Tris Propane pH 7.5 | 100 | mM | | ATP disodium salt | 0.019 | M | | |
| 432 | 4.56 | 2 Ethoxyethanol | 12 | 12.0% | | 6 | Na-Acetate pH 4.5 | 50 | mM | | MPD | 1.9% | | | |
| 433 | 6.03 | PEG MME 550 | 12 | 12.0% | | 6 | Bis-Tris Propane pH 7.5 | 100 | mM | | Manganese Chloride | 0.043 | M | | |
| 434 | 5.15 | PEG MME 2K | 19.7 | 19.7% | | 19.7 | | 0 | mM | | Taurine | 0.085 | M | | |
| 435 | 7.26 | MPD | 33.8 | 33.8% | | 16.9 | Na-Citrate pH 6.5 | 50 | mM | | D (+) Glucose | 1.9% | | | |
| 436 | 4.24 | PEG MME 2K | 10.7 | 10.7% | | 10.7 | TRIS-HCl pH 7.5 | 100 | mM | | Ethyl Acetate | 1.59% | | | |
| 437 | 4.1 | PEG 4K | 35 | 35.0% | | 35 | Na-Cacodylate pH 4.5 | 100 | mM | | 2,2,2-Trifluoroethanol | 2% | | Glycerol | 6.4% |
| 438 | 7.1 | PEG MME 2K | 12.3 | 12.3% | | 12.3 | Hepes pH 7.5 | 100 | mM | | Trimethylamine HCl | 0.025 | M | | |
| 439 | 4.43 | PEG 8K | 22.5 | 22.5% | | 22.5 | Na-Malonate pH 4.0 | 100 | mM | | Glycyl-Glycyl-Glycine | 0.001 | M | | |
| 440 | 4.49 | Sec-Butanol | 5.8 | 5.8% | | 2.9 | Na-Cacodylate pH 5.5 | 100 | mM | | Yttrium Chloride | 0.005 | M | | |
| 441 | 5.8 | PEG MME 2K | 28.3 | 28.3% | | 28.3 | Na-Citrate pH 5.5 | 50 | mM | | sec-butanol | 1.2% | | | |
| 442 | 6.12 | PEG DME 250 | 20 | 20.0% | | 10 | Mopso pH 6.5 | 100 | mM | | Xylitol | 4% | | | |
| 443 | 7.12 | PEG 8K | 25.9 | 25.9% | | 25.9 | Bis-Tris Propane pH 7.5 | 100 | mM | | 1,4-Dithio-DL-Threitol | 0.03 | M | | |
| 444 | 6.14 | PEG MME 5K | 10 | 10.0% | | 10 | Na-Cacodylate pH 6.5 | 100 | mM | | MPD | 1% | | | |
| 445 | 4.68 | Isopropanol | 59.4 | 59.4% | | 29.7 | Na-Cacodylate pH 4.5 | 100 | mM | | Benzamidine HCl | 0.4% | | Glucopyranoside | 0.4% |
| 446 | 3.75 | PEG DME 250 | 12 | 12.0% | | 6 | | 0 | mM | | Phenol | 0.048 | M | Glycerol | 2% |
| 447 | 8.93 | Ethanol | 32.6 | 32.6% | | 16.3 | CAPSO pH 8.5 | 50 | mM | | 1,4 Dioxane | 1% | | | |
| 448 | 10.34 | Jeffamine M-600 | 35 | 35.0% | | 17.5 | CAPSO pH 8.5 | 50 | mM | | sec-butanol | 2.6% | | | |
| 449 | 7.22 | 2 Ethoxyethanol | 26.8 | 26.8% | | 13.4 | Hepes pH 7.5 | 100 | mM | | | | | | |
| 450 | 4.59 | PEG 10K | 21.9 | 21.9% | | 21.9 | Na-Acetate pH 4.5 | 50 | mM | | 1,4 Butanediol | 4.3% | | | |
| 451 | 5.84 | PEG 1500 | 36.6 | 36.6% | | 36.6 | CAPSO pH 9.5 | 50 | mM | | Yttrium Chloride | 0.047 | M | | |
| 452 | 3.35 | PEG 1500 | 22 | 22.0% | | 22 | | 0 | mM | | sec-butanol | 3% | | | |
| 453 | 5.56 | Ethylene Glycol | 31.4 | 31.4% | | 15.7 | | 0 | mM | | sec-butanol | 4.1% | | | |
| 454 | 9.98 | Polyethyleneimine | 3.1 | 3.1% | | 3.1 | Hepes pH 8.5 | 100 | mM | | Guanidine HCl | 0.07 | M | | |
| 455 | 8.26 | Polyethyleneimine | 1 | 1.0% | | 1 | Bis-Tris Propane pH 7.5 | 100 | mM | | | | | | |
| 456 | 5.66 | PEG 10K | 16.5 | 16.5% | | 16.5 | Na-Cacodylate pH 6.5 | 100 | mM | | Benzamidine HCl | 4.16% | | | |
| 457 | 3.75 | PEG MME 2K | 32.1 | 32.1% | | 32.1 | Na-Cacodylate pH 5.5 | 100 | mM | | | | | | |
| 458 | 4.78 | PEG 600 | 34.6 | 34.6% | | 34.6 | Na-Acetate pH 4.5 | 50 | mM | | Taurine | 0.044 | M | | |
| 459 | 3.46 | PEG 600 | 36.2 | 36.2% | | 36.2 | | 0 | mM | | Taurine | 0.074 | M | | |
| 460 | 7.76 | PEG 400 | 15.6 | 15.6% | | 7.8 | TRIS-HCl pH 8.5 | 100 | mM | | sec-butanol | 4.7% | | | |
| 461 | 6.65 | PEG 200 | 29.4 | 29.4% | | 14.7 | Na—K-Phosphate pH 8.5 | 100 | mM | | Ethyl Acetate | 2.27% | | | |
| 462 | 7.82 | MPD | 37.4 | 37.4% | | 18.7 | Na-Citrate pH 6.5 | 50 | mM | | 1,4-Dithio-DL-Threitol | 0.03 | M | | |
| 463 | 10.82 | Jeffamine M-600 | 10 | 10.0% | | 5 | Na-Cacodylate pH 7.5 | 100 | mM | | | | | | |
| 464 | 4.73 | Isobutanol | 9.2 | 9.2% | | 4.6 | Na-Citrate pH 4.5 | 50 | mM | | Glycyl-Glycyl-Glycine | 0.005 | M | | |
| 465 | 8.82 | Polyethyleneimine | 2.2 | 2.2% | | 2.2 | Na—K-Phosphate pH 5.5 | 100 | mM | | Taurine | 0.092 | M | | |
| 466 | 7.42 | Isobutanol | 4 | 4.0% | | 2 | Hepes pH 7.5 | 100 | mM | | | | | | |
| 467 | 5.1 | PEG MME 5K | 18.6 | 18.6% | | 18.6 | | 0 | mM | | Urea | 0.01 | M | | |
| 468 | 7.06 | Polyethyleneimine | 1.5 | 1.5% | | 1.5 | Hepes pH 6.5 | 100 | mM | | Betaine Monohydrate | 0.097 | M | Glycerol | 5.6% |
| 469 | 9.72 | MPD | 12.6 | 12.6% | | 6.3 | CAPSO pH 9.5 | 50 | mM | | 1,4 Dioxane | 2.2% | | | |
| 470 | 3.98 | PEG 6K | 6.1 | 6.1% | | 6.1 | TRIS-HCl pH 6.5 | 100 | mM | | Strontium Chloride | 0.086 | M | | |
| 471 | 3.58 | | | | | | Na-Acetate pH 4.5 | 50 | mM | | Cupric Chloride | 0.066 | M | | |
| 472 | 5.87 | Methanol | 15.6 | 15.6% | | 7.8 | Bis-Tris Propane pH 7.5 | 100 | mM | | Strontium Chloride | 0.02 | M | | |
| 473 | 8.07 | PEG MME 5K | 14.5 | 14.5% | | 14.5 | Na—K-Phosphate pH 7.5 | 100 | mM | | Guanidine HCl | 0.02 | M | | |
| 474 | 6.71 | PEG 300 | 48.2 | 48.2% | | 24.1 | TRIS-HCl pH 7.5 | 100 | mM | | 1,4-Dithio-DL-Threitol | 0.017 | M | Cymal-3 | 0.62% |
| 475 | 8.33 | Ethylene Glycol | 46.4 | 46.4% | | 23.2 | Na—K-Phosphate pH 7.5 | 100 | mM | | 1,4 Dioxane | 3.1% | | Triton X-100 | 0.84% |
| 476 | 8.86 | Ethanol | 31.6 | 31.6% | | 15.8 | CAPSO pH 8.5 | 50 | mM | | 1,4 Butanediol | 4.5% | | | |
| 477 | 4.85 | PEG 4K | 10.2 | 10.2% | | 10.2 | TRIS-HCl pH 6.5 | 100 | mM | | | | | | |
| 478 | 6.86 | PEG DME 2K | 5 | 5.0% | | 5 | Hepes pH 7.5 | 100 | mM | | ATP disodium salt | 0.011 | M | | |
| 479 | 6.23 | MPD | 5.2 | 5.2% | | 2.6 | TRIS-HCl pH 6.5 | 100 | mM | | Phenol | 0.079 | M | | |
| 480 | 6.19 | | | | | | Mopso pH 6.5 | 100 | mM | | Strontium Chloride | 0.062 | M | | |
| 481 | 9.29 | Methanol | 26.2 | 26.2% | | 13.1 | Na—K-Phosphate pH 8.5 | 100 | mM | | sec-butanol | 2.9% | | | |
| 482 | 7.03 | Sec-Butanol | 5 | 5.0% | | 2.5 | Na-Citrate pH 6.5 | 50 | mM | | | | | | |
| 483 | 6.58 | Ethanol | 20.6 | 20.6% | | 10.3 | Na-Succinate pH 6.5 | 100 | mM | | Manganese Chloride | 0.026 | M | | |
| 484 | 7.17 | Dioxane | 2.5 | 2.5% | | 1.25 | Hepes pH 7.5 | 100 | mM | | D (+) Glucose | 4.3% | | | |
| 485 | 7.23 | PEG DME 250 | 6.6 | 6.6% | | 3.3 | Na—K-Phosphate pH 6.5 | 100 | mM | | Urea | 0.065 | M | | |
| 486 | 7.99 | Polyethyleneimine | 1.5 | 1.5% | | 1.5 | Bis-Tris Propane pH 6.5 | 100 | mM | | PEG 400 | 1.5% | | C12E9 | 0.2% |
| 487 | 10.37 | | | | | | Na-Succinate pH 5.5 | 100 | mM | | 2,2,2-Trifluoroethanol | 10% | | LDAO | 0.13% |
| 488 | 5.4 | Ethanol | 20 | 20.0% | | 10 | | 0 | mM | | PEG 200 | 2% | | | |
| 489 | 9.57 | Isopropanol | 23.8 | 23.8% | | 11.9 | CAPSO pH 9.5 | 50 | mM | | | | | | |
| 490 | 4.79 | Isopropanol | 8.2 | 8.2% | | 4.1 | Na-Malonate pH 5.0 | 100 | mM | | Dextran Sulfate | 2.4% | | | |
| 491 | 7.18 | PEG MME 2K | 11 | 11.0% | | 11 | Hepes pH 7.5 | 100 | mM | | Ethylene Glycol | 4.2% | | Triton X-100 | 0.54% |
| 492 | 5.37 | PEG 10K | 22.6 | 22.6% | | 22.6 | Na-Acetate pH 5.5 | 50 | mM | | 2,2,2-Trifluoroethanol | 1% | | | |
| 493 | 4.54 | Ethylene Glycol | 10.6 | 10.6% | | 5.3 | TRIS-Maleate pH 4.5 | 50 | mM | | 1,4 Butanediol | 3.2% | | | |
| 494 | 4.86 | PEG 300 | 42.6 | 42.6% | | 21.3 | TRIS-Maleate pH 4.5 | 50 | mM | | Strontium Chloride | 0.074 | M | | |
| 495 | 8.03 | Isopropanol | 32.8 | 32.8% | | 16.4 | Na—K-Phosphate pH 7.5 | 100 | mM | | | | | | |
| 496 | 8.36 | PEG 400 | 18.6 | 18.6% | | 9.3 | CAPSO pH 8.5 | 50 | mM | | MPD | 4.3% | | | |
| 497 | 6.09 | Methanol | 31 | 31.0% | | 15.5 | TRIS-HCl pH 6.5 | 100 | mM | | D (+) Glucose | 2.8% | | | |
| 498 | 6.92 | PEG 6K | 32 | 32.0% | | 32 | Na-Cacodylate pH 7.5 | 100 | mM | | Xylitol | 33% | | C12E9 | 0.2% |
| 499 | 3.33 | PEG 400 | 16.4 | 16.4% | | 8.2 | | 0 | mM | | 1,4 Dioxane | 5% | | Cymal-3 | 0.84% |
| 500 | 7.07 | PEG 600 | 9 | 9.0% | | 9 | Mopso pH 7.5 | 100 | mM | | | | | | |
| 501 | 8.12 | Potassium | 28.4 | 1.0 | M | 33.39468303 | Hepes pH 7.5 | 100 | mM | | Jeffamine M-600 | 1% | | | |
| | | Sodium Tartrate | | | | | | | | | | | | | |
| 502 | 6.43 | Ammonium | 2 | 0.1 | M | 1 | TRIS-Maleate pH 6.5 | 50 | mM | | | | | | |
| | | Phosphate | | | | | | | | | | | | | |
| 503 | 5.53 | Ammonium | 6 | 0.5 | M | 9.295774648 | Mopso pH 6.5 | 100 | mM | | | | | | |
| | | Citrate | | | | | | | | | | | | | |
| 504 | 7.72 | Magnesium | 1.21 | 1.3 | M | 26.62 | Mopso pH 7.5 | 100 | mM | | Ammonium Sulfate | 0.168 | M | | |
| | | Sulfate | | | | | | | | | | | | | |
| 505 | 7.96 | | | | | | TRIS-HCl pH 7.5 | 100 | mM | | Isopropanol | 4% | | | |
| 506 | 4.04 | Ammonium | 11.4 | 2.5 | M | 12.46242604 | Na-Acetate pH 4.5 | 50 | mM | | Zinc Acetate | 0.288 | M | Triton X-100 | 0.2% |
| | | Nitrate | | | | | | | | | | | | | |
| 507 | 2.67 | Ferric Chloride | 2 | 0.4 | M | 22.22222222 | Mopso pH 6.5 | 100 | mM | | | | | | |
| | | Hexahydrate | | | | | | | | | | | | | |
| 508 | 5.36 | Ammonium | 8.2 | 1.8 | M | 8.964201183 | Na-Succinate pH 5.5 | 100 | mM | | Ammonium Sulfate | 0.14 | M | | |
| | | Nitrate | | | | | | | | | | | | | |
| 509 | 5.35 | Ammonium | 15 | 3.3 | M | 16.39792899 | Na-Malonate pH 7.0 | 100 | mM | | | | | | |
| | | Nitrate | | | | | | | | | | | | | |
| 510 | 7.26 | Sodium Chloride | 0.38 | 0.4 | M | 3.9 | Hepes pH 7.5 | 100 | mM | | Calcium Chloride | 0.048 | M | | |
| 511 | 7.38 | Lithium Chloride | 8.33 | 8.3 | M | 41.65 | Bis-Tris Propane pH 8.5 | 100 | mM | | Sodium Thiocyanate | 0.12 | M | | |
| 512 | 3.6 | Magnesium | 0.976 | 1.7 | M | 42.5 | Na-Malonate pH 5.0 | 100 | mM | | Sodium Thiocyanate | 0.05 | M | | |
| | | Chloride | | | | | | | | | | | | | |
| 513 | 7.22 | Lithium Chloride | 1.9 | 1.9 | M | 9.5 | TRIS-HCl pH 7.5 | 100 | mM | | Sodium Thiocyanate | 0.16 | M | Triton X-100 | 0.82% |
| 514 | 6.56 | Sodium Acetate | 61.79 | 1.0 | M | 5 | Na-Cacodylate pH 4.5 | 100 | mM | | | | | | |
| 515 | 5.05 | Potassium | 53.6 | 2.8 | M | 35.44565842 | TRIS-Maleate pH 5.5 | 50 | mM | | Zinc Acetate | 0.104 | M | C12E9 | 0.2% |
| | | Chloride | | | | | | | | | | | | | |
| 516 | 7.37 | Potassium | 29.4 | 1.6 | M | 19.44220817 | Hepes pH 7.5 | 100 | mM | | Magnesium Chloride | 0.144 | M | | |
| | | Chloride | | | | | | | | | | | | | |
| 517 | 10.07 | Tri-Sodium Citrate | 0.791 | 0.7 | M | 20.59895833 | CAPSO pH 9.5 | 50 | mM | | Sodium Iodide | 0.208 | M | | |
| | | Dihydrate | | | | | | | | | | | | | |
| 518 | 3.9 | Zinc Sulfate | 50 | 1.8 | M | 45 | | 0 | mM | | | | | | |
| | | Hexahydrate | | | | | | | | | | | | | |
| 519 | 4.1 | Ammonium | 2 | 2.0 | M | 28.57142857 | Na-Malonate pH 5.0 | 100 | mM | | Calcium Chloride | 0.08 | M | | |
| | | Sulfate | | | | | | | | | | | | | |
| 520 | 5.9 | Lithium Sulfate | 53.8 | 1.8 | M | 43.75 | Na-Cacodylate pH 6.5 | 100 | mM | | Lithium Chloride | 0.242 | M | | |
| | | Monohydrate | | | | | | | | | | | | | |
| 521 | 6.33 | Sodium Sulfate | 0.084 | 0.1 | M | 6.5625 | Hepes pH 6.5 | 100 | mM | | | | | | |
| 522 | 5.72 | Sodium Chloride | 1.16 | 1.2 | M | 11.9 | | 0 | mM | | Cadmium Chloride | 0.025 | M | | |
| 523 | 7.18 | Potassium | 0.6 | 0.0 | M | 0.705521472 | TRIS-HCl pH 6.5 | 100 | mM | | | | | | |
| | | Sodium Tartrate | | | | | | | | | | | | | |
| 524 | 4.63 | Magnesium | 1.1 | 1.8 | M | 45 | Na-Succinate pH 5.5 | 100 | mM | | | | | | |
| | | Chloride | | | | | | | | | | | | | |
| 525 | 7.6 | Potassium | 22.8 | 1.2 | M | 15.07763082 | TRIS-HCl pH 7.5 | 100 | mM | | Sodium Iodide | 0.266 | M | | |
| | | Chloride | | | | | | | | | | | | | |
| 526 | 7.35 | Ammonium | 1.06 | 1.1 | M | 15.14285714 | Mopso pH 7.5 | 100 | mM | | | | | | |
| | | Sulfate | | | | | | | | | | | | | |
| 527 | 6.55 | | | | | | TRIS-HCl pH 6.5 | 100 | mM | | Calcium Chloride | 0.075 | M | | |
| 528 | 9.87 | Potassium | 30 | 1.6 | M | 19.83898792 | CAPSO pH 9.5 | 50 | mM | | | | | | |
| | | Chloride | | | | | | | | | | | | | |
| 529 | 4.25 | | | | | | Na-Citrate pH 4.5 | 50 | mM | | Sodium Thiocyanate | 0.276 | M | | |
| 530 | 8.42 | Sodium Acetate | 36.25 | 2.0 | M | 10 | | 0 | mM | | DMSO | 0.6% | | | |
| 531 | 5.95 | Sodium Formate | 7.98 | 2.3 | M | 16.62984892 | TRIS-Maleate pH 5.5 | 50 | mM | | | | | | |
| 532 | 6.92 | Lithium Sulfate | 20.6 | 0.8 | M | 18.7727825 | TRIS-HCl pH 6.5 | 100 | mM | | | | | | |
| | | Monohydrate | | | | | | | | | | | | | |
| 533 | 7.78 | Potassium | 12 | 0.4 | M | 14.11042945 | Bis-Tris Propane pH 6.5 | 100 | mM | | 1,6 Hexanediol | 1.32 | M | | |
| | | Sodium Tartrate | | | | | | | | | | | | | |
| 534 | 6.98 | Magnesium | 1.4 | 1.5 | M | 30.8 | Bis-Tris Propane pH 7.5 | 100 | mM | | Potassium Chloride | 0.05 | M | | |
| | | Sulfate | | | | | | | | | | | | | |
| 535 | 5.54 | Sodium | 0.34 | 0.3 | M | 29.6 | Na-Cacodylate pH 6.5 | 100 | mM | | Isopropanol | 4% | | | |
| | | Phosphate | | | | | | | | | | | | | |
| 536 | 1.55 | Ferric Chloride | 4 | 0.9 | M | 44.44444444 | Na-Citrate pH 4.5 | 50 | mM | | | | | | |
| | | Hexahydrate | | | | | | | | | | | | | |
| 537 | 5.75 | Ammonium | 14 | 0.4 | M | 7 | Na-Citrate pH 6.5 | 50 | mM | | | | | Cymal-3 | 0.2% |
| | | Phosphate | | | | | | | | | | | | | |
| 538 | 5.93 | Ammonium | 14 | 3.1 | M | 15.30473373 | Na-Cacodylate pH 6.5 | 100 | mM | | Magnesium Chloride | 0.186 | M | | |
| | | Nitrate | | | | | | | | | | | | | |
| 539 | 6.25 | Ammonium | 33.6 | 7.3 | M | 36.73136095 | Na-K-Phosphate pH 6.5 | 100 | mM | | Ethanol | 2% | | | |
| | | Nitrate | | | | | | | | | | | | | |
| 540 | 9 | Ammonium | 5.4 | 5.4% | | 2.7 | Bis-Tris Propane pH 8.5 | 100 | mM | | Jeffamine M-600 | 1% | | | |
| | | Bromide | | | | | | | | | | | | | |
| 541 | 5.08 | Magnesium | 0.31 | 0.3 | M | 6.82 | Na-Succinate pH 5.5 | 100 | mM | | | | | | |
| | | Sulfate | | | | | | | | | | | | | |
| 542 | 8.59 | Potassium | 54.8 | 2.9 | M | 36.23921794 | TRIS-HCl pH 8.5 | 100 | mM | | Sodium Iodide | 0.01 | M | | |
| | | Chloride | | | | | | | | | | | | | |
| 543 | 4.62 | Sodium | 0.305 | 0.3 | M | 26.3 | TRIS-HCl pH 6.5 | 100 | mM | | | | | | |
| | | Phosphate | | | | | | | | | | | | | |
| 544 | 7.75 | Potassium | 48.4 | 1.0 | M | 31.66666667 | | 0 | mM | | Sodium Iodide | 0.158 | M | | |
| | | Sodium Tartrate | | | | | | | | | | | | | |
| 545 | 6.94 | Sodium Acetate | 66.96 | 1.5 | M | 7.5 | Na-Cacodylate pH 4.5 | 100 | mM | | Ammonium Sulfate | 0.21 | M | Glycerol | 8.2% |
| 546 | 4.73 | Ammonium | 45.8 | 1.1 | M | 22.9 | Na-Malonate pH 7.0 | 100 | mM | | Sodium Chloride | 0.11 | M | | |
| | | Phosphate | | | | | | | | | | | | | |
| 547 | 7.13 | Ammonium | 4.28922 | 4.3 | M | 29.8 | Na-Cacodylate pH 4.5 | 100 | mM | | Ammonium Sulfate | 0.273 | M | | |
| | | Acetate | | | | | | | | | | | | | |
| 548 | 6.38 | | | | | | TRIS-HCl pH 6.5 | 100 | mM | | Barium Chloride | 0.066 | M | Glucopyranoside | 0.7% |
| 549 | 5.1 | Magnesium | 2.02 | 0.9 | M | 22.14912281 | Na-Cacodylate pH 6.5 | 100 | mM | | | | | | |
| | | Chloride | | | | | | | | | | | | | |
| 550 | 3.43 | Cadmium Sulfate | 20 | 0.2 | M | 10 | Na-Malonate pH 7.0 | 100 | mM | | | | | | |
| | | Monohydrate | | | | | | | | | | | | | |
| 551 | 5.59 | Ammonium | 2.29 | 2.3 | M | 32.71428571 | Na-Cacodylate pH 5.5 | 100 | mM | | Sodium Iodide | 0.214 | M | | |
| | | Sulfate | | | | | | | | | | | | | |
| 552 | 8.76 | Sodium Formate | 7.98 | 2.3 | M | 16.62984892 | CAPSO pH 8.5 | 50 | mM | | | | | | |
| 553 | 5.32 | PEG 4K | 10 | 10.0% | | 10 | TRIS-Maleate pH 4.5 | 50 | mM | | | | | | |
| 554 | 5.06 | Ammonium | 39.32 | 2.2 | M | 44 | Mopso pH 6.5 | 100 | mM | | | | | | |
| | | Citrate | | | | | | | | | | | | | |
| 555 | 6.24 | Tri-Sodium Citrate | 0.269 | 0.2 | M | 7.005208333 | Na-Cacodylate pH 5.5 | 100 | mM | | Sodium Thiocyanate | 0.288 | M | | |
| | | Dihydrate | | | | | | | | | | | | | |
| 556 | 5.13 | Lithium Sulfate | 56 | 1.7 | M | 42.5 | Na-Acetate pH 5.5 | 50 | mM | | 1,6 Hexanediol | 0.25 | M | | |
| | | Monohydrate | | | | | | | | | | | | | |
| 557 | 7.23 | Ammonium | 2.84934 | 2.8 | M | 19.8 | Hepes pH 7.5 | 100 | mM | | Cobaltus Chloride | 0.033 | M | | |
| | | Acetate | | | | | | | | | | | | | |
| 558 | 8.17 | Magnesium | 0.91 | 1.8 | M | 45 | Hepes pH 8.5 | 100 | mM | | | | | | |
| | | Chloride | | | | | | | | | | | | | |
| 559 | 5.96 | PEG 4K | 10 | 10.0% | | 10 | Na-Succinate pH 7.5 | 100 | mM | | | | | | |
| 560 | 6.85 | Sodium Formate | 46.4 | 5.0 | M | 35.71428571 | TRIS-Maleate pH 6.5 | 50 | mM | | | | | Glycerol | 2% |
| 561 | 7.53 | Sodium Formate | 25.26 | 6.0 | M | 42.85714286 | Na-Succinate pH 7.5 | 100 | mM | | Calcium Chloride | 0.005 | M | | |
| 562 | 7.47 | | | | | | Na-Malonate pH 7.0 | 100 | mM | | Cobaltus Chloride | 0.05 | M | | |
| 563 | 3.15 | Cadmium Sulfate | 26 | 0.3 | M | 13 | TRIS-Maleate pH 4.5 | 50 | mM | | Cadmium Chloride | 0.023 | M | | |
| | | Monohydrate | | | | | | | | | | | | | |
| 564 | 4.3 | | | | | | Na-Succinate pH 4.5 | 100 | mM | | Sodium Thiocyanate | 0.4 | M | | |
| 565 | 6.49 | Magnesium | 0.15 | 0.2 | M | 3.3 | Bis-Tris Propane pH 7.5 | 100 | mM | | Ethanol | 4.6% | | | |
| | | Sulfate | | | | | | | | | | | | | |
| 566 | 4.27 | Lithium Sulfate | 41.8 | 1.5 | M | 38.09234508 | Na-Acetate pH 4.5 | 50 | mM | | Ethanol | 4.8% | | | |
| | | Monohydrate | | | | | | | | | | | | | |
| 567 | 6.9 | Ammonium | 1.05 | 1.1 | M | 15 | Bis-Tris Propane pH 8.5 | 100 | mM | | Cobaltus Chloride | 0.05 | M | | |
| | | Sulfate | | | | | | | | | | | | | |
| 568 | 5.3 | Ammonium | 8.95 | 0.7 | M | 13.86619718 | Hepes pH 8.5 | 100 | mM | | Ammonium Sulfate | 0.182 | M | C12E9 | 0.2% |
| | | Citrate | | | | | | | | | | | | | |
| 569 | 6.84 | | | | | | TRIS-Maleate pH 6.5 | 50 | mM | | Potassium Chloride | 0.2 | M | | |
| 570 | 8.46 | Magnesium | 0.48 | 0.5 | M | 10.56 | Mopso pH 6.5 | 100 | mM | | 1,6 Hexanediol | 1.68 | M | | |
| | | Sulfate | | | | | | | | | | | | | |
| 571 | 5.99 | Magnesium | 0.96 | 1.0 | M | 25 | TRIS-Maleate pH 6.5 | 50 | mM | | Potassium Chloride | 0.02 | M | | |
| | | Chloride | | | | | | | | | | | | | |
| 572 | 4.97 | Ammonium | 15.91 | 1.2 | M | 24.64929577 | Na-Succinate pH 7.5 | 100 | mM | | | | | | |
| | | Citrate | | | | | | | | | | | | | |
| 573 | 6.22 | Ferric Chloride | 1 | 0.2 | M | 11.11111111 | Bis-Tris Propane pH 7.5 | 100 | mM | | 1,6 Hexanediol | 1.6 | M | | |
| | | Hexahydrate | | | | | | | | | | | | | |
| 574 | 7.12 | Potassium | 55.6 | 2.9 | M | 36.76825762 | Na-Cacodylate pH 7.5 | 100 | mM | | Cesium Chloride | 0.002 | M | C12E9 | 0.2% |
| | | Chloride | | | | | | | | | | | | | |
| 575 | 7.05 | Sodium Chloride | 2.98 | 3.0 | M | 30.5 | Na-K-Phosphate pH 8.5 | 100 | mM | | Ammonium Sulfate | 0.168 | M | | |
| 576 | 6.22 | Ammonium | 19.4 | 19.4% | | 9.7 | Na-Cacodylate pH 5.5 | 100 | mM | | | | | | |
| | | Bromide | | | | | | | | | | | | | |
| 577 | 6.29 | Lithium Sulfate | 18.8 | 0.7 | M | 17.13244228 | Na-Succinate pH 6.5 | 100 | mM | | | | | | |
| | | Monohydrate | | | | | | | | | | | | | |
| 578 | 6.35 | Ammonium | 1.05 | 1.1 | M | 15 | Na-Cacodylate pH 4.5 | 100 | mM | | Jeffamine M-600 | 2.8% | | Glucopyranoside | 0.84% |
| | | Sulfate | | | | | | | | | | | | | |
| 579 | 7.23 | Amonium | 9.8 | 2.1 | M | 10.71331361 | Na-K-Phosphate pH 8.5 | 100 | mM | | | | | | |
| | | Nitrate | | | | | | | | | | | | | |
| 580 | 3.74 | | | | | | Na-Malonate pH 5.0 | 100 | mM | | Cobaltus Chloride | 0.063 | M | | |
| 581 | 7.43 | Ammonium | 10 | 10.0% | | 5 | Na-K-Phosphate pH 7.5 | 100 | mM | | | | | | |
| | | Bromide | | | | | | | | | | | | | |
| 582 | 6.1 | Ammonium | 2 | 2.0 | M | 28.57142857 | Na-Succinate pH 6.5 | 100 | mM | | Zinc Acetate | 0.002 | M | | |
| | | Sulfate | | | | | | | | | | | | | |
| 583 | 2.95 | Nickel Chloride | 20 | 3.6% | | 45 | Na-Malonate pH 5.0 | 100 | mM | | | | | | |
| | | Hexahydrate | | | | | | | | | | | | | |
| 584 | 7.46 | Potassium | 34.2 | 1.2 | M | 40.21472393 | Na-Cacodylate pH 7.5 | 100 | mM | | Isopropanol | 2% | | | |
| | | Sodium Tartrate | | | | | | | | | | | | | |
| 585 | 3.02 | Magnesium | 2.12 | 0.9 | M | 23.24561404 | TRIS-Maleate pH 4.5 | 50 | mM | | Acetonitrile | 2.48% | | | |
| | | Chloride | | | | | | | | | | | | | |
| 586 | 4.02 | Magnesium | 0.86 | 1.2 | M | 30 | Na-Acetate pH 4.5 | 50 | mM | | Jeffamine M-600 | 1% | | | |
| | | Chloride | | | | | | | | | | | | | |
| 587 | 6.98 | Tri-Sodium Citrate | 0.238 | 0.2 | M | 6.197916667 | Mopso pH 7.5 | 100 | mM | | Cupric Chloride | 0.028 | M | Glucopyranoside | 0.8% |
| | | Dihydrate | | | | | | | | | | | | | |
| 588 | 4.78 | Nickel Chloride | 58 | 2.0% | | 25 | CAPSO pH 9.5 | 50 | mM | | DMSO | 1.02% | | Glycerol | 3.6% |
| | | Hexahydrate | | | | | | | | | | | | | |
| 589 | 7.52 | | | | | | Mopso pH 7.5 | 100 | mM | | Cobaltus Chloride | 0.041 | M | | |
| 590 | 5.09 | Ammonium | 34.77 | 1.8 | M | 36 | TRIS-Maleate pH 4.5 | 50 | mM | | Acetonitrile | 3.52% | | | |
| | | Citrate | | | | | | | | | | | | | |
| 591 | 6.79 | | | | | | Na-K-Phosphate pH 6.5 | 100 | mM | | Sodium Iodide | 0.4 | M | | |
| 592 | 7.3 | Lithium Chloride | 8.49 | 8.5 | M | 42.45 | Hepes pH 8.5 | 100 | mM | | Isopropanol | 2% | | | |
| 593 | 9.2 | Ammonium | 6.6 | 6.6% | | 3.3 | CAPSO pH 8.5 | 50 | mM | | Potassium Chloride | 0.046 | M | | |
| | | Bromide | | | | | | | | | | | | | |
| 594 | 6.82 | | | | | | Hepes pH 6.5 | 100 | mM | | Urea | 0.12 | M | | |
| 595 | 7.45 | Ammonium | 12 | 2.6 | M | 13.1183432 | CAPSO pH 8.5 | 50 | mM | | Potassium Chloride | 0.168 | M | | |
| | | Nitrate | | | | | | | | | | | | | |
| 596 | 5.54 | Calcium Acetate | 40.4 | 0.5 | M | 26.93333333 | Na-Acetate pH 4.5 | 50 | mM | | Potassium Chloride | 0.112 | M | | |
| | | Dihydrate | | | | | | | | | | | | | |
| 597 | 5.23 | Ammonium | 2 | 2.0 | M | 28.57142857 | TRIS-Maleate pH 5.5 | 50 | mM | | | | | | |
| | | Sulfate | | | | | | | | | | | | | |
| 598 | 8.04 | Ammonium | 1.9266 | 1.9 | M | 13.4 | TRIS-HCl pH 8.5 | 100 | mM | | Ammonium Sulfate | 0.28 | M | | |
| | | Acetate | | | | | | | | | | | | | |
| 599 | 8.09 | Potassium | 10.4 | 0.4 | M | 12.22903885 | Hepes pH 8.5 | 100 | mM | | | | | | |
| | | Sodium Tartrate | | | | | | | | | | | | | |
| 600 | 6.07 | | | | | | Hepes pH 6.5 | 100 | mM | | Cadmium Chloride | 0.02 | M | | |
| 601 | 4.77 | Sodium Chloride | 2.88 | 2.9 | M | 29.5 | Na-Succinate pH 5.5 | 100 | mM | | Cadmium Chloride | 0.023 | M | | |
| 602 | 9.12 | Sodium Sulfate | 0.44 | 0.7 | M | 34.375 | Bis-Tris Propane pH 7.5 | 100 | mM | | Jeffamine M-600 | 3.8% | | | |
| 603 | 6.33 | Ammonium | 37.4 | 8.2 | M | 40.88550296 | TRIS-HCl pH 6.5 | 100 | mM | | Barium Chloride | 0.002 | M | | |
| | | Nitrate | | | | | | | | | | | | | |
| 604 | 7.12 | Ammonium | 1.06 | 1.1 | M | 15.14285714 | Bis-Tris Propane pH 7.5 | 100 | mM | | | | | | |
| | | Sulfate | | | | | | | | | | | | | |
| 605 | 6.3 | Ammonium | 50 | 9.0 | M | 45 | Mopso pH 6.5 | 100 | mM | | | | | | |
| | | Nitrate | | | | | | | | | | | | | |
| 606 | 5.2 | Ammonium | 14.77 | 0.9 | M | 18 | TRIS-Maleate pH 5.5 | 50 | mM | | Ethanol | 2.8% | | | |
| | | Citrate | | | | | | | | | | | | | |
| 607 | 4.82 | Ammonium | 30 | 6.6 | M | 32.79585799 | Na-Citrate pH 6.5 | 50 | mM | | | | | Maltoside | 0.88% |
| | | Nitrate | | | | | | | | | | | | | |
| 608 | 5.29 | Ammonium | 10 | 10.0% | | 5 | TRIS-Maleate pH 4.5 | 50 | mM | | | | | | |
| | | Bromide | | | | | | | | | | | | | |
| 609 | 5.08 | Ammonium | 26.82 | 2.1 | M | 41.55211268 | Mopso pH 7.5 | 100 | mM | | | | | Glycerol | 3% |
| | | Citrate | | | | | | | | | | | | | |
| 610 | 5.16 | Ammonium | 27.05 | 1.5 | M | 30 | Hepes pH 8.5 | 100 | mM | | Cesium Chloride | 0.118 | M | | |
| | | Citrate | | | | | | | | | | | | | |
| 611 | 6.99 | Sodium Acetate | 40 | 1.3 | M | 6.25 | Na—K-Phosphate pH 6.5 | 100 | mM | | | | | | |
| 612 | 5.22 | | | | | | Na-Acetate pH 5.5 | 50 | mM | | Calcium Chloride | 0.021 | M | | |
| 613 | 8.09 | Tri-Sodium Citrate | 0.188 | 0.2 | M | 4.895833333 | Na—K-Phosphate pH 7.5 | 100 | mM | | | | | | |
| | | Dihydrate | | | | | | | | | | | | | |
| 614 | 7.89 | Sodium | 0.349 | 0.3 | M | 30.1 | TRIS-Maleate pH 6.5 | 50 | mM | | | | | | |
| | | Phosphate | | | | | | | | | | | | | |
| 615 | 4.29 | Sodium Sulfate | 0.192 | 0.3 | M | 15 | Na-Malonate pH 7.0 | 100 | mM | | Zinc Acetate | 0.204 | M | | |
| 616 | 7.21 | | | | | | Na—K-Phosphate pH 6.5 | 100 | mM | | | | | Triton X-100 | 0.52% |
| 617 | 7.62 | Potassium | 58.4 | 1.2 | M | 40 | Na-Succinate pH 7.5 | 100 | mM | | | | | | |
| | | Sodium Tartrate | | | | | | | | | | | | | |
| 618 | 7.96 | Ammonium | 2.93 | 3.1 | M | 44.28571429 | Na—K-Phosphate pH 7.5 | 100 | mM | | Potassium Chloride | 0.002 | M | | |
| | | Sulfate | | | | | | | | | | | | | |
| 619 | 6.68 | Calcium Chloride | 2.14 | 0.8 | M | 20.18867925 | Hepes pH 6.5 | 100 | mM | | | | | | |
| 620 | 6.25 | Sodium Formate | 32.82 | 5.5 | M | 39.28571429 | Na—K-Phosphate pH 5.5 | 100 | mM | | Sodium Thiocyanate | 0.14 | M | | |
| 621 | 8.83 | | | | | | Na—K-Phosphate pH 8.5 | 100 | mM | | Potassium Chloride | 0.144 | M | Triton X-100 | 0.2% |
| 622 | 5.22 | | | | | | Na-Cacodylate pH 5.5 | 100 | mM | | Phenol | 0.06 | M | | |
| 623 | 7.01 | | | | | | Na—K-Phosphate pH 6.5 | 100 | mM | | Cesium Chloride | 0.4 | M | | |
| 624 | 4.84 | Ammonium | 25 | 1.9 | M | 38.73239437 | Na—K-Phosphate pH 6.5 | 100 | mM | | | | | | |
| | | Citrate | | | | | | | | | | | | | |
| 625 | 7.35 | | | | | | Na-Succinate pH 7.5 | 100 | mM | | Barium Chloride | 0.009 | M | Glucopyranoside | 0.46% |
| 626 | 4.91 | Sodium Chloride | 2.18 | 2.2 | M | 22.3 | Na-Cacodylate pH 5.5 | 100 | mM | | Sodium Thiocyanate | 0.24 | M | | |
| 627 | 7.56 | Magnesium | 1.27 | 1.4 | M | 27.94 | Hepes pH 6.5 | 100 | mM | | Jeffamine M-600 | 2.7% | | | |
| | | Sulfate | | | | | | | | | | | | | |
| 628 | 7.83 | Sodium | 0.322 | 0.3 | M | 27.8 | TRIS-Maleate pH 6.5 | 50 | mM | | | | | | |
| | | Phosphate | | | | | | | | | | | | | |
| 629 | 6.77 | Magnesium | 3.16 | 1.4 | M | 34.64912281 | Bis-Tris Propane pH 6.5 | 100 | mM | | Cupric Chloride | 0.005 | M | | |
| | | Chloride | | | | | | | | | | | | | |
| 630 | 5.82 | Ammonium | 1.05 | 1.1 | M | 15 | Tris-Maleate pH 5.5 | 50 | mM | | | | | | |
| | | Sulfate | | | | | | | | | | | | | |
| 631 | 7.1 | Calcium Chloride | 2.03 | 0.8 | M | 19.1509434 | Hepes pH 7.5 | 100 | mM | | Sodium Chloride | 0.4 | M | | |
| 632 | 4.32 | Nickel Chloride | 21.6 | 0.5% | | 6.25 | TRIS-Maleate pH 6.5 | 50 | mM | | | | | Glucopyranoside | 0.8% |
| | | Hexahydrate | | | | | | | | | | | | | |
| 633 | 8.29 | Magnesium | 2.01 | 0.9 | M | 22.03947368 | Bis-Tris Propane pH 8.5 | 100 | mM | | | | | | |
| | | Chloride | | | | | | | | | | | | | |
| 634 | 6.24 | Calcium Acetate | 46.2 | 0.6 | M | 30.8 | TRIS-Maleate pH 6.5 | 50 | mM | | Sodium Iodide | 0.116 | M | | |
| | | Dihydrate | | | | | | | | | | | | | |
| 635 | 8.99 | Potassium | 1.47 | 0.4 | M | 12.76041667 | Bis-Tris Propane pH 7.5 | 100 | mM | | Potassium Chloride | 0.12 | M | Cymal-3 | 0.8% |
| | | Phosphate | | | | | | | | | | | | | |
| 636 | 6.67 | Potassium | 31.8 | 1.1 | M | 37.39263804 | Na-Citrate pH 6.5 | 50 | mM | | Cadmium Chloride | 0.002 | M | Glycerol | 1% |
| | | Sodium Tartrate | | | | | | | | | | | | | |
| 637 | 8.51 | Lithium Sulfate | 29 | 1.1 | M | 26.42770352 | Na-Malonate pH 5.0 | 100 | mM | | Acetonitrile | 2% | | | |
| | | Monohydrate | | | | | | | | | | | | | |
| 638 | 8.49 | Calcium Acetate | 20 | 0.3 | M | 13.33333333 | CAPSO pH 8.5 | 50 | mM | | | | | | |
| | | Dihydrate | | | | | | | | | | | | | |
| 639 | 9.02 | Potassium | 2.71 | 0.7 | M | 23.52430556 | Na-Acetate pH 5.5 | 50 | mM | | Sodium Fluoride | 0.3104 | M | | |
| | | Phosphate | | | | | | | | | | | | | |
| 640 | 5.81 | Lithium Chloride | 5.33 | 5.3 | M | 26.65 | TRIS-HCl pH 6.5 | 100 | mM | | 1,6 Hexanediol | 1.48 | M | Glucopyranoside | 0.2% |
| 641 | 6.77 | Potassium | 6.4 | 0.2 | M | 7.525562372 | TRIS-Maleate pH 6.5 | 50 | mM | | | | | | |
| | | Sodium Tartrate | | | | | | | | | | | | | |
| 642 | 8.19 | | | | | | TRIS-HCl pH 8.5 | 100 | mM | | Taurine | 0.06 | M | | |
| 643 | 9.14 | Potassium | 40.2 | 2.1 | M | 26.58424382 | CAPSO pH 8.5 | 50 | mM | | 1,6 Hexanediol | 1.36 | M | | |
| | | Chloride | | | | | | | | | | | | | |
| 644 | 7.47 | Sodium Acetate | 70 | 1.8 | M | 8.75 | Na-Citrate pH 4.5 | 50 | mM | | Cobaltus Chloride | 0.025 | M | Glycerol | 4.2% |
| 645 | 8.04 | Ammonium | 1.24 | 1.2 | M | 17.71428571 | Hepes pH 8.5 | 100 | mM | | DMSO | 2.4% | | | |
| | | Sulfate | | | | | | | | | | | | | |
| 646 | 6.43 | Ammonium | 18 | 3.9 | M | 19.67751479 | TRIS-HCl pH 6.5 | 100 | mM | | Calcium Chloride | 0.068 | M | | |
| | | Nitrate | | | | | | | | | | | | | |
| 647 | 7.63 | Ammonium | 0.763542 | 0.8 | M | 5.3 | CAPSO pH 9.5 | 50 | mM | | Cadmium Chloride | 0.019 | M | | |
| | | Acetate | | | | | | | | | | | | | |
| 648 | 6.2 | Calcium Acetate | 28.6 | 0.4 | M | 19.06666667 | Bis-Tris Propane pH 9.5 | 100 | mM | | Isopropanol | 2% | | | |
| | | Dihydrate | | | | | | | | | | | | | |
| 649 | 6.45 | Ammonium | 7.6 | 0.2 | M | 3.8 | Na-Malonate pH 7.0 | 100 | mM | | DMSO | 2.52% | | | |
| | | Phosphate | | | | | | | | | | | | | |
| 650 | 7.7 | Ammonium | 3.16368 | 3.2 | M | 22 | CAPSO pH 9.5 | 50 | mM | | Barium Chloride | 0.026 | M | LDAO | 0.28% |
| | | Acetate | | | | | | | | | | | | | |
| 651 | 8.49 | Lithium Sulfate | 36.2 | 1.3 | M | 32.9890644 | Hepes pH 8.5 | 100 | mM | | Sodium Iodide | 0.01 | M | | |
| | | Monohydrate | | | | | | | | | | | | | |
| 652 | 5.5 | Sodium Formate | 20.01 | 5.8 | M | 41.69965875 | Na-Citrate pH 4.5 | 50 | mM | | Cupric Chloride | 0.005 | M | | |
| 653 | 5.37 | | | | | | Na-Succinate pH 5.5 | 100 | mM | | Taurine | 0.06 | M | | |
| 654 | 7.22 | Sodium Acetate | 26.96 | 2.3 | M | 11.25 | Na-Citrate pH 6.5 | 50 | mM | | Isopropanol | 2% | | | |
| 655 | 6.19 | Ammonium | 1.05 | 1.1 | M | 15 | Na—K-Phosphate pH 5.5 | 100 | mM | | | | | | |
| | | Sulfate | | | | | | | | | | | | | |
| 656 | 6.91 | Ammonium | 1.00386 | 1.0 | M | 7 | Bis-Tris Propane pH 6.5 | 100 | mM | | Calcium Chloride | 0.02 | M | | |
| | | Acetate | | | | | | | | | | | | | |
| 657 | 4.72 | Magnesium | 1.4 | 1.5 | M | 30.8 | Na-Succinate pH 5.5 | 100 | mM | | | | | | |
| | | Sulfate | | | | | | | | | | | | | |
| 658 | 5.59 | Ammonium | 2.93 | 3.2 | M | 45.71428571 | | 0 | mM | | | | | | |
| | | Sulfate | | | | | | | | | | | | | |
| 659 | 7.33 | Magnesium | 1.73 | 0.8 | M | 18.96929825 | TRIS-Maleate pH 5.5 | 50 | mM | | Jeffamine M-600 | 3.6% | | | |
| | | Chloride | | | | | | | | | | | | | |
| 660 | 4.32 | Ammonium | 10.4 | 10.4% | | 5.2 | Na-Succinate pH 4.5 | 100 | mM | | Barium Chloride | 0.038 | M | | |
| | | Bromide | | | | | | | | | | | | | |
| 661 | 8.93 | Magnesium | 0.54 | 1.4 | M | 35 | CAPSO pH 8.5 | 50 | mM | | | | | | |
| | | Chloride | | | | | | | | | | | | | |
| 662 | 8.99 | | | | | | CAPSO pH 8.5 | 50 | mM | | Barium Chloride | 0.073 | M | | |
| 663 | 7.75 | Potassium | 39 | 1.3 | M | 41.66666667 | Na-Succinate pH 7.5 | 100 | mM | | | | | | |
| | | Sodium Tartrate | | | | | | | | | | | | | |
| 664 | 7.16 | Ammonium | 26 | 26.0% | | 13 | Bis-Tris Propane pH 6.5 | 100 | mM | | Isopropanol | 2% | | | |
| | | Bromide | | | | | | | | | | | | | |
| 665 | 5.28 | Ammonium | 25.2 | 0.6 | M | 12.6 | Na—K-Phosphate pH 7.5 | 100 | mM | | | | | | |
| | | Phosphate | | | | | | | | | | | | | |
| 666 | 8.74 | Ammonium | 2.5 | 2.5 | M | 35.71428571 | Na—K-Phosphate pH 8.5 | 100 | mM | | | | | | |
| | | Sulfate | | | | | | | | | | | | | |
| 667 | 1.7 | Ferric Chloride | 1.5 | 0.3 | M | 16.66666667 | TRIS-Maleate pH 6.5 | 50 | mM | | Sodium Chloride | 0.39 | M | | |
| | | Hexahydrate | | | | | | | | | | | | | |
| 668 | 7.13 | | | | | | Na—K-Phosphate pH 7.5 | 100 | mM | | Sodium Thiocyanate | 0.4 | M | | |
| 669 | 5.87 | Ammonium | 1 | 1.0 | M | 14.28571429 | Na-Malonate pH 7.0 | 100 | mM | | | | | | |
| | | Sulfate | | | | | | | | | | | | | |
| 670 | 8.74 | | | | | | Na—K-Phosphate pH 8.5 | 100 | mM | | Sodium Thiocyanate | 0.128 | M | | |
| 671 | 8.15 | Lithium Chloride | 5.33 | 5.3 | M | 26.65 | Hepes pH 8.5 | 100 | mM | | | | | | |
| 672 | 7.14 | | | | | | Na—K-Phosphate pH 6.5 | 100 | mM | | Potassium Chloride | 0.068 | M | | |
| 673 | 7.28 | Ammonium | 24.4 | 24.4% | | 12.2 | Mopso pH 7.5 | 100 | mM | | Cesium Chloride | 0.122 | M | | |
| | | Bromide | | | | | | | | | | | | | |
| 674 | 3.44 | Zinc Sulfate | 25 | 1.4 | M | 34.03465347 | Na-Malonate pH 5.0 | 100 | mM | | Sodium Thiocyanate | 0.212 | M | | |
| | | Hexahydrate | | | | | | | | | | | | | |
| 675 | 9.46 | Calcium Chloride | 0.75 | 0.3 | M | 7.075471698 | CAPSO pH 9.5 | 50 | mM | | Sodium Chloride | 0.33 | M | LDAO | 0.42% |
| 676 | 1.86 | Ferric Chloride | 4 | 0.9 | M | 44.44444444 | Na-Citrate pH 5.5 | 50 | mM | | Cupric Chloride | 0.002 | M | | |
| | | Hexahydrate | | | | | | | | | | | | | |
| 677 | 4.36 | Sodium Chloride | 1.85 | 1.9 | M | 19 | Na-Acetate pH 4.5 | 50 | mM | | | | | | |
| 678 | 6.12 | Calcium Chloride | 2.86 | 1.1 | M | 26.98113208 | TRIS-HCl pH 7.5 | 100 | mM | | Magnesium Chloride | 0.242 | M | | |
| 679 | 1.37 | Ferric Chloride | 3.5 | 0.8 | M | 38.88888889 | | 0 | mM | | Jeffamine M-600 | 4.5% | | Glycerol | 4% |
| | | Hexahydrate | | | | | | | | | | | | | |
| 680 | 7.23 | Ammonium | 5.21196 | 5.2 | M | 36.2 | | 0 | mM | | | | | | |
| | | Acetate | | | | | | | | | | | | | |
| 681 | 10.09 | Ammonium | 0.84 | 0.8 | M | 12 | CAPSO pH 9.5 | 50 | mM | | Sodium Fluoride | 0.1856 | M | | |
| | | Sulfate | | | | | | | | | | | | | |
| 682 | 6.69 | | | | | | Na-Citrate pH 6.5 | 50 | mM | | Calcium Chloride | 0.022 | M | C12E9 | 0.2% |
| 683 | 9.1 | Lithium Sulfate | 43.6 | 1.6 | M | 39.7326853 | CAPSO pH 8.5 | 50 | mM | | Isopropanol | 2% | | | |
| | | Monohydrate | | | | | | | | | | | | | |
| 684 | 4.66 | Zinc Sulfate | 31.8 | 1.7 | M | 43.29207921 | Na-Acetate pH 5.5 | 50 | mM | | Sodium Iodide | 0.01 | M | | |
| | | Hexahydrate | | | | | | | | | | | | | |
| 685 | 6.58 | | | | | | Bis-Tris Propane pH 8.5 | 100 | mM | | Zinc Acetate | 0.11 | M | | |
| 686 | 7.26 | Ammonium | 4.1067 | 4.1 | M | 28.5 | Bis-Tris Propane pH 6.5 | 100 | mM | | Barium Chloride | 0.06 | M | Glycerol | 4% |
| | | Acetate | | | | | | | | | | | | | |
| 687 | 8.63 | | | | | | Bis-Tris Propane pH 8.5 | 100 | mM | | Ethanol | 3.8% | | | |
| 688 | 6.21 | | | | | | | 0 | mM | | Cobaltus Chloride | 0.18 | M | | |
| 689 | 6.98 | Ammonium | 2.56542 | 2.6 | M | 17.8 | Bis-Tris Propane pH 9.5 | 100 | mM | | | | | | |
| | | Acetate | | | | | | | | | | | | | |
| 690 | 3.99 | Ammonium | 27.8 | 0.7 | M | 13.9 | CAPSO pH 8.5 | 50 | mM | | Magnesium Chloride | 0.222 | M | Cymal-3 | 0.2% |
| | | Phosphate | | | | | | | | | | | | | |
| 691 | 6.42 | | | | | | Bis-Tris Propane pH 6.5 | 100 | mM | | Sodium Iodide | 0.156 | M | | |
| 692 | 5.8 | Calcium Acetate | 26.2 | 0.3 | M | 17.46666667 | Na-Cacodylate pH 4.5 | 100 | mM | | Ethanol | 4.2% | | | |
| | | Dihydrate | | | | | | | | | | | | | |
| 693 | 4.8 | Magnesium | 1.56 | 1.7 | M | 34.32 | Na-Acetate pH 5.5 | 50 | mM | | Acetonitrile | 1.44% | | | |
| | | Sulfate | | | | | | | | | | | | | |
| 694 | 7.23 | | | | | | Na-Succinate pH 7.5 | 100 | mM | | Guanidine HCl | 0.2 | M | | |
| 695 | 4.3 | Sodium Sulfate | 0.131 | 0.2 | M | 10.234375 | Na-Cacodylate pH 4.5 | 100 | mM | | Cobaltus Chloride | 0.038 | M | | |
| 696 | 8.49 | | | | | | Bis-Tris Propane pH 8.5 | 100 | mM | | Sodium Iodide | 0.1 | M | | |
| 697 | 4.79 | Magnesium | 1.3 | 0.6 | M | 14.25438596 | Bis-Tris Propane pH 9.5 | 100 | mM | | Lithium Sulfate | 0.21 | M | | |
| | | Chloride | | | | | | | | | | | | | |
| 698 | 3.45 | Magnesium | 1.39 | 0.6 | M | 15.24122807 | Na-Acetate pH 4.5 | 50 | mM | | Cadmium Chloride | 0.022 | M | | |
| | | Chloride | | | | | | | | | | | | | |
| 699 | 3.7 | Cadmium Sulfate | 15.2 | 0.2 | M | 7.6 | Na-Cacodylate pH 4.5 | 100 | mM | | Potassium Chloride | 0.094 | M | | |
| | | Monohydrate | | | | | | | | | | | | | |
| 700 | 7.32 | Ammonium | 3.78222 | 3.8 | M | 26.3 | TRIS-Maleate pH 6.5 | 50 | mM | | | | | | |
| | | Acetate | | | | | | | | | | | | | |
| 701 | 7.82 | Potassium | 38.4 | 1.0 | M | 33.33333333 | Hepes pH 7.5 | 100 | mM | | Acetonitrile | 1.92% | | | |
| | | Sodium Tartrate | | | | | | | | | | | | | |
| 702 | 5.77 | | | | | | | 0 | mM | | Cadmium Chloride | 0.013 | M | Cymal-3 | 0.3% |
| 703 | 5.73 | Lithium Chloride | 8 | 8.0 | M | 40 | TRIS-HCl pH 7.5 | 100 | mM | | | | | | |
| 704 | 5.81 | Magnesium | 1.57 | 0.7 | M | 17.21491228 | Mopso pH 6.5 | 100 | mM | | | | | | |
| | | Chloride | | | | | | | | | | | | | |
| 705 | 4.43 | Sodium Sulfate | 0.407 | 0.6 | M | 31.796875 | Na-Acetate pH 4.5 | 50 | mM | | | | | Glycerol | 4.6% |
| 706 | 4.26 | Zinc Sulfate | 26.4 | 1.4 | M | 35.94059406 | | 0 | mM | | Cesium Chloride | 0.02 | M | | |
| | | Hexahydrate | | | | | | | | | | | | | |
| 707 | 8.61 | Potassium | 0.92 | 0.2 | M | 7.986111111 | TRIS-Maleate pH 6.5 | 50 | mM | | | | | | |
| | | Phosphate | | | | | | | | | | | | | |
| 708 | 8.86 | | | | | | CAPSO pH 8.5 | 50 | mM | | Magnesium Chloride | 0.298 | M | | |
| 709 | 8.64 | Potassium | 23 | 0.8 | M | 27.04498978 | CAPSO pH 8.5 | 50 | mM | | | | | | |
| | | Sodium Tartrate | | | | | | | | | | | | | |
| 710 | 6.69 | Potassium | 22 | 0.8 | M | 25.86912065 | TRIS-HCl pH 7.5 | 100 | mM | | | | | | |
| | | Sodium Tartrate | | | | | | | | | | | | | |
| 711 | 3.48 | Lithium Chloride | 2.52 | 2.5 | M | 12.6 | Na-Malonate pH 5.0 | 100 | mM | | DMSO | 1.68% | | | |
| 712 | 5.28 | Ammonium | 6 | 0.5 | M | 9.295774648 | Na-Citrate pH 5.5 | 50 | mM | | Acetonitrile | 3.28% | | | |
| | | Citrate | | | | | | | | | | | | | |
| 713 | 8.05 | | | | | | Na—K-Phosphate pH 7.5 | 100 | mM | | 1,6 Hexanediol | 0.96 | M | | |
| 714 | 5.56 | Sodium | 0.29 | 0.3 | M | 25 | CAPSO pH 9.5 | 50 | mM | | Ammonium Sulfate | 0.266 | M | | |
| | | Phosphate | | | | | | | | | | | | | |
| 715 | 2.96 | Calcium Chloride | 1.38 | 0.5 | M | 13.01886792 | TRIS-Maleate pH 4.5 | 50 | mM | | | | | | |
| 716 | 5.47 | Calcium Chloride | 1.43 | 0.5 | M | 13.49056604 | Mopso pH 6.5 | 100 | mM | | Magnesium Chloride | 0.206 | M | Maltoside | 0.8% |
| 717 | 6.12 | Nickel Chloride | 13.8 | 0.0% | | 0.25 | Na-Cacodylate pH 7.5 | 100 | mM | | Lithium Chloride | 0.426 | M | | |
| | | Hexahydrate | | | | | | | | | | | | | |
| 718 | 4.37 | Potassium | 56.4 | 3.0 | M | 37.2972973 | Na-Acetate pH 4.5 | 50 | mM | | | | | | |
| | | Chloride | | | | | | | | | | | | | |
| 719 | 3.95 | Lithium Chloride | 1.13 | 1.1 | M | 5.65 | Na-Cacodylate pH 4.5 | 100 | mM | | | | | | |
| 720 | 7.73 | Sodium Sulfate | 0.37 | 0.6 | M | 28.90625 | Bis-Tris Propane pH 6.5 | 100 | mM | | | | | | |
| 721 | 6.13 | Ammonium | 1.65 | 1.7 | M | 23.57142857 | | 0 | mM | | Sodium Iodide | 0.228 | M | | |
| | | Sulfate | | | | | | | | | | | | | |
| 722 | 4.1 | Magnesium | 1.15 | 1.3 | M | 25.3 | Na-Succinate pH 4.5 | 100 | mM | | Sodium Thiocyanate | 0.192 | M | | |
| | | Sulfate | | | | | | | | | | | | | |
| 723 | 6.1 | Ammonium | 1.78 | 1.8 | M | 25.42857143 | Na-Citrate pH 6.5 | 50 | mM | | | | | | |
| | | Sulfate | | | | | | | | | | | | | |
| 724 | 6.72 | Sodium Chloride | 1.86 | 1.9 | M | 19.1 | Bis-Tris Propane pH 6.5 | 100 | mM | | DMSO | 1.32% | | | |
| 725 | 5.18 | Ammonium | 51.6 | 6.2 | M | 31 | | 0 | mM | | Ethanol | 4.6% | | | |
| | | Nitrate | | | | | | | | | | | | | |
| 726 | 1.54 | Ferric Chloride | 3.1 | 0.7 | M | 34.44444444 | TRIS-Maleate pH 5.5 | 50 | mM | | | | | | |
| | | Hexahydrate | | | | | | | | | | | | | |
| 727 | 9.83 | Sodium Chloride | 1.57 | 1.6 | M | 16.1 | Hepes pH 8.5 | 100 | mM | | Jeffamine M-600 | 2.5% | | | |
| 728 | 3.07 | Cadmium Sulfate | 36.8 | 0.4 | M | 18.4 | TRIS-Maleate pH 4.5 | 50 | mM | | Ammonium Sulfate | 0.168 | M | | |
| | | Monohydrate | | | | | | | | | | | | | |
| 729 | 6.79 | Ammonium | 0.9633 | 1.0 | M | 6.7 | Na-Succinate pH 6.5 | 100 | mM | | | | | | |
| | | Acetate | | | | | | | | | | | | | |
| 730 | 7.97 | Ammonium | 19.6 | 4.3 | M | 21.42662722 | TRIS-HCl pH 8.5 | 100 | mM | | Sodium Fluoride | 0.2224 | M | | |
| | | Nitrate | | | | | | | | | | | | | |
| 731 | 5.39 | Ammonium | 20 | 4.4 | M | 21.86390533 | TRIS-Maleate pH 5.5 | 50 | mM | | | | | | |
| | | Nitrate | | | | | | | | | | | | | |
| 732 | 4.79 | Ammonium | 32.05 | 2.1 | M | 42 | Na-Cacodylate pH 5.5 | 100 | mM | | | | | | |
| | | Citrate | | | | | | | | | | | | | |
| 733 | 7.46 | Ammonium | 2.6 | 2.6 | M | 37.14285714 | Na-Succinate pH 7.5 | 100 | mM | | | | | | |
| | | Sulfate | | | | | | | | | | | | | |
| 734 | 8.05 | | | | | | Na—K-Phosphate pH 7.5 | 100 | mM | | 1,6 Hexanediol | 1.44 | M | Glycerol | 4.2% |
| 735 | 5.48 | Nickel Chloride | 20 | 1.0% | | 12.5 | TRIS-HCl pH 8.5 | 100 | mM | | Barium Chloride | 0.005 | M | | |
| | | Hexahydrate | | | | | | | | | | | | | |
| 736 | 2.07 | Nickel Chloride | 46 | 1.5% | | 18.75 | Na-Citrate pH 5.5 | 50 | mM | | Barium Chloride | 0.08 | M | Glucopyranoside | 0.88% |
| | | Hexahydrate | | | | | | | | | | | | | |
| 737 | 10.78 | Potassium | 15 | 0.5 | M | 17.63803681 | | 0 | mM | | Jeffamine M-600 | 1% | | | |
| | | Sodium Tartrate | | | | | | | | | | | | | |
| 738 | 6.99 | Lithium Sulfate | 44.8 | 1.6 | M | 40.82624544 | Na-Succinate pH 7.5 | 100 | mM | | | | | | |
| | | Monohydrate | | | | | | | | | | | | | |
| 739 | 4.83 | Ammonium | 5.4 | 0.1 | M | 2.7 | TRIS-HCl pH 6.5 | 100 | mM | | | | | | |
| | | Phosphate | | | | | | | | | | | | | |
| 740 | 8.32 | Tri-Sodium Citrate | 0.86 | 0.7 | M | 22.39583333 | TRIS-HCl pH 7.5 | 100 | mM | | Sodium Iodide | 0.132 | M | | |
| | | Dihydrate | | | | | | | | | | | | | |
| 741 | 7.84 | Sodium Acetate | 11.43 | 2.5 | M | 12.5 | | 0 | mM | | | | | | |
| 742 | 9.1 | Tri-Sodium Citrate | 0.995 | 0.8 | M | 25.91145833 | Mopso pH 6.5 | 100 | mM | | Isopropanol | 4.6% | | | |
| | | Dihydrate | | | | | | | | | | | | | |
| 743 | 7.35 | Sodium Formate | 43.53 | 3.4 | M | 23.92857143 | Bis-Tris Propane pH 6.5 | 100 | mM | | | | | | |
| 744 | 7.53 | Sodium Acetate | 56.61 | 2.8 | M | 13.75 | TRIS-HCl pH 6.5 | 100 | mM | | | | | | |
| 745 | 7.22 | | | | | | Na-Succinate pH 7.5 | 100 | mM | | Glycine | 0.2 | M | | |
| 746 | 6.56 | | | | | | Mopso pH 6.5 | 100 | mM | | Betaine Monohydrate | 0.12 | M | | |
| 747 | 7.29 | Potassium | 59.6 | 3.2 | M | 39.41345601 | Na-Succinate pH 7.5 | 100 | mM | | | | | | |
| | | Chloride | | | | | | | | | | | | | |
| 748 | 7.05 | Ammonium | 4.43118 | 4.4 | M | 30.8 | TRIS-Maleate pH 5.5 | 50 | mM | | | | | | |
| | | Acetate | | | | | | | | | | | | | |
| 749 | 5.99 | Nickel Chloride | 20 | 3.5% | | 43.75 | Na-Succinate pH 7.5 | 100 | mM | | | | | | |
| | | Hexahydrate | | | | | | | | | | | | | |
| 750 | 7.95 | Sodium Chloride | 0.86 | 0.9 | M | 8.8 | Bis-Tris Propane pH 7.5 | 100 | mM | | Calcium Chloride | 0.07 | M | | |
| 751 | 4.39 | Sodium Sulfate | 0.115 | 0.2 | M | 8.984375 | TRIS-Maleate pH 5.5 | 50 | mM | | Yttrium Chloride | 0.08 | M | | |
| 752 | 4.9 | Lithium Chloride | 0.77 | 0.8 | M | 3.85 | Na-Cacodylate pH 5.5 | 100 | mM | | 1,4 Butanediol | 3.1% | | | |
| 753 | 6.45 | | | | | | Na-Succinate pH 6.5 | 100 | mM | | Glycyl-Glycyl-Glycine | 0.018 | M | Triton X-100 | 0.78% |
| 754 | 5.17 | Ammonium | 52.6 | 9.0 | M | 45 | | 0 | mM | | | | | | |
| | | Nitrate | | | | | | | | | | | | | |
| 755 | 8.18 | | | | | | Hepes pH 8.5 | 100 | mM | | Dextran Sulfate | 1.8% | | | |
| 756 | 7.1 | Potassium | 50 | 2.6 | M | 33.06497987 | Na-Citrate pH 6.5 | 50 | mM | | PEG 400 | 1.8% | | | |
| | | Chloride | | | | | | | | | | | | | |
| 757 | 7.07 | Ammonium | 2.92032 | 2.9 | M | 20.3 | Na—K-Phosphate pH 6.5 | 100 | mM | | Xylitol | 3.2% | | | |
| | | Acetate | | | | | | | | | | | | | |
| 758 | 5.19 | | | | | | Na-Cacodylate pH 5.5 | 100 | mM | | Xylitol | 3.7% | | Triton X-100 | 0.24% |
| 759 | 5.28 | Ammonium | 20 | 20.0% | | 10 | Na-Citrate pH 5.5 | 50 | mM | | | | | | |
| | | Bromide | | | | | | | | | | | | | |
| 760 | 6.92 | Ammonium | 32.6 | 7.1 | M | 35.63816568 | Na—K-Phosphate pH 8.5 | 100 | mM | | Xylitol | 4.1% | | | |
| | | Nitrate | | | | | | | | | | | | | |
| 761 | 6.26 | Lithium Sulfate | 10 | 0.4 | M | 9.113001215 | Na—K-Phosphate pH 6.5 | 100 | mM | | | | | | |
| | | Monohydrate | | | | | | | | | | | | | |
| 762 | 7.1 | Ammonium | 2.98116 | 3.0 | M | 20.7 | Hepes pH 6.5 | 100 | mM | | Strontium Chloride | 0.066 | M | | |
| | | Acetate | | | | | | | | | | | | | |
| 763 | 8.23 | Sodium Chloride | 1.95 | 2.0 | M | 20 | Mopso pH 7.5 | 100 | mM | | | | | | |
| 764 | 7.27 | | | | | | Na—K-Phosphate pH 6.5 | 100 | mM | | Phenol | 0.025 | M | | |
| 765 | 8.52 | Lithium Sulfate | 8 | 0.3 | M | 7.290400972 | Na-Malonate pH 5.0 | 100 | mM | | 1,4 Butanediol | 1.5% | | | |
| | | Monohydrate | | | | | | | | | | | | | |
| 766 | 6.95 | Potassium | 37.4 | 1.3 | M | 43.97750511 | Hepes pH 6.5 | 100 | mM | | 1,4 Dioxane | 0.5% | | | |
| | | Sodium Tartrate | | | | | | | | | | | | | |
| 767 | 5.39 | Zinc Sulfate | 5 | 0.3 | M | 6.806930693 | Bis-Tris Propane pH 6.5 | 100 | mM | | Glycine | 0.3 | M | | |
| | | Hexahydrate | | | | | | | | | | | | | |
| 768 | 5.42 | Ammonium | 1.71 | 1.7 | M | 24.42857143 | TRIS-Maleate pH 5.5 | 50 | mM | | | | | | |
| | | Sulfate | | | | | | | | | | | | | |
| 769 | 10.07 | Ammonium | 1.24 | 1.2 | M | 17.71428571 | CAPSO pH 9.5 | 50 | mM | | Guanidine HCl | 0.054 | M | Triton X-100 | 0.92% |
| | | Sulfate | | | | | | | | | | | | | |
| 770 | 4.94 | | | | | | Mopso pH 6.5 | 100 | mM | | Ethyl Acetate | 2.55% | | | |
| 771 | 4.39 | Ammonium | 1.65 | 1.7 | M | 23.57142857 | TRIS-Maleate pH 4.5 | 50 | mM | | sec-butanol | 4.7% | | | |
| | | Sulfate | | | | | | | | | | | | | |
| 772 | 6.99 | Ammonium | 2.5 | 2.5 | M | 35.71428571 | TRIS-Maleate pH 6.5 | 50 | mM | | 1,4 Butanediol | 2.7% | | | |
| | | Sulfate | | | | | | | | | | | | | |
| 773 | 0.86 | Nickel Chloride | 43.6 | 1.8% | | 21.875 | | 0 | mM | | Dextran Sulfate | 1.86% | | | |
| | | Hexahydrate | | | | | | | | | | | | | |
| 774 | 8.36 | Magnesium | 2.79 | 1.2 | M | 30.59210526 | CAPSO pH 8.5 | 50 | mM | | MPD | 0.5% | | Glucopyranoside | 0.2% |
| | | Chloride | | | | | | | | | | | | | |
| 775 | 6.03 | Calcium Chloride | 2.03 | 0.8 | M | 19.1509434 | Na-Cacodylate pH 7.5 | 100 | mM | | 1,4 Dioxane | 2.8% | | | |
| 776 | 7.28 | | | | | | Na-Citrate pH 5.5 | 50 | mM | | Taurine | 0.12 | M | | |
| 777 | 3.68 | Calcium Chloride | 1.63 | 0.6 | M | 15.37735849 | Na-Cacodylate pH 4.5 | 100 | mM | | | | | | |
| 778 | 8.15 | Ammonium | 1 | 1.0 | M | 14.28571429 | TRIS-HCl pH 8.5 | 100 | mM | | Trimethylamine HCl | 0.091 | M | | |
| | | Sulfate | | | | | | | | | | | | | |
| 779 | 5.96 | Sodium Acetate | 11.8 | 1.5 | M | 7.5 | Na-Malonate pH 7.0 | 100 | mM | | PEG 400 | 0.6% | | | |
| 780 | 6.76 | Potassium | 21.6 | 0.8 | M | 25.39877301 | Hepes pH 6.5 | 100 | mM | | Trimethylamine HCl | 0.018 | M | | |
| | | Sodium Tartrate | | | | | | | | | | | | | |
| 781 | 6.09 | Tri-Sodium Citrate | 0.319 | 0.3 | M | 8.307291667 | Na-Malonate pH 5.0 | 100 | mM | | Ethylene Glycol | 2.7% | | | |
| | | Dihydrate | | | | | | | | | | | | | |
| 782 | 7.42 | Sodium Acetate | 46.07 | 2.0 | M | 10 | TRIS-HCl pH 6.5 | 100 | mM | | | | | | |
| 783 | 6.27 | | | | | | Na—K-Phosphate pH 5.5 | 100 | mM | | | | | Triton X-100 | 0.74% |
| 784 | 5.52 | Calcium Acetate | 31.6 | 0.4 | M | 21.06666667 | Na-Acetate pH 4.5 | 50 | mM | | 2,2,2-Trifluoroethanol | 1.6% | | | |
| | | Dihydrate | | | | | | | | | | | | | |
| 785 | 7.06 | | | | | | Hepes pH 8.5 | 100 | mM | | Yttrium Chloride | 0.002 | M | | |
| 786 | 3.99 | Cadmium Sulfate | 25.6 | 0.3 | M | 12.8 | TRIS-Maleate pH 5.5 | 50 | mM | | D (+) Glucose | 4.5% | | | |
| | | Monohydrate | | | | | | | | | | | | | |
| 787 | 6.13 | Sodium Formate | 20 | 4.3 | M | 30.35714286 | Na-Acetate pH 4.5 | 50 | mM | | 2,2,2-Trifluoroethanol | 1.6% | | | |
| 788 | 7.76 | Sodium Formate | 15 | 4.4 | M | 31.25911451 | Na—K-Phosphate pH 7.5 | 100 | mM | | | | | | |
| 789 | 5.42 | | | | | | Na-Cacodylate pH 5.5 | 100 | mM | | Acetonitrile | 8% | | | |
| 790 | 5.86 | Zinc Sulfate | 30 | 1.6 | M | 40.84158416 | Na-Cacodylate pH 7.5 | 100 | mM | | PEG 400 | 3.9% | | | |
| | | Hexahydrate | | | | | | | | | | | | | |
| 791 | 7.15 | | | | | | Na-Cacodylate pH 7.5 | 100 | mM | | Dextran Sulfate | 1.44% | | | |
| 792 | 9.02 | Potassium | 0.44 | 0.1 | M | 3.819444444 | | 0 | mM | | Guanidine HCl | 0.04 | M | | |
| | | Phosphate | | | | | | | | | | | | | |
| 793 | 6.53 | Sodium Sulfate | 0.289 | 0.5 | M | 22.578125 | Hepes pH 6.5 | 100 | mM | | Phenol | 0.037 | M | | |
| 794 | 7.15 | Sodium Formate | 41.29 | 6.0 | M | 42.85714286 | Na-Cacodylate pH 7.5 | 100 | mM | | | | | Glycerol | 2% |
| 795 | 6.32 | Sodium Acetate | 10.36 | 2.1 | M | 10.625 | CAPSO pH 8.5 | 50 | mM | | Dextran Sulfate | 3% | | | |
| 796 | 5.92 | Sodium Chloride | 0.98 | 1.0 | M | 10 | Na-Cacodylate pH 5.5 | 100 | mM | | | | | | |
| 797 | 6.21 | Ammonium | 14.4 | 3.1 | M | 15.74201183 | Na-Succinate pH 6.5 | 100 | mM | | | | | | |
| | | Nitrate | | | | | | | | | | | | | |
| 798 | 4.38 | Magnesium | 2.34 | 1.0 | M | 25.65789474 | Na-Acetate pH 5.5 | 50 | mM | | Taurine | 0.052 | M | | |
| | | Chloride | | | | | | | | | | | | | |
| 799 | 9.24 | Potassium | 1.59 | 0.4 | M | 13.80208333 | | 0 | mM | | | | | | |
| | | Phosphate | | | | | | | | | | | | | |
| 800 | 6.77 | Sodium Formate | 34.71 | 5.6 | M | 40 | Hepes pH 6.5 | 100 | mM | | Yttrium Chloride | 0.02 | M | | |
| 801 | 7.73 | Ammonium | 23.4 | 5.1 | M | 25.58076923 | CAPSO pH 9.5 | 50 | mM | | 2,2,2-Trifluoroethanol | 4.1% | | Glycerol | 6.4% |
| | Nitrate | | | | | | | | | | | | | | |
| 802 | 8.33 | Potassium | 5.8 | 0.2 | M | 6.8200409 | Hepes pH 8.5 | 100 | mM | | 1,4 Dioxane | 1.5% | | | |
| | | Sodium Tartrate | | | | | | | | | | | | | |
| 803 | 4.54 | | | | | | Na-Citrate pH 4.5 | 50 | mM | | 1,4-Dithio-DL-Threitol | 0.021 | M | | |
| 804 | 6.66 | Ammonium | 15.6 | 15.6% | | 7.8 | Na—K-Phosphate pH 6.5 | 100 | mM | | | | | | |
| | | Bromide | | | | | | | | | | | | | |
| 805 | 4.55 | | | | | | Na-Citrate pH 4.5 | 50 | mM | | Glycerol Anhydrous | 3.4% | | Cymal-3 | 0.4% |
| 806 | 5.08 | Ammonium | 20.68 | 1.6 | M | 32.03943662 | | 0 | mM | | Dextran Sulfate | 2.04% | | | |
| | | Citrate | | | | | | | | | | | | | |
| 807 | 6.96 | Potassium | 25 | 0.9 | M | 29.39672802 | Na-Succinate pH 6.5 | 100 | mM | | Betaine Monohydrate | 0.002 | M | | |
| | | Sodium Tartrate | | | | | | | | | | | | | |
| 808 | 6.34 | Sodium Acetate | 33.39 | 1.6 | M | 8.15 | Na-Acetate pH 5.5 | 50 | mM | | Phenol | 0.05 | M | | |
| 809 | 7.02 | Ammonium | 25.6 | 5.6 | M | 27.98579882 | Na—K-Phosphate pH 8.5 | 100 | mM | | 1,4 Dioxane | 5% | | | |
| | | Nitrate | | | | | | | | | | | | | |
| 810 | 4.47 | Cadmium Sulfate | 47 | 0.5 | M | 23.5 | TRIS-Maleate pH 6.5 | 50 | mM | | Glycine | 0.22 | M | | |
| | | Monohydrate | | | | | | | | | | | | | |
| 811 | 5.85 | Nickel Chloride | 5 | 2.2% | | 27.5 | | 0 | mM | | 2,2,2-Trifluoroethanol | 1.2% | | | |
| | | Hexahydrate | | | | | | | | | | | | | |
| 812 | 4.06 | Magnesium | 0.9 | 1.0 | M | 19.8 | Na-Cacodylate pH 4.5 | 100 | mM | | 2,2,2-Trifluoroethanol | 2% | | | |
| | | Sulfate | | | | | | | | | | | | | |
| 813 | 9.94 | Ammonium | 1.78 | 1.8 | M | 25.42867143 | CAPSO pH 9.5 | 50 | mM | | Ethylene Glycol | 1.2% | | | |
| | | Sulfate | | | | | | | | | | | | | |
| 814 | 7.4 | Tri-Sodium Citrate | 0.68 | 0.6 | M | 17.70833333 | Bis-Tris Propane pH 6.6 | 100 | mM | | Betaine Monohydrate | 0.03 | M | | |
| | | Dihydrate | | | | | | | | | | | | | |
| 815 | 5.04 | Ammonium | 44.8 | 1.1 | M | 22.4 | Na-Acetate pH 5.5 | 50 | mM | | 1,4 Dioxane | 3.5% | | | |
| | | Phosphate | | | | | | | | | | | | | |
| 816 | 5.19 | | | | | | Na-Malonate pH 7.0 | 100 | mM | | Guanidine HCl | 0.02 | M | | |
| 817 | 5.53 | Ammonium | 0.84 | 0.8 | M | 12 | Na-Malonate pH 7.0 | 100 | mM | | Guanidine HCl | 0.02 | M | | |
| | | Sulfate | | | | | | | | | | | | | |
| 818 | 6.6 | Sodium Acetate | 75.18 | 1.3 | M | 6.25 | Na-Citrate pH 4.5 | 50 | mM | | Xylitol | 1.2% | | | |
| 819 | 8.98 | Calcium Chloride | 2.27 | 0.9 | M | 21.41509434 | | 0 | mM | | Glycerol Anhydrous | 1% | | | |
| 820 | 7.76 | Sodium Sulfate | 0.26 | 0.4 | M | 20.3125 | Na-Citrate pH 4.5 | 50 | mM | | | | | | |
| 821 | 1.41 | Ferric Chloride | 3.9 | 0.9 | M | 43.33333333 | Na-Citrate pH 4.5 | 50 | mM | | 1,4 Butanediol | 1% | | | |
| | | Hexahydrate | | | | | | | | | | | | | |
| 822 | 5.26 | Zinc Sulfate | 18 | 1.0 | M | 24.5049505 | TRIS-Maleate pH 6.5 | 50 | mM | | Yttrium Chloride | 0.025 | M | | |
| | | Hexahydrate | | | | | | | | | | | | | |
| 823 | 4.62 | | | | | | Mopso pH 6.5 | 100 | mM | | Urea | 0.18 | M | | |
| 824 | 6.59 | Sodium Sulfate | 0.247 | 0.4 | M | 19.296875 | Na-Succinate pH 7.5 | 100 | mM | | Dextran Sulfate | 1.56% | | | |
| 825 | 5.89 | Sodium Acetate | 19.11 | 1.8 | M | 9 | TRIS-Maleate pH 5.5 | 50 | mM | | ATP disodium salt | 0.018 | M | Triton X-100 | 0.22% |
| 826 | 8.19 | Potassium | 1.73 | 0.5 | M | 15.01736111 | Hepes pH 6.5 | 100 | mM | | | | | | |
| | | Phosphate | | | | | | | | | | | | | |
| 827 | 7.76 | Magnesium | 0.91 | 1.5 | M | 37.5 | TRIS-HCl pH 7.5 | 100 | mM | | | | | | |
| | | Chloride | | | | | | | | | | | | | |
| 828 | 6.86 | Sodium Acetate | 41.43 | 2.3 | M | 11.5 | Hepes pH 6.5 | 100 | mM | | | | | | |
| 829 | 8.38 | Potassium | 48.4 | 2.6 | M | 32.00690052 | Hepes pH 8.5 | 100 | mM | | Strontium Chloride | 0.023 | M | Glucopyranoside | 0.76% |
| | | Chloride | | | | | | | | | | | | | |
| 830 | 8.6 | | | | | | Na—K-Phosphate pH 8.5 | 100 | mM | | 1,4 Dioxane | 2% | | | |
| 831 | 6.28 | Ammonium | 1.81 | 1.8 | M | 25.85714286 | Na-Cacodylate pH 5.5 | 100 | mM | | | | | | |
| | | Sulfate | | | | | | | | | | | | | |
| 832 | 5.4 | Sodium Acetate | 15.36 | 1.9 | M | 9.5 | Na-Citrate pH 4.5 | 50 | mM | | Trimethylamine HCl | 0.092 | M | | |
| 833 | 8.57 | Lithium Sulfate | 40 | 1.5 | M | 36.45200486 | TRIS-HCl pH 7.5 | 50 | mM | | | | | | |
| | | Monohydrate | | | | | | | | | | | | | |
| 834 | 7.26 | Ammonium | 4.07628 | 4.1 | M | 28.3 | TRIS-HCl pH 6.5 | 100 | mM | | PEG 400 | 5% | | | |
| | | Acetate | | | | | | | | | | | | | |
| 835 | 4.49 | Ammonium | 31.6 | 6.9 | M | 34.54497041 | | 0 | mM | | MPD | 3.3% | | C12E9 | 0.2% |
| | | Nitrate | | | | | | | | | | | | | |
| 836 | 7.63 | | | | | | Na—K-Phosphate pH 7.5 | 100 | mM | | Guanidine HCl | 0.36 | M | | |
| 837 | 5.62 | Lithium Sulfate | 20 | 0.7 | M | 18.22600243 | Hepes pH 7.5 | 100 | mM | | Glycerol Anhydrous | 1% | | | |
| | | Monohydrate | | | | | | | | | | | | | |
| 838 | 7.82 | Potassium | 20 | 0.7 | M | 23.51738241 | TRIS-HCl pH 7.5 | 100 | mM | | | | | | |
| | | Sodium Tartrate | | | | | | | | | | | | | |
| 839 | 8.28 | Lithium Sulfate | 31.6 | 1.2 | M | 28.79708384 | Hepes pH 8.5 | 100 | mM | | Trimethylamine HCl | 0.046 | M | Glucopyranoside | 0.56% |
| | | Monohydrate | | | | | | | | | | | | | |
| 840 | 8.08 | Potassium | 21.4 | 0.8 | M | 25.16359918 | Hepes pH 8.5 | 100 | mM | | | | | | |
| | | Sodium Tartrate | | | | | | | | | | | | | |
| 841 | 6.92 | Ammonium | 1.81 | 1.8 | M | 25.85714286 | Na-Succinate pH 7.5 | 100 | mM | | | | | | |
| | | Sulfate | | | | | | | | | | | | | |
| 842 | 6.75 | Potassium | 13.6 | 0.5 | M | 15.99182004 | Mopso pH 6.5 | 100 | mM | | Ethylene Glycol | 2.5% | | | |
| | | Sodium Tartrate | | | | | | | | | | | | | |
| 843 | 6.65 | Ammonium | 54.8 | 6.0 | M | 30 | CAPSO pH 8.5 | 50 | mM | | Yttrium Chloride | 0.002 | M | | |
| | | Nitrate | | | | | | | | | | | | | |
| 844 | 5.96 | Ammonium | 0.84 | 0.8 | M | 12 | Na—K-Phosphate pH 5.5 | 100 | mM | | sec-butanol | 1% | | Glucopyranoside | 0.6% |
| | | Sulfate | | | | | | | | | | | | | |
| 845 | 6.29 | Calcium Chloride | 3.75 | 1.4 | M | 35.37735849 | | 0 | mM | | Glycyl-Glycyl-Glycine | 0.002 | M | Cymal-3 | 0.74% |
| 846 | 6.52 | | | | | | Hepes pH 6.5 | 100 | mM | | Betaine Monohydrate | 0.082 | M | | |
| 847 | 7.01 | Sodium Sulfate | 0.115 | 0.2 | M | 8.984375 | Na-Cacodylate pH 7.5 | 100 | mM | | Guanidine HCl | 0.09 | M | | |
| 848 | 5.92 | Ammonium | 16 | 0.4 | M | 8 | Bis-Tris Propane pH 8.5 | 100 | mM | | | | | | |
| | | Phosphate | | | | | | | | | | | | | |
| 849 | 6.48 | Calcium Chloride | 0.43 | 0.2 | M | 4.056603774 | Na-Cacodylate pH 7.5 | 100 | mM | | Manganese Chloride | 0.041 | M | | |
| 850 | 4.03 | Lithium Sulfate | 45.6 | 1.7 | M | 41.55528554 | Na-Malonate pH 5.0 | 100 | mM | | Trimethylamine HCl | 0.002 | M | | |
| | | Monohydrate | | | | | | | | | | | | | |
| 851 | 8.04 | | | | | | Na—K-Phosphate pH 7.5 | 100 | mM | | Trimethylamine HCl | 0.031 | M | | |
| 852 | 1.52 | Ferric Chloride | 4 | 0.9 | M | 44.44444444 | CAPSO pH 9.5 | 50 | mM | | Strontium Chloride | 0.002 | M | | |
| | | Hexahydrate | | | | | | | | | | | | | |
| 853 | 4.25 | Zinc Sulfate | 60 | 1.8 | M | 43.75 | | 0 | mM | | | | | | |
| | | Hexahydrate | | | | | | | | | | | | | |
| 854 | 7.31 | Ammonium | 4.2588 | 4.3 | M | 29.6 | | 0 | mM | | ATP disodium salt | 0.018 | M | | |
| | | Acetate | | | | | | | | | | | | | |
| 855 | 4.76 | Ammonium | 54.6 | 1.4 | M | 27.3 | Mopso pH 6.5 | 100 | mM | | Guanidine HCl | 0.02 | M | | |
| | | Phosphate | | | | | | | | | | | | | |
| 856 | 7.74 | Ammonium | 0.84 | 0.8 | M | 12 | Hepes pH 8.5 | 100 | mM | | | | | | |
| | | Sulfate | | | | | | | | | | | | | |
| 857 | 5.16 | Lithium Sulfate | 15.6 | 0.6 | M | 14.2162819 | Na-Succinate pH 5.5 | 100 | mM | | Xylitol | 4.5% | | | |
| | | Monohydrate | | | | | | | | | | | | | |
| 858 | 9.49 | Tri-Sodium Citrate | 0.59 | 0.5 | M | 15.36458333 | CAPSO pH 8.5 | 50 | mM | | | | | | |
| | | Dihydrate | | | | | | | | | | | | | |
| 859 | 1.46 | Ferric Chloride | 1 | 0.2 | M | 11.11111111 | TRIS-Maleate pH 4.5 | 50 | mM | | Taurine | 0.048 | M | | |
| | | Hexahydrate | | | | | | | | | | | | | |
| 860 | 6.53 | Ammonium | 20 | 20.0% | | 10 | Na-Succinate pH 6.5 | 100 | mM | | | | | | |
| | | Bromide | | | | | | | | | | | | | |
| 861 | 4.5 | Ammonium | 1.13 | 1.1 | M | 16.14285714 | Na-Citrate pH 4.5 | 50 | mM | | 1,4 Dioxane | 3.1% | | | |
| | | Sulfate | | | | | | | | | | | | | |
| 862 | 6.98 | Lithium Chloride | 2.4 | 2.4 | M | 12 | Na-Citrate pH 5.5 | 50 | mM | | | | | | |
| 863 | 6.52 | Ammonium | 2.77836 | 2.8 | M | 19.3 | Na-Malonate pH 6.0 | 100 | mM | | | | | Cymal-3 | 0.2% |
| | | Acetate | | | | | | | | | | | | | |
| 864 | 5.37 | | | | | | Na-Succinate pH 5.5 | 100 | mM | | PEG 400 | 3% | | Triton X-100 | 0.2% |
| 865 | 5.29 | Sodium | 0.1 | 0.1 | M | 8.6 | CAPSO pH 8.5 | 50 | mM | | | | | | |
| | | Phosphate | | | | | | | | | | | | | |
| 866 | 4.36 | | | | | | Na-Succinate pH 4.5 | 100 | mM | | D (+) Glucose | 15% | | | |
| 867 | 6.29 | Ammonium | 1.05456 | 1.1 | M | 7.3 | Na-Cacodylate pH 4.5 | 100 | mM | | Ethylene Glycol | 2.4% | | | |
| | | Acetate | | | | | | | | | | | | | |
| 868 | 5.35 | Sodium Sulfate | 0.095 | 0.1 | M | 7.421875 | Na-Succinate pH 5.5 | 100 | mM | | Trimethylamine HCl | 0.067 | M | Maltoside | 0.2% |
| 869 | 6.48 | Lithium Sulfate | 42 | 1.5 | M | 38.2746051 | Hepes pH 6.5 | 100 | mM | | Ethylene Glycol | 3.6% | | | |
| | | Monohydrate | | | | | | | | | | | | | |
| 870 | 3.46 | Magnesium | 0.85 | 0.8 | M | 18.75 | TRIS-Maleate pH 4.5 | 50 | mM | | Ethylene Glycol | 1% | | | |
| | | Chloride | | | | | | | | | | | | | |
| 871 | 5.48 | Calcium Acetate | 26.8 | 0.4 | M | 17.86666667 | Na-Cacodylate pH 5.5 | 100 | mM | | | | | | |
| | | Dihydrate | | | | | | | | | | | | | |
| 872 | 5.78 | Calcium Chloride | 0.56 | 0.2 | M | 5.283018868 | TRIS-Maleate pH 6.5 | 50 | mM | | Xylitol | 1.5% | | | |
| 873 | 4.49 | | | | | | Na-Succinate pH 4.5 | 100 | mM | | 2,2,2-Trifluoroethanol | 14% | | | |
| 874 | 4.7 | Ammonium | 40 | 1.0 | M | 20 | TRIS-HCl pH 7.5 | 100 | mM | | | | | | |
| | | Phosphate | | | | | | | | | | | | | |
| 875 | 5.74 | Magnesium | 0.45 | 0.5 | M | 9.9 | Mopso pH 6.5 | 100 | mM | | | | | | |
| | | Sulfate | | | | | | | | | | | | | |
| 876 | 8.59 | Sodium Formate | 44.51 | 4.1 | M | 29.28571429 | TRIS-HCl pH 8.5 | 100 | mM | | Glycerol Anhydrous | 3.5% | | | |
| 877 | 8.13 | Potassium | 1.73 | 0.5 | M | 15.01736111 | Na—K-Phosphate pH 6.5 | 100 | mM | | | | | | |
| | | Phosphate | | | | | | | | | | | | | |
| 878 | 5.87 | Ammonium | 1.13 | 1.1 | M | 16.14285714 | TRIS-Maleate pH 6.5 | 50 | mM | | Ethyl Acetate | 2.13% | | | |
| | | Sulfate | | | | | | | | | | | | | |
| 879 | 6.43 | Tri-Sodium Citrate | 0.852 | 0.7 | M | 22.1875 | TRIS-Maleate pH 4.5 | 50 | mM | | Phenol | 0.091 | M | | |
| | | Dihydrate | | | | | | | | | | | | | |
| 880 | 6.92 | Sodium Sulfate | 0.138 | 0.2 | M | 10.78125 | Na-Cacodylate pH 7.5 | 100 | mM | | PEG 400 | 3.8% | | | |
| 881 | 8.59 | Sodium Acetate | 70.18 | 2.6 | M | 13 | | 0 | mM | | 1,4 Dioxane | 1% | | | |
| 882 | 7.83 | Ammonium | 2.92 | 2.9 | M | 41.71428571 | TRIS-HCl pH 7.5 | 100 | mM | | | | | | |
| | | Sulfate | | | | | | | | | | | | | |
| 883 | 6.69 | Calcium Acetate | 16.8 | 0.2 | M | 11.2 | | 0 | mM | | Manganese Chloride | 0.006 | M | Glycerol | 3% |
| | | Dihydrate | | | | | | | | | | | | | |
| 884 | 1.42 | Ferric Chloride | 1.4 | 0.3 | M | 15.55555556 | Hepes pH 7.5 | 100 | mM | | Guanidine HCl | 0.02 | M | | |
| | | Hexahydrate | | | | | | | | | | | | | |
| 885 | 3.96 | | | | | | Na-Malonate pH 6.0 | 100 | mM | | ATP disodium salt | 0.011 | M | | |
| 886 | 6.99 | Potassium | 30 | 1.1 | M | 35.27607362 | Na—K-Phosphate pH 6.5 | 100 | mM | | 1,4-Dithio-DL-Threitol | 0.002 | M | | |
| | | Sodium Tartrate | | | | | | | | | | | | | |
| 887 | 5.26 | | | | | | Na-Acetate pH 5.5 | 50 | mM | | PEG 400 | 10% | | | |
| 888 | 3.99 | | | | | | Na-Malonate pH 6.0 | 100 | mM | | Guanidine HCl | 0.2 | M | | |
| 889 | 6.29 | | | | | | Na-Succinate pH 6.5 | 100 | mM | | ATP disodium salt | 0.006 | M | | |
| 890 | 7.09 | Calcium Acetate | 40 | 0.5 | M | 26.66666667 | Hepes pH 7.5 | 50 | mM | | | | | | |
| | | Dihydrate | | | | | | | | | | | | | |
| 891 | 2.01 | Nickel Chloride | 42.6 | 1.0% | | 12.5 | Na-Citrate pH 5.5 | 50 | mM | | Ethyl Acetate | 1.14% | | | |
| | | Hexahydrate | | | | | | | | | | | | | |
| 892 | 7.36 | | | | | | Mopso pH 7.5 | 100 | mM | | Glycine | 0.298 | M | | |
| 893 | 2.18 | Calcium Chloride | 3.48 | 1.3 | M | 32.83018868 | Na-Acetate pH 4.5 | 50 | mM | | PEG 400 | 2% | | | |
| 894 | 7.75 | Potassium | 40 | 1.4 | M | 45 | Bis-Tris Propane pH 7.5 | 100 | mM | | | | | | |
| | | Sodium Tartrate | | | | | | | | | | | | | |
| 895 | 1.54 | Ferric Chloride | 1.6 | 0.4 | M | 17.77777778 | TRIS-HCl pH 8.5 | 100 | mM | | 1,4 Butanediol | 3% | | Glycerol | 9% |
| | | Hexahydrate | | | | | | | | | | | | | |
| 896 | 3.46 | Zinc Sulfate | 57 | 1.5 | M | 37.5 | | 0 | mM | | Yttrium Chloride | 0.073 | M | | |
| | | Hexahydrate | | | | | | | | | | | | | |
| 897 | 5.11 | Ammonium | 9 | 2.0 | M | 9.838757396 | Na-Citrate pH 5.5 | 50 | mM | | Glycyl-Glycyl-Glycine | 0.072 | M | | |
| | | Nitrate | | | | | | | | | | | | | |
| 898 | 4.96 | Ammonium | 24.55 | 1.3 | M | 26 | TRIS-HCl pH 8.5 | 100 | mM | | Benzamidine HCl | 3.6% | | Glycerol | 6.4% |
| | | Citrate | | | | | | | | | | | | | |
| 899 | 9.26 | Potassium | 1.53 | 0.4 | M | 13.28125 | Bis-Tris Propane pH 7.5 | 100 | mM | | Trimethylamine HCl | 0.006 | M | | |
| | | Phosphate | | | | | | | | | | | | | |
| 900 | 5.25 | Ammonium | 9.2 | 2.0 | M | 10.05739645 | Na-Acetate pH 5.5 | 50 | mM | | Yttrium Chloride | 0.012 | M | Glycerol | 3.6% |
| | | Nitrate | | | | | | | | | | | | | |
| 901 | 6.59 | | | | | | TRIS-Maleate pH 6.5 | 50 | mM | | Strontium Chloride | 0.002 | M | | |
| 902 | 7.29 | Potassium | 58.2 | 1.2 | M | 38.33333333 | Na-Cacodylate pH 7.5 | 100 | mM | | Guanidine HCl | 0.01 | M | | |
| | | Sodium Tartrate | | | | | | | | | | | | | |
| 903 | 7.01 | Ammonium | 1.9266 | 1.9 | M | 13.4 | Na—K-Phosphate pH 6.5 | 100 | mM | | Phenol | 0.024 | M | | |
| | | Acetate | | | | | | | | | | | | | |
| 904 | 8.03 | | | | | | Hepes pH 8.5 | 100 | mM | | Ethylene Glycol | 25% | | | |
| 905 | 6.28 | | | | | | Mopso pH 7.5 | 100 | mM | | Cupric Chloride | 0.002 | M | | |
| 906 | 5.18 | Potassium | 39 | 2.1 | M | 25.7906843 | Na-Citrate pH 5.5 | 50 | mM | | Urea | 0.06 | M | Triton X-100 | 0.88% |
| | | Chloride | | | | | | | | | | | | | |
| 907 | 5.9 | Sodium Sulfate | 0.113 | 0.2 | M | 8.828125 | | 0 | mM | | sec-butanol 3.5% | | | | |
| 908 | 5.37 | | | | | | Na—K-Phosphate pH 5.5 | 100 | mM | | ATP disodium salt | 0.01 | M | | |
| 909 | 4.23 | Potassium | 53.6 | 2.8 | M | 35.44565842 | Na-Malonate pH 6.0 | 100 | mM | | sec-butanol | 3.9% | | | |
| | | Chloride | | | | | | | | | | | | | |
| 910 | 8.04 | Lithium Chloride | 4.15 | 4.2 | M | 20.75 | Hepes pH 8.5 | 100 | mM | | Trimethylamine HCl | 0.075 | M | | |
| 911 | 4.46 | Calcium Chloride | 3.48 | 1.3 | M | 32.83018868 | Bis-Tris Propane pH 8.5 | 100 | mM | | | | | | |
| 912 | 9.66 | Calcium Acetate | 5 | 0.1 | M | 3.333333333 | CAPSO pH 9.5 | 50 | mM | | Guanidine HCl | 0.002 | M | | |
| | | Dihydrate | | | | | | | | | | | | | |
| 913 | 5.28 | | | | | | Na-Malonate pH 7.0 | 100 | mM | | Taurine | 0.033 | M | | |
| 914 | 5.19 | Ammonium | 41 | 1.0 | M | 20.5 | Mopso pH 7.5 | 100 | mM | | Xylitol | 1% | | | |
| | | Phosphate | | | | | | | | | | | | | |
| 915 | 8.42 | Ammonium | 2.6 | 2.6 | M | 37.14285714 | TRIS-HCl pH 8.5 | 100 | mM | | PEG 400 | 4.7% | | | |
| | | Sulfate | | | | | | | | | | | | | |
| 916 | 4.63 | Cadmium Sulfate | 53.4 | 0.5 | M | 26.7 | Bis-Tris Propane pH 9.5 | 100 | mM | | Ethylene Glycol | 4% | | | |
| | | Monohydrate | | | | | | | | | | | | | |
| 917 | 7.01 | Potassium | 20 | 0.7 | M | 23.51738241 | Na-Acetate pH 5.5 | 50 | mM | | MPD | 3% | | | |
| | | Sodium Tartrate | | | | | | | | | | | | | |
| 918 | 8.43 | Ammonium | 2.92 | 2.9 | M | 41.71428571 | Hepes pH 8.5 | 100 | mM | | Guanidine HCl | 0.024 | M | | |
| | | Sulfate | | | | | | | | | | | | | |
| 919 | 5.74 | Calcium Chloride | 0.6 | 0.2 | M | 5.660377358 | Na-Cacodylate pH 6.5 | 100 | mM | | 2,2,2-Trifluoroethanol | 2.5% | | | |
| 920 | 9.16 | Potassium | 1.38 | 0.4 | M | 11.97916667 | Na—K-Phosphate pH 7.5 | 100 | mM | | Betaine Monohydrate | 0.059 | M | | |
| | | Phosphate | | | | | | | | | | | | | |
| 921 | 8.12 | | | | | | TRIS-HCl pH 8.5 | 100 | mM | | PEG 400 | 3.9% | | | |
| 922 | 7.49 | Ammonium | 4.49202 | 4.5 | M | 31.2 | Na—K-Phosphate pH 8.5 | 100 | mM | | 1,4 Butanediol | 2.5% | | | |
| | | Acetate | | | | | | | | | | | | | |
| 923 | 4.64 | Ammonium | 37.8 | 0.9 | M | 18.9 | Hepes pH 6.5 | 100 | mM | | Xylitol | 2.9% | | | |
| | | Phosphate | | | | | | | | | | | | | |
| 924 | 5.1 | Ammonium | 25.91 | 1.0 | M | 20 | CAPSO pH 9.5 | 50 | mM | | Dextran Sulfate | 2.7% | | | |
| | | Citrate | | | | | | | | | | | | | |
| 925 | 6.19 | Potassium | 14.4 | 0.8 | M | 9.522714204 | Mopso pH 6.5 | 100 | mM | | Glycyl-Glycyl-Glycine | 0.043 | M | | |
| | | Chloride | | | | | | | | | | | | | |
| 926 | 7.01 | Ammonium | 20 | 20.0% | | 10 | TRIS-HCl pH 6.5 | 100 | mM | | | | | | |
| | | Bromide | | | | | | | | | | | | | |
| 927 | 6.34 | Calcium Chloride | 0.5 | 0.2 | M | 4.716981132 | Bis-Tris Propane pH 6.5 | 100 | mM | | Benzamidine HCl | 0.5% | | | |
| 928 | 7.23 | Tri-Sodium Citrate | 0.38 | 0.3 | M | 9.895833333 | Hepes pH 7.5 | 100 | mM | | | | | | |
| | | Dihydrate | | | | | | | | | | | | | |
| 929 | 7.19 | Lithium Sulfate | 46.6 | 1.7 | M | 42.46658566 | CAPSO pH 8.5 | 50 | mM | | Yttrium Chloride | 0.002 | M | | |
| | | Monohydrate | | | | | | | | | | | | | |
| 930 | 5.52 | Sodium Formate | 29.11 | 3.5 | M | 25 | Na-Acetate pH 5.5 | 50 | mM | | Guanidine HCl | 0.02 | M | | |
| 931 | 4.98 | Cadmium Sulfate | 38.8 | 0.4 | M | 19.4 | | 0 | mM | | 1,4 Butanediol | 4.5% | | | |
| | | Monohydrate | | | | | | | | | | | | | |
| 932 | 7.99 | Lithium Chloride | 0.79 | 0.8 | M | 3.95 | TRIS-HCl pH 8.5 | 100 | mM | | D (+) Glucose | 2.5% | | | |
| 933 | 4.24 | Ammonium | 40 | 1.0 | M | 20 | TRIS-Maleate pH 4.5 | 50 | mM | | | | | | |
| | | Phosphate | | | | | | | | | | | | | |
| 934 | 8.69 | Calcium Acetate | 22 | 0.3 | M | 14.66666667 | CAPSO pH 8.5 | 50 | mM | | 2,2,2-Trifluoroethanol | 2.1% | | | |
| | | Dihydrate | | | | | | | | | | | | | |
| 935 | 6.86 | Sodium Sulfate | 0.453 | 0.7 | M | 35.390625 | TRIS-HCl pH 6.5 | 100 | mM | | | | | | |
| 936 | 6.97 | Calcium Chloride | 0.89 | 0.3 | M | 8.396226415 | TRIS-HCl pH 7.5 | 100 | mM | | 2,2,2-Trifluoroethanol | 1% | | | |
| 937 | 6.94 | Ammonium | 10.4 | 10.4% | | 5.2 | TRIS-Maleate pH 6.5 | 50 | mM | | sec-butanol | 3.8% | | | |
| | | Bromide | | | | | | | | | | | | | |
| 938 | 8.28 | | | | | | TRIS-HCl pH 7.5 | 100 | mM | | Spermidine | 0.02 | M | | |
| 939 | 6.38 | Sodium | 0.17 | 0.2 | M | 15 | Na-Malonate pH 6.0 | 100 | mM | | | | | | |
| | | Phosphate | | | | | | | | | | | | | |
| 940 | 4.36 | Lithium Chloride | 8.81 | 8.5 | M | 42.5 | TRIS-Maleate pH 6.5 | 50 | mM | | Xylitol | 1% | | Cymal-3 | 0.1% |
| 941 | 5.63 | Ammonium | 10 | 2.2 | M | 10.93195266 | | 0 | mM | | Glycyl-Glycyl-Glycine | 0.002 | M | | |
| | | Nitrate | | | | | | | | | | | | | |
| 942 | 8.59 | Potassium | 2.85 | 0.7 | M | 24.73958333 | TRIS-Maleate pH 4.5 | 50 | mM | | D (+) Glucose | 2.5% | | | |
| | | Phosphate | | | | | | | | | | | | | |
| 943 | 7.09 | Calcium Chloride | 0.43 | 0.2 | M | 4.056603774 | | 0 | mM | | sec-butanol | 1% | | | |
| 944 | 2.68 | Nickel Chloride | 44.4 | 0.8% | | 9.375 | Bis-Tris Propane pH 9.5 | 100 | mM | | | | | | |
| | | Hexahydrate | | | | | | | | | | | | | |
| 945 | 8.55 | Potassium | 2 | 0.5 | M | 17.36111111 | Bis-Tris Propane pH 9.5 | 100 | mM | | | | | | |
| | | Phosphate | | | | | | | | | | | | | |
| 946 | 8.52 | Potassium | 2.3 | 0.6 | M | 19.96527778 | TRIS-HCl pH 6.5 | 100 | mM | | | | | | |
| | | Phosphate | | | | | | | | | | | | | |
| 947 | 4.27 | Potassium | 21.2 | 1.1 | M | 14.01955147 | TRIS-Maleate pH 4.5 | 50 | mM | | Glycerol Anhydrous | 3.8% | | | |
| | | Chloride | | | | | | | | | | | | | |
| 948 | 4.36 | Sodium | 0.32 | 0.3 | M | 27.2 | TRIS-Maleate pH 4.5 | 50 | mM | | Benzamidine HCl | 0.5% | | | |
| | | Phosphate | | | | | | | | | | | | | |
| 949 | 4.72 | Ammonium | 43.2 | 1.1 | M | 21.6 | Na-Succinate pH 5.5 | 100 | mM | | Taurine | 0.013 | M | | |
| | | Phosphate | | | | | | | | | | | | | |
| 950 | 6.57 | Ammonium | 30 | 2.1 | M | 42 | Na-Citrate pH 5.5 | 50 | mM | | Yttrium Chloride | 0.002 | M | | |
| | | Citrate | | | | | | | | | | | | | |
| 951 | 6.85 | Sodium Acetate | 20.71 | 2.5 | M | 12.5 | TRIS-Maleate pH 6.5 | 50 | mM | | | | | | |
| 952 | 4.84 | Cadmium Sulfate | 46.6 | 0.6 | M | 31.06666667 | TRIS-HCl pH 7.5 | 100 | mM | | Glycine | 0.1 | M | Maltoside | 0.22% |
| | | Monohydrate | | | | | | | | | | | | | |
| 953 | 9.57 | Lithium Sulfate | 27.8 | 1.0 | M | 25.33414338 | CAPSO pH 9.5 | 50 | mM | | | | | | |
| | | Monohydrate | | | | | | | | | | | | | |
| 954 | 8.55 | Potassium | 1.26 | 0.3 | M | 10.9375 | Bis-Tris Propane pH 9.5 | 100 | mM | | MPD | 4.6% | | | |
| | | Phosphate | | | | | | | | | | | | | |
| 955 | 6.94 | Ammonium | | | | | | | | | | | | | |
| | | Acetate | 1.10526 | 1.1 | M | 7.7 | | 0 | mM | | Taurine | 0.025 | M | Triton X-100 | 0.36% |
| 956 | 5.49 | Ammonium | 10.6 | 0.3 | M | 5.3 | Na-Succinate pH 7.5 | 100 | mM | | Benzamidine HCl | 0.96% | | | |
| | | Phosphate | | | | | | | | | | | | | |
| 957 | 8.49 | Potassium | 40 | 2.1 | M | 26.4519839 | Bis-Tris Propane pH 8.5 | 100 | mM | | | | | | |
| | | Chloride | | | | | | | | | | | | | |
| 958 | 8.38 | Ammonium | 1.07 | 1.1 | M | 15.28571429 | Hepes pH 8.5 | 100 | mM | | Xylitol | 1.3% | | | |
| | | Sulfate | | | | | | | | | | | | | |
| 959 | 4.52 | Sodium | 0.295 | 0.3 | M | 25.4 | | 0 | mM | | | | | Triton X-100 | 0.46% |
| | | Phosphate | | | | | | | | | | | | | |
| 960 | 4.79 | Ammonium | 41.6 | 1.0 | M | 20.8 | Mopso pH 6.5 | 100 | mM | | PEG 400 | 1% | | | |
| | | Phosphate | | | | | | | | | | | | | |
| 961 | 5.48 | Sodium Formate | 27.36 | 2.0 | M | 14.28571429 | Na-Succinate pH 5.5 | 100 | mM | | Manganese Chloride | 0.059 | M | | |
| 962 | 7.47 | Sodium Chloride | 3.51 | 3.5 | M | 36 | TRIS-HCl pH 7.5 | 100 | mM | | sec-butanol | 3.8% | | | |
| 963 | 7.8 | Sodium Formate | 58.36 | 1.6 | M | 11.07142857 | TRIS-HCl pH 7.5 | 100 | mM | | Glycine | 0.132 | M | | |
| 964 | 7.43 | Sodium Formate | 49.27 | 5.0 | M | 35.35714286 | Mopso pH 7.5 | 100 | mM | | Trimethylamine HCl | 0.005 | M | | |
| 965 | 5.02 | Ammonium | 30 | 1.3 | M | 25 | Hepes pH 8.5 | 100 | mM | | Benzamidine HCl | 3.44% | | | |
| | | Citrate | | | | | | | | | | | | | |
| 966 | 5.98 | Cadmium Sulfate | 50.8 | 0.7 | M | 33.86666667 | Na-Malonate pH 6.0 | 100 | mM | | Betaine Monohydrate | 0.044 | M | | |
| | | Monohydrate | | | | | | | | | | | | | |
| 967 | 4.28 | Ammonium | 58.6 | 1.5 | M | 29.3 | CAPSO pH 8.5 | 50 | mM | | Ethylene Glycol | 2.5% | | Cymal-3 | 0.34% |
| | | Phosphate | | | | | | | | | | | | | |
| 968 | 8.09 | Sodium Sulfate | 0.26 | 0.4 | M | 20.3125 | Hepes pH 8.5 | 100 | mM | | | | | | |
| 969 | 9.98 | Tri-Sodium Citrate | 0.702 | 0.6 | M | 18.28125 | CAPSO pH 9.5 | 50 | mM | | D (+) Glucose | 1% | | | |
| | | Dihydrate | | | | | | | | | | | | | |
| 970 | 2.49 | Magnesium | 2.84 | 1.2 | M | 31.14035088 | Na-Citrate pH 4.5 | 50 | mM | | Dextran Sulfate | 1.5% | | | |
| | | Chloride | | | | | | | | | | | | | |
| 971 | 6.49 | | | | | | Na-Succinate pH 6.5 | 100 | mM | | 1,4-Dithio-DL-Threitol | 0.056 | M | | |
| 972 | 5.02 | Sodium | 0.348 | 0.3 | M | 30 | Hepes pH 6.5 | 100 | mM | | Guanidine HCl | 0.028 | M | | |
| | | Phosphate | | | | | | | | | | | | | |
| 973 | 5.42 | Calcium Acetate | 32 | 0.4 | M | 21.33333333 | TRIS-Maleate pH 4.5 | 50 | mM | | Manganese Chloride | 0.041 | M | | |
| | | Dihydrate | | | | | | | | | | | | | |
| 974 | 5.97 | Tri-Sodium Citrate | 0.534 | 0.4 | M | 13.90625 | Na-Succinate pH 4.5 | 100 | mM | | Glycerol Anhydrous | 1.4% | | | |
| | | Dihydrate | | | | | | | | | | | | | |
| 975 | 6.88 | Potassium | 10 | 0.5 | M | 6.612995975 | Mopso pH 7.5 | 100 | mM | | Manganese Chloride | 0.01 | M | | |
| | | Chloride | | | | | | | | | | | | | |
| 976 | 7.04 | Calcium Chloride | 2.14 | 0.8 | M | 20.18867925 | Mopso pH 7.5 | 100 | mM | | | | | | |
| 977 | 6.19 | Ammonium | 59.2 | 8.5 | M | 42.5 | Na-Succinate pH 6.5 | 100 | mM | | Xylitol | 1% | | | |
| | | Nitrate | | | | | | | | | | | | | |
| 978 | 8.92 | Tri-Sodium Citrate | 0.96 | 0.8 | M | 25 | Na-Malonate pH 7.0 | 100 | mM | | Phenol | 0.006 | M | | |
| | | Dihydrate | | | | | | | | | | | | | |
| 979 | 5.12 | Ammonium | 36 | 2.0 | M | 40 | | 0 | mM | | sec-butanol | 3.4% | | | |
| | | Citrate | | | | | | | | | | | | | |
| 980 | 6.89 | Sodium Chloride | 2.44 | 2.4 | M | 25 | Na-Cacodylate pH 7.5 | 100 | mM | | | | | | |
| 981 | 8.15 | Ammonium | 1.07 | 1.1 | M | 15.28571429 | CAPSO pH 9.5 | 50 | mM | | Betaine Monohydrate | 0.074 | M | | |
| | | Sulfate | | | | | | | | | | | | | |
| 982 | 9.85 | Potassium | 3 | 0.8 | M | 26.04166667 | Na-Succinate pH 6.5 | 100 | mM | | Taurine | 0.002 | M | | |
| | | Phosphate | | | | | | | | | | | | | |
| 983 | 3.8 | Zinc Sulfate | 28.4 | 1.5 | M | 38.66336634 | Na-Succinate pH 4.5 | 100 | mM | | Phenol | 0.005 | M | | |
| | | Hexahydrate | | | | | | | | | | | | | |
| 984 | 8.29 | Ammonium | 1.71 | 1.7 | M | 24.42857143 | Hepes pH 8.5 | 100 | mM | | 1,4-Dithio-DL-Threitol | 0.002 | M | | |
| | | Sulfate | | | | | | | | | | | | | |
| 985 | 7.33 | Tri-Sodium Citrate | 0.94 | 0.8 | M | 24.47916667 | Bis-Tris Propane pH 9.5 | 100 | mM | | Betaine Monohydrate | 0.06 | M | | |
| | | Dihydrate | | | | | | | | | | | | | |
| 986 | 5.26 | Ammonium | 27.73 | 2.1 | M | 42.96197183 | Mopso pH 7.5 | 100 | mM | | | | | | |
| | | Citrate | | | | | | | | | | | | | |
| 987 | 4.02 | Magnesium | 1.7 | 1.9 | M | 37.4 | Na-Succinate pH 4.5 | 100 | mM | | Ethylene Glycol | 2.6% | | | |
| | | Sulfate | | | | | | | | | | | | | |
| 988 | 7.36 | Potassium | 29 | 1.0 | M | 34.1002045 | | 0 | mM | | D (+) Glucose | 1% | | | |
| | | Sodium Tartrate | | | | | | | | | | | | | |
| 989 | 4.17 | | | | | | TRIS-Maleate pH 4.5 | 50 | mM | | Strontium Chloride | 0.03 | M | | |
| 990 | 5.43 | | | | | | Na—K-Phosphate pH 5.5 | 100 | mM | | Benzamidine HCl | 10% | | | |
| 991 | 6.91 | Potassium | 40 | 2.1 | M | 26.4519839 | TRIS-HCl pH 6.5 | 100 | mM | | | | | | |
| | | Chloride | | | | | | | | | | | | | |
| 992 | 7.06 | Potassium | 36.2 | 1.3 | M | 42.56646217 | Bis-Tris Propane pH 6.5 | 100 | mM | | sec-butanol | 1% | | Maltoside | 0.1% |
| | | Sodium Tartrate | | | | | | | | | | | | | |
| 993 | 4.53 | Ammonium | 19.2 | 19.2% | | 9.6 | Na-Malonate pH 6.0 | 100 | mM | | Urea | 0.084 | M | | |
| | | Bromide | | | | | | | | | | | | | |
| 994 | 5.31 | Calcium Chloride | 1.47 | 0.6 | M | 13.86792453 | Na-Cacodylate pH 6.5 | 100 | mM | | MPD | 4.7% | | | |
| 995 | 7.29 | Ammonium | 4.38048 | 4.4 | M | 30.4 | | 0 | mM | | Glycine | 0.18 | M | Glucopyranoside | 0.7% |
| | | Acetate | | | | | | | | | | | | | |
| 996 | 6.13 | Sodium Chloride | 0.38 | 0.4 | M | 3.9 | Na-Cacodylate pH 6.5 | 100 | mM | | PEG 400 | 3.5% | | | |
| 997 | 7.95 | | | | | | CAPSO pH 8.5 | 50 | mM | | Glycyl-Glycyl-Glycine | 0.025 | M | | |
| 998 | 5 | Sodium Formate | 19.52 | 5.7 | M | 40.67852768 | Na-Succinate pH 4.5 | 100 | mM | | 1,4 Dioxane | 1.1% | | | |
| 999 | 9.24 | | | | | | CAPSO pH 9.5 | 50 | mM | | Dextran Sulfate | 6% | | | |
| 1000 | 11.28 | | | | | | Na—K-Phosphate pH 8.5 | 100 | mM | | Spermidine | 0.04 | M | | |

### REFERENCES

### Patents and Patent Publications:

U.S. Pat. No. 6,913,732
U.S. Pat. No. 6,039,804
U.S. Pat. No. 6,656,267
U.S. Pat. No. 7,214,540

### Other References:

Hiraki, M., R. Kato, et al. (2006). “Development of an automated large-scale protein-crystallization and monitoring system for high-throughput protein-structure analyses.” Acta Crystallogr D Biol Crystallogr 62(Pt 9): 1058-65.
Hiraki, M., R. Kato, et al. (2006). “Development of an automated large-scale protein-crystallization and monitoring system for high-throughput protein-structure analyses.” Acta Crystallographica Section D 62(9): 1058-1065.
Hosfield, D., J. Palan, et al. (2003). “A fully integrated protein crystallization platform for small-molecule drug discovery.” J Struct Biol 142(1): 207-17.
Hui, R. and A. Edwards (2003). “High-throughput protein crystallization.” J Struct Biol 142(1): 154-61.
Jancarik, J. and S. H. Kim (1991). “Sparse matrix sampling: a screening method for crystallization of proteins.” J Appl Crystallogr 24: 409-411.
Santarsiero, B. D., D. T. Yegian, et al. (2002). “An approach to rapid protein crystallization using nanodroplets.” Journal of Applied Crystallography 35(2): 278-281.
Saridakis, E. and N. E. Chayen (2000). “Improving protein crystal quality by decoupling nucleation and growth in vapor diffusion.” Protein Sci 9(4): 755-7.
Segelke, B. W. (2001). “Efficiency analysis of sampling protocols used in protein crystallization screening”Journal of Crystal Growth 232(1): 553-562.
Stevens, R. C. (2000). “High-throughput protein crystallization.” Curr Opin Struct Biol 10(5): 558-63.
Stojanoff, V. (2004). “A novel approach to high-throughput screening; a solution for structural genomics?” Structure 12(7): 1127-8.
Sugahara, M. and M. Miyano (2002). “[Development of high-throughput automatic protein crystallization and observation system].” Tanpakushitsu Kakusan Koso 47(8 Suppl): 1026-32.
Sulzenbacher, G., A. Gruez, et al. (2002). “A medium-throughput crystallization approach.” Acta Crystallogr D Biol Crystallogr 58(Pt 12): 2109-15.
Watanabe, N., H. Murai, et al. (2002). “Semi-automatic protein crystallization system that allows in situ observation of X-ray diffraction from crystals in the drop.” Acta Crystallogr D Biol Crystallogr 58(Pt 10 Pt 1): 1527-30.

What is claimed is:

1. A microplate, comprising a frame including a plurality of wells with defined side-by-side paired chambers of equal size, wherein the side-by-side paired chambers have a maximum volume of about 8 μl, and wherein the side-by-side paired chambers have a vapor channel providing vapor exchange between the side-by-side paired chambers.

2. The microplate of claim 1, wherein the frame has a footprint that can be easily handled by a robotic handling system.

3. The microplate of claim 1, wherein the side-by-side paired chambers have bottoms aligned in the same plane.

4. The microplate of claim 1, wherein the side-by-side paired chambers have flat, conical, or concave bottoms.

5. The microplate of claim 1, wherein the vapor channel has a predetermined depth and width to allow for a predetermined quantity of a first crystallization solution and a second crystallization solution to optimally equilibrate.

6. The microplate of claim 1, wherein the vapor channel is formed by an opening in a wall between the side-by-side paired chambers and a membrane that is positioned over said plurality of wells.

7. The microplate of claim 1, wherein each well is positioned on said frame such that a liquid handling system can automatically deposit a crystallization solution into one of the side-by-side paired chambers and can automatically deposit a protein solution into the other of the side-by-side paired chambers.

8. The microplate of claim 1, wherein the microplate has 768 functional wells.

9. The microplate of claim 8, wherein each well is positioned on said frame such that a liquid handling system can automatically deposit crystallization solution into one of the side-by-side paired chambers and can automatically deposit a protein solution into the other of the side-by-side paired chambers.

10. A method of using a microplate comprising employing a liquid handling system to automatically deposit a crystallization solution into a first side-by-side paired chamber and to automatically deposit a protein solution into a second side-by-side paired chamber, wherein the side-by-side paired chambers each have a maximum volume of about 8 μl, wherein the crystallization solution and the protein solution interact via vapor diffusion; and wherein protein crystals are formed within the chamber containing the protein solution.

11. The method of claim 10, wherein the crystallization solution is selected from the solutions shown in Table 2.

12. The method of claim 10, wherein the amount of crystallization solution deposited is about 6 μl and the amount of protein solution deposited is about 1 μl.

13. The method of claim 10, wherein the amount of crystallization solution deposited is in the range of about 4 μl to about 8 μl and the amount of protein solution deposited is in the range of greater than 0.5 μl to about 2 μl.
